(19) United States
(12) Patent Application Publication
(10) Pub. No.: US 2025/0039740 A1
(43) Pub. Date: Jan. 30, 2025

(54) WIRELESS COMMUNICATION METHOD AND APPARATUS

(71) Applicant: GUANGDONG OPPO MOBILE TELECOMMUNICATIONS CORP., LTD., Dongguan (CN)

(72) Inventors: Zhe FU, Dongguan (CN); Shukun WANG, Dongguan (CN); Yali GUO, Dongguan (CN); Cong SHI, Dongguan (CN)

(73) Assignee: GUANGDONG OPPO MOBILE TELECOMMUNICATIONS CORP., LTD., Dongguan (CN)

(21) Appl. No.: 18/915,753

(22) Filed: Oct. 15, 2024

Related U.S. Application Data
(63) Continuation of application No. PCT/CN2022/087156, filed on Apr. 15, 2022.

(51) Int. Cl. H04W 28/06; H04L 47/2466; H04L 47/2475; H04L 47/41

(52) U.S. Cl. CPC H04W 28/065; H04L 47/2466; H04L 47/2475; H04L 47/41

(57) ABSTRACT

A wireless communication method and an apparatus are provided, and the method includes: performing, by a receive end, a first operation for a first PDU based on first information, where the first PDU includes part of or all of PDUs in a first PDU group, and PDUs in the first PDU group belong to one or more PDU sets.

### CROSS-REFERENCE TO RELATED APPLICATIONS

This application is a continuation of International Application No. PCT/CN2022/087156, filed on Apr. 15, 2022, the disclosure of which is hereby incorporated by reference in its entirety.

### TECHNICAL FIELD

This application relates to the field of communications technologies, and more specifically, to a wireless communication method and apparatus.

### BACKGROUND

Currently, in a communications system, transmission is performed by using a protocol data unit (PDU) as a granularity, or only transmission of a PDU itself is concerned, which may cause a transmission manner of the PDU to be improper.

### SUMMARY

This application provides a wireless communication method and apparatus.

According to a first aspect, a wireless communication method is provided and includes: performing, by a receive end, a first operation for a first PDU based on first information, where the first PDU includes part of or all of PDUs in a first PDU group, and PDUs in the first PDU group belong to one or more PDU sets.

According to a second aspect, a wireless communication method is provided and includes: performing, by a transmit end, a second operation for the first PDU, where the first PDU includes part of or all of PDUs in a first PDU group, PDUs in the first PDU group belong to one or more PDU sets, and the second operation is determined based on first information.

According to a third aspect, a receive end is provided and includes a processing unit, configured to perform a first operation for a first PDU based on first information, where the first PDU includes part of or all of PDUs in a first PDU group, and PDUs in the first PDU group belong to one or more PDU sets.

According to a fourth aspect, a transmit end is provided and includes: a processing unit, configured to perform a second operation for a first PDU, where the first PDU includes part of or all of PDUs in a first PDU group, PDUs in the first PDU group belong to one or more PDU sets, and the second operation is determined based on first information.

According to a fifth aspect, a receive end is provided and includes a processor, a memory, and a communications interface, where the memory is configured to store one or more computer programs, and the processor is configured to invoke the computer programs in the memory, to cause the receive end to perform part of or all of steps in foregoing methods.

According to a sixth aspect, a transmit end is provided and includes a processor, a memory, and a communications interface, where the memory is configured to store one or more computer programs, and the processor is configured to invoke the computer programs in the memory, to cause the transmit end to perform part of or all of steps in foregoing methods.

According to a seventh aspect, an embodiment of this application provides a communications system, where the system includes the receive end and/or the transmit end described above. In another possible design, the system may further include another device that interacts with the terminal or the network device in solutions provided in embodiments of this application.

According to an eighth aspect, an embodiment of this application provides a computer-readable storage medium, where the computer-readable storage medium stores a computer program, and the computer program causes a terminal to perform part of or all of steps in methods in the foregoing aspects.

According to a ninth aspect, an embodiment of this application provides a computer program product, where the computer program product includes a non-transitory computer-readable storage medium that stores a computer program, and the computer program may be operated to cause a terminal to perform part of or all of steps in methods in foregoing aspects. In some implementations, the computer program product may be a software installation package.

According to a tenth aspect, an embodiment of this application provides a chip, where the chip includes a memory and a processor, and the processor may invoke a computer program from the memory and run the computer program, to implement part of or all of steps described in methods in foregoing aspects.

### BRIEF DESCRIPTION OF DRAWINGS

FIG. 1 is a schematic diagram of a wireless communications system to which embodiments of this application are applicable.

FIG. 2 shows a wireless communications system 200 to which an embodiment of this application is applied.

FIG. 3 is a schematic diagram of a QoS model according to an embodiment of this application.

FIG. 4 is a schematic flowchart of a wireless communication method according to an embodiment of this application.

FIG. 5 is a schematic flowchart of a wireless communication method according to another embodiment of this application.

FIG. 6 is a schematic flowchart of a transmission method of first information according to an embodiment of this application.

FIG. 7 is a schematic flowchart of a transmission method of first information according to another embodiment of this application.

FIG. 8 is a schematic diagram of a receive end according to an embodiment of this application.

FIG. 9 is a schematic diagram of a transmit end according to an embodiment of this application.

FIG. 10 is a schematic structural diagram of a receive end according to an embodiment of this application.

### DESCRIPTION OF EMBODIMENTS

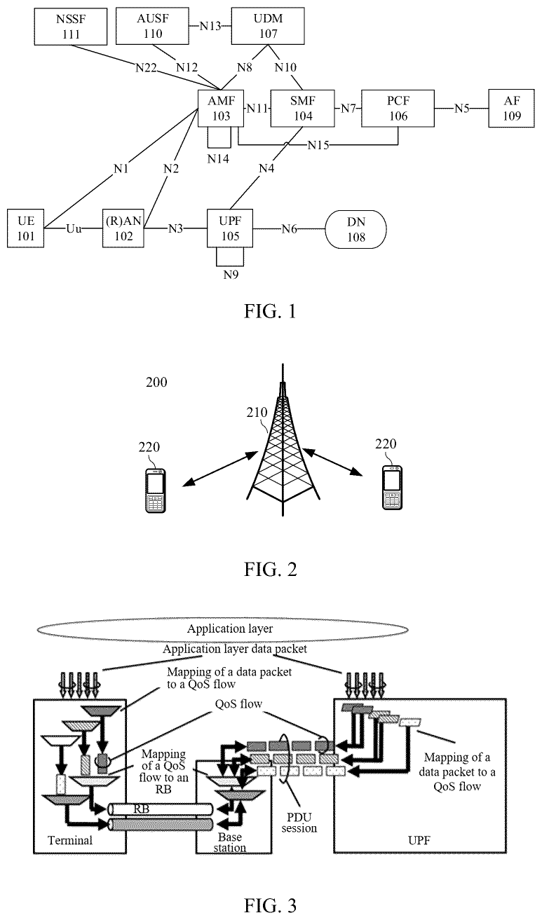

The technical solutions in this application are described below with reference to the accompanying drawings. For ease of understanding, the following first describes, with reference to FIG. 1 and FIG. 2, an architecture and terms of a communications system to which an embodiment of this application is applied.

FIG. 1 is a schematic diagram of a wireless communications system to which embodiments of this application are applicable. As shown in FIG. 1, a 5th generation (5G) system or new radio (NR) network architecture released by the 3rd Generation Partnership Project (3GPP) standard organization includes: a terminal device (also referred to as “user equipment (UE)) 101, an access network device 102 (including a radio access network (RAN) or an access network (AN)) that supports 3GPP technologies, a user plane function (UPF) network element 105, an access and mobility management function (AMF) network element 103, a session management function (SMF) network element 104, a policy control function (PCF) network element 106, an application function (AF) network element 109, a data network (DN) 108, a network slice selection function (NSSF) 111, an authentication server function (AUSF) 110, and a unified data management function (UDM) 107.

It should be noted that the network architecture shown in FIG. 1 does not constitute a limitation on the 5G network architecture. In specific implementation, the 5G network architecture may include more or fewer network elements than those shown in the figure, or some network elements may be combined, or the like. In addition, in FIG. 1, an AN or a RAN is represented in a manner of (R) AN.

The terminal device 101 may be a user equipment (UE), a terminal, a handheld terminal, a notebook computer, a subscriber unit, a cellular phone, a smart phone, a wireless data card, a personal digital assistant (PDA) computer, a tablet computer, a wireless modem, a handheld device, a laptop computer, a cordless phone, or a wireless local loop (WLL) station, a machine-type communication (MTC) terminal, a handheld device having a wireless communication function, a computing device, a processing device connected to a wireless modem, an unmanned aerial vehicle, a vehicle-mounted device, a wearable device, a terminal in an internet of things, a virtual reality device, a terminal device in a future communications system (for example, 6G) network, a terminal in a future evolved public land mobile network (PLMN), or the like.

The access network device 102 is an access device for a terminal device to access the network architecture in a wireless manner, and is mainly responsible for radio resource management, quality of service (QOS) management, data compression and encryption, and the like on an air interface side, which may be, for example, a base station NodeB, an evolved base station eNodeB, a base station in a 5G mobile communications system or a new radio (NR) communications system, or a base station in a future mobile communications system.

The UPF network element 105, the AMF network element 103, the SMF network element 104, and the PCF network element 106 are network elements of a 3GPP core network (referred to as core network elements). The UPF network element 105 may be referred to as a user plane function network element, and is mainly responsible for user data transmission. Another network element may be referred to as a control plane function network element, and is mainly responsible for certification, authentication, registration management, session management, mobility management, policy control, and the like, so as to ensure reliable and stable transmission of user data.

The UPF network element 105 (or “PCF” for short) may be configured to forward and receive data of a terminal. For example, the UPF network element may receive data of a service from a data network, and transmit the data to the terminal through an access network device. The UPF network element may further receive user data from the terminal through the access network device, and forward the user data to the data network. The transmission resources allocated and scheduled by the UPF network element to the terminal are managed and controlled by the SMF network element. Bearers between the terminal and the UPF network element may include: a user plane connection between the UPF network element and the access network device, and a channel established between the access network device and the terminal. The user plane connection is a quality of service (QOS) flow that may be established between the UPF network element and the access network device for data transmission.

The AMF network element 103 (or “AMF” for short) may be used to manage access of a terminal to a core network, such as location update of a terminal, network registration, access control, mobility management of a terminal, attachment and detachment of a terminal, and the like. The AMF network element may further provide a control plane storage resource for a session in a case of providing a service for the session of the terminal, so as to store a session identifier, an SMF network element identifier associated with the session identifier, and the like.

The SMF network element 104 (or “SMF” for short) may be configured to: select a user plane network element for a terminal, redirect a user plane network element for the terminal, allocate an internet protocol (IP) address to the terminal, establish a bearer (also referred to as a session) between the terminal and the UPF network element, modify and release a session, and control QoS.

The PCF network element 106 (or “PCF” for short) is configured to provide a policy, for example, a QoS policy or a slice selection policy, to the AMF network element 103 and the SMF network element 104.

The AF network element 109 (or “AF” for short) is configured to: interact with a network element in the 3GPP core network to support application of a route that affects data, access a network exposure function, interact with the PCF network element for policy control, and the like.

The DN 108 may provide a data service for a user in an IP multi-media service (IMS) network, the Internet, or the like. The DN 108 may include a plurality of application servers (AS), providing different application services, such as an operator service, internet access, or a third-party service. The AS may implement a function of an AF network element.

The NSSF 111 is configured to select a network slice and supports the following functions: selecting a set of network slice instances that serve UE; determining allowed network slice selection assistance information (NSSAI), and when required, determining a mapping to subscribed single-network slice selection assistance information (S-NSSAI); determining configured NSSAI, and when required, determining a mapping to subscribed S-NSSAI; and determining a set of AMFs that may be used to query a UE, or determining a list of candidate AMFs based on a configuration.

The AUSF 110 is configured to: receive an identity authentication request from the AMF 103 for the terminal, request a key from the UDM 107, and then forward the delivered key to the AMF 103 for authentication processing.

The UDM 107 includes functions such as generation and storage of user subscription data and management of authentication data, and supports interaction with an external third-party server.

It should be understood that each network element in FIG. 1 may be a network element in a hardware device, a software function running on dedicated hardware, or a virtualized function instantiated on a platform (for example, a cloud platform). It should be noted that in the network architecture shown in the foregoing figure, network elements included in the entire network architecture are merely described as examples. In embodiments of this application, the network elements included in the entire network architecture are not limited.

FIG. 2 shows a wireless communications system 200 to which an embodiment of this application is applied. The wireless communications system 200 may include a network device 210 and a terminal device 220. The network device 210 may be a device that communicates with the terminal device 220. The network device 210 may provide communication coverage for a specific geographical area, and may communicate with the terminal device 220 located within the coverage.

FIG. 2 exemplarily shows one network device and two terminals. In a possible implementation, the wireless communications system 200 may include a plurality of network devices, and another quantity of terminal devices may be included in coverage of each network device, which is not limited in embodiments of this application.

In a possible implementation, the wireless communications system 200 may further include another network entity such as a network controller or a mobility management entity, which is not limited in embodiments of this application.

It should be understood that the technical solutions of embodiments of this application may be applied to various communications systems, such as a 5th generation (5G) system or new radio (NR), a long-term evolution (LTE) system, an LTE frequency division duplex (FDD) system, and LTE time division duplex (TDD). The technical solutions provided in this application may further be applied to a future communications system, such as a 6th generation mobile communications system or a satellite communications system.

The terminal device in embodiments of this application may also be referred to as a user equipment (UE), an access terminal, a user unit, a user station, a mobile site, a mobile station (MS), a mobile terminal (MT), a remote station, a remote terminal, a mobile device, a user terminal, a terminal, a wireless receive end, a user agent, or a user apparatus. The terminal device in embodiments of this application may be a device providing a user with voice and/or data connectivity and capable of connecting people, objects, and machines, such as a handheld device or vehicle-mounted device having a wireless connection function. The terminal device in embodiments of this application may be a mobile phone, a tablet computer (Pad), a notebook computer, a palmtop computer, a mobile internet device (MID), a wearable device, a virtual reality (VR) device, an augmented reality (AR) device, a wireless terminal in industrial control, a wireless terminal in self driving, a wireless terminal in remote medical surgery, a wireless terminal in smart grid, a wireless terminal in transportation safety, a wireless terminal in smart city, a wireless terminal in smart home, or the like. In a possible implementation, a UE may be configured to act as a base station. For example, the UE may act as a scheduling entity, which provides a sidelink signal between UEs in V2X or D2D, or the like. For example, a cellular phone and a vehicle communicate with each other through a sidelink signal. A cellular phone and a smart home device communicate with each other, without relaying a communication signal by using a base station.

The network device in embodiments of this application may be a device used to communicate with a terminal device. In some implementations, the network device may be a core network device (for example, a core network element shown in FIG. 1). In some other implementations, the network device may be an access network device or a radio access network device, for example, the network device may be a base station. The network device in embodiments of this application may be a radio access network (RAN) node (or device) that connects the terminal device to a wireless network. The base station may broadly cover various names in the following, or replace with the following names, for example: a NodeB, an evolved NodeB (eNB), a next generation NodeB (gNB), a relay station, an access point, a transmitting and receiving point (TRP), a transmitting point (TP), a primary MeNB, a secondary SeNB, a multi-standard radio (MSR) node, a home base station, a network controller, an access node, a wireless node, an access point (AP), a transmission node, a transceiver node, a base band unit (BBU), a remote radio unit (RRU), an active antenna unit (AAU), a remote radio head (RRH), a central unit (CU), a distributed unit (DU), a positioning node, or the like. The base station may be a macro base station, a micro base station, a relay node, a donor node, or the like, or a combination thereof. Alternatively, the base station may be a communications module, a modem, or a chip disposed in the device or the apparatus described above. Alternatively, the base station may be a mobile switching center, a device that functions as a base station in device to device D2D, vehicle-to-everything (V2X), and machine-to-machine (M2M) communications, a network-side device in a 6G network, a device that functions as a base station in a future communications system, or the like. The base station may support networks with a same access technology or different access technologies. A specific technology and a specific device form used by the network device are not limited in embodiments of this application.

The base station may be a fixed or mobile base station. For example, a helicopter or an unmanned aerial vehicle may be configured to function as a mobile base station, and one or more cells may move depending on a location of the mobile base station. In other examples, a helicopter or an unmanned aerial vehicle may be configured to serve as a device in communication with another base station.

In some deployments, the network device in embodiments of this application may be a CU or a DU, or the network device includes a CU and a DU. The gNB may further include an AAU.

The network device and the terminal device may be deployed on land, including being indoors or outdoors, handheld, or vehicle-mounted, may be deployed on a water surface, or may be deployed on a plane, a balloon, or a satellite in the air. A scenario in which the network device and the terminal device are located is not limited in embodiments of this application.

It should be understood that all or some of functions of the receive end in this application may also be implemented by software functions running on hardware, or by virtualization functions instantiated on a platform (for example, a cloud platform).

Referring to FIG. 3, a concept of a QoS flow is introduced in a 5G network. After accessing the 5G network by using a Uu interface, a terminal may establish, under control of an SMF, a QoS flow for data transmission. The SMF provides QoS flow configuration information of each QoS flow to a base station, which specifically includes information such as a bit rate requirement, a delay requirement, and a bit error rate requirement. For each QoS flow, the base station may schedule a radio resource according to the QoS flow configuration information received from the SMF to ensure a QoS requirement of the QoS flow. In a QoS flow in the 5G network, both an upstream data flow (that is, a data flow transmitted by the terminal to a peer device by using the 5G network) and a downstream data flow (that is, a data flow transmitted by a peer device to a terminal by using the 5G network) may be transmitted. Herein, the peer device refers to a peer application server or a peer terminal. An upstream data flow and a downstream data flow in one QoS flow have a same delay requirement. If delay requirements of an upstream data flow and a downstream data flow of a service are different, the service is transmitted by using different QoS flows. The delay herein refers to a data transmission delay between the terminal and the UPF.

In a mobile communications network, to enable that user plane data is transmitted, one or more QoS flows need to be established, and different QoS flows correspond to different Qos parameters. As an important measure of communication quality, a QoS parameter is generally used to indicate a feature of a QoS flow, and the QoS parameter may include but is not limited to: a 5G QoS identifier (5QI), an address resolution protocol (ARP), a guaranteed flow bit rate (GFBR), a maximum flow bit rate (MFBR), a maximum packet loss rate (UL/DL), an end-to-end packet delay budget (PDB), an AN-PDB, a packet error rate (PER), a priority level, an average window, a resource type, a maximum data burst volume, a UE-aggregate maximum bit rate (UE-AMBR), a session-AMBR and the like.

A filter, or referred to as a service data flow (SDF) template, includes a parameter that describes a feature of a data packet, and is configured to obtain a specific data packet through filtering and bind the data packet to a specific QoS flow. Herein, the most common filter is an IP quintuple, that is, a source IP address, a destination IP address, a source port number, a destination port number, and a protocol type.

A network-side user plane network element and the terminal form a filter (see a trapezoid in the terminal and a parallelogram in the UPF in FIG. 3) according to a feature parameter combination of a data packet, obtain, through filtering, uplink or downlink data packets that match a data packet feature and are transmitted on a user plane, and bind the uplink or downlink data packets to a data flow.

### Cloud Gaming (CG)

CG refers to a set of cases in which the vast majority of game-related calculations (single or multiple) are offloaded from a UE to an edge server or a remote server.

### Extended Reality (XR)

The extended reality is a large-scale protector for a plurality of heterogeneous use cases and services, and is studied and summarized in SA1, SA2, and SA4, including but not limited to TR 22.842 and TR 26.928. These XR cases may be roughly divided into an augmented reality (AR), a virtual reality (VR), and a mixed reality (MR).

Currently, XR and media services (XR and media services, XRM) include a video frame and an audio frame. For a video frame, the video frame may include one or more video slices, where the video slices may be understood as spatially different areas in the video frame and are separately encoded from other areas in a same frame.

It should be noted that methods in embodiments of this application may be applied to the foregoing XR scenario. In this case, data carried in a PDU may be XR service data. Certainly, methods in embodiments of this application may be further used in another scenario, which is not limited in embodiments of this application.

### PDU Set

A PDU set includes one or more PDUs that carry a payload of an information unit (for example, a frame or a video slice of an XRM service) generated at an application layer, and the information has same importance requirement at the application layer. The application layer requires all PDUs in the PDU set to use a corresponding information unit. In some cases, the application layer may still recover some information units when part of PDUs are lost.

In some scenarios, the PDU set may carry an I frame, a P frame, a B frame, and the like. As an intra-frame coded picture, the I frame is a complete picture and may be independently coded and decoded as a JPG image file. As a prediction picture, the P frame is not a complete frame, and includes only an image change compared with a previous frame. It should be noted that if a reference frame is lost, the P frame cannot be decoded and displayed. As a bidirectional prediction picture, the B frame includes a change between a current reference frame and a subsequent reference frame. Generally, the more reference frames, the higher a compression ratio. It should be noted that the B frame can be decoded only when a current reference frame and a subsequent reference frame are available.

In some other scenarios, a plurality of PDU sets may carry data of a group of pictures (GOP). The GOP may be understood as a set of consecutive video frames. Generally, the first frame of the GOP is an I frame, and a following frame may be a P frame or a B frame.

It should be noted that, in embodiments of this application, the PDU set may be a PDU set encapsulated by a higher layer, or may be a PDU set re-encapsulated by a lower layer based on a higher layer PDU or PDU set. In addition, the PDU set in embodiments of this application may also be represented by using another term, which is not limited in embodiments of this application.

In addition, in embodiments of this application, the PDU may be a PDU encapsulated by a higher layer, or may be a PDU re-encapsulated by a lower layer based on a higher layer PDU or PDU set. In addition, the PDU in embodiments of this application may also be represented by using another term, which is not limited in embodiments of this application.

It should be noted that in embodiments of this application, the higher layer may refer to an application layer or a NAS layer, and the lower layer may refer to an AS layer. Alternatively, the higher layer may indicate a higher layer of the AS layer, and the lower layer may indicate a lower layer of the AS layer. For example, SDAP is a higher layer, and PDCP/MAC/RLC is a lower layer. For another example, PDCP is a higher layer, and RLC is a lower layer. For another example, PDCP/RLC is a higher layer, and MAC is a lower layer.

As mentioned above, in some scenarios, there is an association relationship between PDUs in a PDU set, or there is an association relationship between PDU sets. However, in an existing communications system, transmission is performed in a PDU granularity, or only transmission of a PDU itself is concerned, which may cause a transmission manner of the PDU to be improper. (for example, cause a waste of transmission resources).

The association relationship between PDU sets is used as an example to describe a problem of waste of transmission resources. It is assumed that a PDU set 1 carries data of the reference frame, and a PDU included in a PDU set 2 carries data of the P frame. In this case, successfully decoding of the PDU set 2 is based on the PDU set 1. In other words, only after the PDU set 1 is successfully decoded, the PDU set 2 can be successfully decoded. Because data of the P frame carried in the PDU set 2 cannot be decoded independently, in a case that transmission of the PDU set 1 fails, transmission of the PDU set 2 is meaningless. However, in an existing PDU set transmission mechanism, attention is paid only to whether transmission of a PDU succeeds. When transmission of the PDU set 1 fails, PDUs in the PDU set 2 are still transmitted, resulting in a waste of transmission resources.

The association relationship between PDUs in a PDU set is used as an example. For a receive end with a relatively weak decoding capability, the receive end can perform integrated packet handling on all PDUs in the PDU set only after receiving all PDUs in the PDU set. In this case, when one PDU in the PDU set fails to be successfully transmitted to the receive end, it is meaningless that a remaining PDU in the PDU set is successfully transmitted. Therefore, transmission of the remaining PDU in the PDU set may cause a waste of resources.

The association relationship between PDU sets is used as an example. For a receive end with a relatively strong decoding capability, after receiving part of PDU sets in a plurality of PDU sets, the receive end may recover the part of PDU sets, and does not need to acquire or decode all PDU sets.

The association relationship between PDUs in a PDU set is used as an example. For a receive end with a relatively strong decoding capability, after receiving part of PDUs in the PDU set, the receive end may generally recover the part of PDU sets, and does not need to acquire or decode all PDUs.

The association relationship between PDUs in a PDU set is used as an example. For a receive end with a relatively strong decoding capability, after receiving part of PDUs in the PDU set, the receive end may generally infer another PDU that is not successfully transmitted (or another PDU not transmitted) in the PDU set. Such a receive end may recover all PDUs based on part of PDUs to perform integrated packet handling. In this case, after the part of PDUs in the PDU set are successfully transmitted to the receive end, transmission of the another PDU in the PDU set is also meaningless. Therefore, transmission of the another PDU in the PDU set may cause a waste of resources.

To avoid the foregoing problem, an embodiment of this application provides a wireless communication method, in which a first PDU including a plurality of PDUs is used as a granularity to perform an operation for the first PDU (hereinafter referred to as a “first operation or a second operation”). The first PDU may include part of or all of PDUs in a first PDU group, and PDUs in the first PDU group belong to one or more PDU sets.

In other words, when the first PDU group includes one PDU set, the first PDU may include part of or all of PDUs in the PDU set. When the first PDU group includes a plurality of PDU sets, the first PDU may include part of or all of PDUs in the plurality of PDU sets. Alternatively, when the first PDU group includes a plurality of PDU sets, the first PDU may include all PDUs in the part of PDU sets and part of PDUs in the part of PDU sets in the plurality of PDU sets.

Generally, PDUs that need to be processed as a whole (namely, PDUs included in the first PDU) may belong to a same Qos flow, that is, PDUs in the first PDU belong to a first QoS flow. In a possible implementation, if the first PDU includes all PDUs in the first PDU group, it indicates that all PDUs in the first PDU group belong to the first QoS flow. In a possible implementation, if the first PDU includes part of PDUs in the first PDU group, it indicates that the part of PDUs in the first PDU group (namely, the part included in the first PDU) belong to the first QoS flow, and accordingly, another PDU, different from the first PDU, in the first PDU group may belong to another QoS flow. In a possible implementation, if the first PDU includes part of PDUs in the first PDU group, it indicates that the part of PDUs in the first PDU group (namely, the part included in the first PDU) belong to the first QoS flow, and accordingly, another PDU, different from the first PDU, in the first PDU group may alternatively belong to the first QoS flow. Certainly, in embodiments of this application, PDUs in the first PDU may alternatively belong to different QoS flows.

Generally, PDUs that need to be processed as a whole (that is, PDUs included in the first PDU) may belong to a same service flow, that is, the PDUs in the first PDU belong to a first service flow. In a possible implementation, if the first PDU includes all PDUs in the first PDU group, it indicates that all PDUs in the first PDU group belong to the first service flow. In a possible implementation, if the first PDU includes part of PDUs in the first PDU group, it indicates that the part of PDUs in the first PDU group (namely, the part included in the first PDU) belong to the first service flow, and accordingly, another PDU, different from the first PDU, in the first PDU group may belong to another service flow. In a possible implementation, if the first PDU includes part of PDUs in the first PDU group, it indicates that the part of PDUs in the first PDU group (namely, the part included in the first PDU) belong to the first service flow, and accordingly, another PDU, different from the first PDU, in the first PDU group may alternatively belong to the first service flow. Certainly, in embodiments of this application, PDUs in the first PDU may alternatively belong to different service flows.

Generally, PDUs that need to be processed as a whole (namely, PDUs included in the first PDU) may belong to a same PDU session, that is, the PDUs in the first PDU belong to a first PDU session. In a possible implementation, if the first PDU includes all PDUs in the first PDU group, it indicates that all PDUs in the first PDU group belong to the first PDU session. In a possible implementation, if the first PDU includes part of PDUs in the first PDU group, it indicates that the part of PDUs in the first PDU group (namely, the part included in the first PDU) belong to the first PDU session, and accordingly, another PDU, different from the first PDU, in the first PDU group may belong to another PDU session. In a possible implementation, if the first PDU includes part of PDUs in the first PDU group, it indicates that the part of PDUs in the first PDU group (namely, the part included in the first PDU) belong to the first PDU session, and accordingly, another PDU, different from the first PDU, in the first PDU group may alternatively belong to the first PDU session. Certainly, in embodiments of this application, PDUs in the first PDU may alternatively belong to different PDU sessions.

Generally, PDUs that need to be processed as a whole (namely, PDUs included in the first PDU) may be associated with a same application, that is, the PDUs in the first PDU are associated with a first application. In a possible implementation, if the first PDU includes all PDUs in the first PDU group, it indicates that all PDUs in the first PDU group are associated with the first application. In a possible implementation, if the first PDU includes part of PDUs in the first PDU group, it indicates that the part of PDUs in the first PDU group (namely, the part included in the first PDU) are associated with the first application, and accordingly, another PDU, different from the first PDU, in the first PDU group may be associated with another application. In a possible implementation, if the first PDU includes part of PDUs in the first PDU group, it indicates that the part of PDUs in the first PDU group (namely, the part included in the first PDU) are associated with the first application, and accordingly, another PDU, different from the first PDU, in the first PDU group may alternatively be associated with the first application. Certainly, in embodiments of this application, the PDUs in the first PDU may alternatively be associated with different applications.

Generally, PDUs that need to be processed as a whole (namely, PDUs included in the first PDU) may be associated with a same AF, and the PDUs in the first PDU are associated with a first application. In a possible implementation, if the first PDU includes all PDUs in the first PDU group, it indicates that all PDUs in the first PDU group are associated with the first AF. In a possible implementation, if the first PDU includes part of PDUs in the first PDU group, it indicates that the part of PDUs in the first PDU group (namely, the part included in the first PDU) are associated with the first AF, and accordingly, another PDU, different from the first PDU, in the first PDU group may be associated with another AF. In a possible implementation, if the first PDU includes part of PDUs in the first PDU group, it indicates that the part of PDUs in the first PDU group (namely, the part included in the first PDU) are associated with the first AF, and accordingly, another PDU, different from the first PDU, in the first PDU group may alternatively be associated the first AF. Certainly, in embodiments of this application, the PDUs in the first PDU may alternatively be associated with different AFs.

Generally, PDUs that need to be processed as a whole (namely, PDUs included in the first PDU) may be associated with a same user, that is, the PDUs in the first PDU are associated with a first user. In a possible implementation, if the first PDU includes all PDUs in the first PDU group, it indicates that all PDUs in the first PDU group are associated with the first user. In a possible implementation, if the first PDU includes part of PDUs in the first PDU group, it indicates that the part of PDUs in the first PDU group (namely, the part included in the first PDU) are associated with the first user, and accordingly, another PDU, different from the first PDU, in the first PDU group may be associated with another user. In a possible implementation, if the first PDU includes part of PDUs in the first PDU group, it indicates that the part of PDUs in the first PDU group (namely, the part included in the first PDU) are associated with the first user, and accordingly, another PDU, different from the first PDU, in the first PDU group may alternatively be associated with the first user. Certainly, in embodiments of this application, the PDUs in the first PDU may alternatively be associated with different users.

Generally, PDUs that need to be processed as a whole (namely, PDUs included in the first PDU) may be associated with a same network device, that is, the PDUs in the first PDU are associated with a first network device. In a possible implementation, if the first PDU includes all PDUs in the first PDU group, it indicates that all PDUs in the first PDU group are associated with the first network device. In a possible implementation, if the first PDU includes part of PDUs in the first PDU group, it indicates that the part of PDUs in the first PDU group (namely, the part included in the first PDU) are associated with the first network device, and accordingly, another PDU, different from the first PDU, in the first PDU group may be associated with another network device. In a possible implementation, if the first PDU includes part of PDUs in the first PDU group, it indicates that the part of PDUs in the first PDU group (namely, the part included in the first PDU) are associated with the first network device, and accordingly, another PDU, different from the first PDU, in the first PDU group may alternatively be associated with the first network device. Certainly, in embodiments of this application, the PDUs in the first PDU may alternatively be associated with different network device.

Generally, PDUs that need to be processed as a whole (namely, PDUs included in the first PDU) may have a same IP quintuple, that is, the IP quintuple of the PDUs in the first PDU is a first IP quintuple. In a possible implementation, if the first PDU includes all PDUs in the first PDU group, it indicates that an IP quintuple of all PDUs in the first PDU group is the first IP quintuple. In a possible implementation, if the first PDU includes part of PDUs in the first PDU group, it indicates that an IP quintuple of the part of PDUs in the first PDU group (namely, the part included in the first PDU) is the first IP quintuple, and accordingly, an IP quintuple of another PDU, different from the first PDU, in the first PDU group may be another IP quintuple. In a possible implementation, if the first PDU includes part of PDUs in the first PDU group, it indicates that an IP quintuple of the part of PDUs in the first PDU group (namely, the part included in the first PDU) is the first IP quintuple, and accordingly, an IP quintuple of another PDU, different from the first PDU, in the first PDU group is the first IP quintuple. Certainly, in embodiments of this application, the IP quintuple of the PDUs in the first PDU may be different IP quintuples.

Based on the foregoing description of the first PDU, the first PDU group, and the PDU set, the following describes methods in embodiments of this application from a receive end of the first PDU and a transmit end of the first PDU with reference to Embodiment 1 and Embodiment 2.

It should be noted that, in some implementations, the receive end may be a terminal device or a network device. The transmit end may also be a terminal device or a network device. In some other implementations, the transmit end may be an encoding end of the first PDU, and the receive end may be a decoding end of the first PDU. Certainly, in embodiments of this application, the transmit end and the encoding end may alternatively be two different devices, and/or the receive end and the decoding end may alternatively be two different devices.

### Embodiment 1

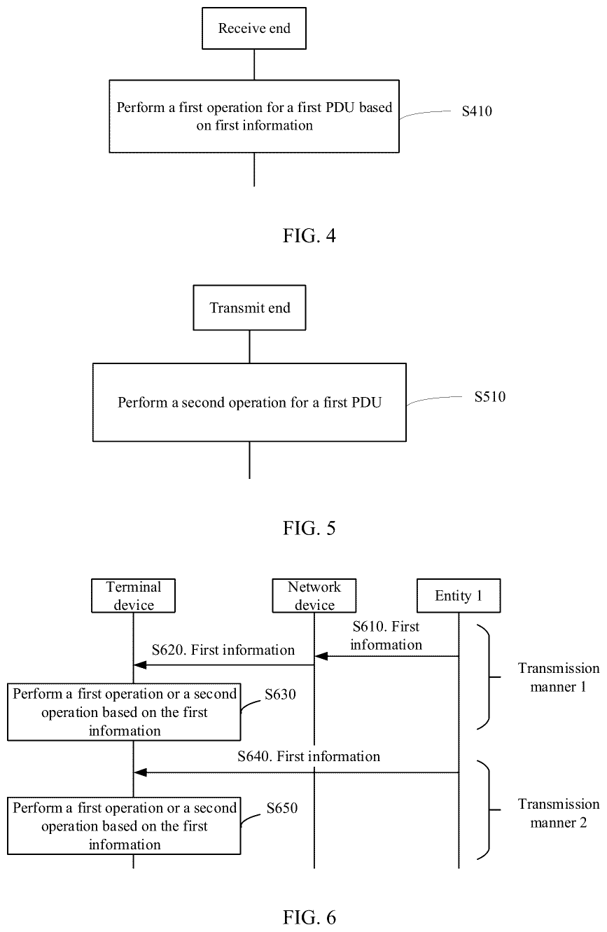

FIG. 4 is a schematic flowchart of a wireless communication method according to an embodiment of this application. The method shown in FIG. 4 includes step S410.

In step S410, a receive end performs a first operation for a first PDU based on first information.

In this embodiment of this application, the receive end performs an operation (also referred to as a “first operation”) for the first PDU based on the first information. In other words, the first PDU is used as a whole to perform a corresponding operation, which avoids focusing only on transmission of a single PDU in a conventional transmission manner, thereby improving efficiency or properness of a transmission manner of the first PDU.

In some implementations, the foregoing first information is used to indicate whether processing is performed on a first PDU basis. As described above, in embodiments of this application, an operation may be performed for the first PDU at a granularity of the first PDU. Therefore, the receive end needs to learn whether processing is performed at a granularity of the first PDU. It may be determined, based on the first information, whether to perform processing at a granularity of the first PDU.

As described above, in embodiments of this application, an operation may be performed for the first PDU at a granularity of the first PDU. However, when the first operation is performed at a granularity of the first PDU, a relationship (also referred to as a first relationship) between all of or part of PDUs included in the first PDU needs to be learned. In this case, the relationship may be indicated by the first information.

In some implementations, the foregoing first information is used to indicate the first relationship between PDUs in the first PDU.

The foregoing first relationship may be, for example, an association relationship between PDUs in the first PDU. It may be understood that PDUs belonging to a same PDU set have an association relationship, or it may be understood that PDUs included in a plurality of PDU sets belonging to a same PDU group have an association relationship.

The first relationship may be, for example, a priority relationship between PDUs in the first PDU. The priority relationship between PDUs in the first PDU may be indicated by levels or indexes of priorities corresponding to the PDUs.

The first relationship may alternatively be, for example, a dependency relationship of a PDU in the first PDU in a coding and/or decoding process. In some implementations, the dependency relationship may include relying on another PDU for decoding, or being individually decoded. If the dependency relationship includes relying on another PDU for decoding, relying on another PDU for decoding may be understood as that a decoding process of a PDU relies on a decoding process of another PDU, or data in PDUs having a dependency relationship can be acquired only by decoding these PDUs together. For example, a decoding process of a P frame described above needs to rely on a reference frame. Therefore, a PDU carrying a P frame generally relies on a PDU carrying a reference frame. If the dependency relationship is being independently decoded, it indicates that a corresponding PDU may be independently decoded. For example, an I frame described above may be independently decoded. Therefore, a dependency relationship of a PDU carrying an I frame may be independently decoded.

In some other implementations, the first information includes information about performing integrated packet handling on the first PDU, or the first information includes information about performing differentiated packet handling on the first PDU.

Generally, to perform integrated packet handling on PDUs in the first PDU, a relationship between the PDUs in the first PDU needs to be learned. For example, the association relationship between PDUs, the dependency relationship between PDUs, or the like described above needs to be learned.

In some implementations, the foregoing association relationship between PDUs in the first PDU may be identified by using a sequence number, an identification number, interval information (such as a start identity, or an end identity), or the like.

In some scenarios, when the first PDU includes a PDU having a high priority, the PDU having a high priority may be prioritized for transmission or processing.

In some other scenarios, when the first PDU includes a PDU having a high priority, or the first PDU includes a PDU that may be independently decoded, differentiated packet handling may need to be performed on PDUs in the first PDU. Generally, after the foregoing PDU is successfully received by the receive end, the first PDU may be successfully decoded. Therefore, the differentiated packet handling may include differentiated priorities and dependencies of PDUs during a decoding process.

Correspondingly, information about differentiated packet handling may include, for example, at least one of following: priority information of the first PDU or a PDU in the first PDU, information indicating a processing order of a PDU in the first PDU, information indicating independent decoding of a PDU in the first PDU, or information indicating a dependency relationship of a PDU in the first PDU in a coding and/or decoding process.

The foregoing information indicating a processing order of a PDU in the first PDU may be indicated by a priority (for example, a priority index) of the PDU in the first PDU. For example, a processing order of a PDU having a high priority in the first PDU may precede a processing order of a PDU having a low priority in the first PDU.

In some other implementations, the foregoing first information includes one or more of following information: information for indicating that integrated packet handling is to be performed on the first PDU; information for indicating that differentiated packet handling is to be performed on the first PDU; information for indicating a PDU, on which integrated packet handling needs to be performed, in the first PDU group; information for indicating a quantity of PDUs tolerated to be lost in the first PDU group; information for indicating a quantity of PDUs required for successfully decoding the first PDU group; information for indicating a quantity of PDUs required for successfully recovering the first PDU group; or information for indicating a quantity of PDUs transmitted successfully in the first PDU group when a condition of successfully decoding the first PDU group is met.

If the first information includes information for indicating that integrated packet handling is to be performed on the first PDU, accordingly, the receive end may perform integrated packet handling on a PDU in the first PDU based on the first information. Alternatively, the receive end may determine, based on the first information, that integrated packet handling needs to be performed on a PDU in the first PDU.

If the first information includes information for indicating that differentiated packet handling is to be performed on the first PDU, accordingly, the receive end may perform differentiated packet handling on a PDU in the first PDU based on the first information. Alternatively, the receive end may determine, based on the first information, that differentiated packet handling needs to be performed on a PDU in the first PDU.

If the first information includes information for indicating a PDU, on which integrated packet handling needs to be performed, in the first PDU group, accordingly, the receive end may perform, based on the first information, integrated packet handling on the PDU indicated by the first information. Alternatively, the receive end may determine, based on the first information, a PDU, on which integrated packet handling needs to be performed, in the first PDU group.

If the first information includes information for indicating a quantity of PDUs tolerated to be lost in the first PDU group, accordingly, the receive end may determine, based on the first information, the quantity of PDUs tolerated to be lost in the first PDU group (also referred to as a number of PDUs tolerated to be lost). In a possible implementation, the quantity of PDUs tolerated to be lost may be represented by a tolerable loss ratio, and the tolerable loss ratio (also referred to as a tolerable loss proportion) is a ratio of the quantity of PDUs tolerated to be lost in the first PDU group to a total quantity of PDUs in the first PDU group. In a possible implementation, the quantity of PDUs tolerated to be lost may be represented by a tolerable loss threshold, and the tolerable loss threshold is a maximum value of the quantity of PDUs tolerated to be lost in the first PDU group.

If the first information includes information for indicating a quantity of PDUs, tolerated to fail to be transmitted, in the first PDU group, accordingly, the receive end may determine, based on the first information, the quantity of PDUs, tolerated to fail to be transmitted, in the first PDU group (also referred to as a number of PDUs tolerated to fail to be transmitted). In a possible implementation, the quantity of PDUs tolerated to fail to be transmitted may be represented by a transmission failure ratio (also referred to as a transmission failure proportion), and the transmission failure ratio is a ratio of the quantity of PDUs, tolerated to fail to be transmitted, in the first PDU group to a total quantity of PDUs in the first PDU group. The quantity of PDUs tolerated to fail to be transmitted in the first PDU group may be a maximum value of the quantity of PDUs tolerated to fail to be transmitted when PDUs in the first PDU group may be successfully decoded. In a possible implementation, the quantity of PDUs tolerated to fail to be transmitted may be represented by a tolerable transmission failure threshold, and the tolerable transmission failure threshold is a maximum value of the quantity of PDUs, tolerated to fail to be transmitted, in the first PDU group.

If the first information includes the information for indicating a quantity of PDUS required for successfully decoding the first PDU group (also referred to as a number, a “first PDU quantity”), accordingly, the receive end may determine, based on the first information, the quantity of PDUs required for successfully decoding the first PDU group. In a possible implementation, the quantity of PDUs required for successfully decoding the first PDU group may be represented by a success ratio, and the success ratio (also referred to as a success proportion) is a ratio of the quantity of PDUs required for successfully decoding the first PDU group to a total quantity of PDUs in the first PDU group. In some scenarios, the foregoing quantity of PDUs required for successfully decoding the first PDU group may be a minimum value of the quantity of PDUs required for successfully decoding the first PDU group, or a quantity of fewest PDUs required for successfully decoding the first PDU group. In a possible implementation, the quantity of PDUs required for successfully decoding the first PDU group may be represented by a successful decoding threshold, and the successful decoding threshold may be a minimum value of the quantity of PDUs required for successfully decoding the first PDU group.

Accordingly, the receive end may perform the first operation based on the foregoing data about the first PDU. Alternatively, the foregoing step S410 includes: performing, by the receive end, the first operation for the first PDU based on a first PDU quantity. Alternatively, the receive end performs the first operation for the first PDU based on a first PDU quantity and a quantity of PDUs transmitted successfully in the first PDU. Alternatively, the receive end performs the first operation for the first PDU based on a first PDU quantity and a quantity of PDUs not transmitted successfully in the first PDU. Alternatively, the receive end performs the first operation for the first PDU based on a first PDU quantity, a quantity of PDUs not transmitted successfully in the first PDU, and a total quantity of PDUs in the first PDU. A process in which the receive end performs the first operation based on the first PDU quantity is described in detail below. For brevity, details are not described herein again.

If the first information includes information for indicating a quantity of PDUs required for successfully recovering the first PDU group, accordingly, the receive end may determine, based on the first information, the quantity of PDUs required for successfully recovering the first PDU group. The quantity of PDUs required for successfully recovering the first PDU group may be represented by a successful recovery ratio (also referred to as a successful recovery proportion), and the successful recovery ratio is a ratio of the quantity of PDUs required for successfully recovering the first PDU group to a total quantity of PDUs in the first PDU group.

If the first information includes information for indicating a quantity of PDUs transmitted successfully in the first PDU group when a condition of successfully decoding the first PDU group is met, accordingly, the receive end may determine, based on the first information, the quantity of PDUs transmitted successfully in the first PDU group when the condition of successfully decoding the first PDU group is met. The quantity of PDUs transmitted successfully may be represented by a successful transmission ratio (also referred to as a successful transmission proportion), and the successful transmission ratio is a ratio of the quantity of PDUs transmitted successfully to a total quantity of PDUs in the first PDU group.

It may be learned from content of the first information described above that, in embodiments of this application, the first information is associated with the first PDU group, or the first information is associated with the first PDU, or the first information is associated with a PDU set, or the first information is associated with part of or all of PDUs in the first PDU.

As described above, PDUs included in the first PDU may belong to a PDU set, or may belong to a plurality of PDU sets. The first information mentioned above may be applicable to the foregoing two scenarios. However, in some cases, when PDUs included in the first PDU belong to a plurality of PDU sets, the foregoing first information may alternatively include one or more of following information: information for indicating a PDU set, on which integrated packet handling needs to be performed, in the first PDU group; information for indicating a target PDU set in the first PDU group; or information for indicating a PDU set, on which differentiated packet handling needs to be performed, in the first PDU group.

In one case, the first information includes the information for indicating a target PDU set in the first PDU group, where the target PDU set is a PDU set of an identification class, or the target PDU set is a PDU set having the highest priority in PDU sets included in the first PDU group.

In one case, the first information includes information for indicating a PDU set, on which differentiated packet handling needs to be performed, in the first PDU group. The differentiated packet handling is described in detail above. For brevity, details are not described herein again.

In some implementations, the foregoing first information may be determined based on one or more of following information: a network load status, QoS information of the first PDU group, QoS information of the first PDU, or QoS information of a PDU set. For example, the first information may indicate, based on the foregoing information, a PDU and/or PDU set to be discarded. For another example, the first information may indicate, based on the foregoing information, a type of a PDU set to be discarded. For another example, the first information may indicate, based on the foregoing information, a type of a PDU to be discarded in the first PDU group.

Content of the first information in embodiments of this application is described above, and a manner of acquiring the first information is described below. In embodiments of this application, the first information may be predefined, or the first information may be preconfigured. Certainly, the first information may also be indicated to the receive end.

When the first information is indicated to the receive end, the foregoing first information may be transmitted by a first entity to the receive end. In other words, the foregoing method further includes: receiving, by the receive end, the first information transmitted by the first entity.

If the receive end is a terminal device, the foregoing first entity includes one or more of a network device, an application layer of the terminal device, an entity of the terminal device, an application server, an application function AF, a decoder, an encoder, a core network entity, a session management function SMF, or a user plane function UPF.

If the receive end is a network device, the foregoing first entity includes one or more of a terminal device, an application server, an AF, a decoder, an encoder, a core network entity, an SMF, or a UPF.

It should be noted that there are many manners of triggering the first information in embodiments of this application. For example, the first information may be periodically indicated to the receive end. For another example, the first information may be non-periodically indicated to the receive end. For another example, the first information may be triggered by an event. For another example, the first information may alternatively be acquired by using a request. A manner in which the receive end acquires the first information is described below by using an example in which the receive end is a network device. It should be understood that manners described below are not only applicable to the network device, but also applicable to another device (for example, a terminal device) as the receive end to acquire the first information.

For example, for a decoder with a relatively strong decoding capability, data in the first PDU group may be decoded based on fewer PDUs. For a decoder with a relatively weak decoding capability, data in the first PDU group may be decoded based on more or even all PDUs. Therefore, the network device may acquire the first information based on a decoding capability of the decoder.

For another example, for a decoder with a relatively strong decoding capability, data in the first PDU group may be decoded based on fewer PDUs. For a decoder with a relatively weak decoding capability, data in the first PDU group may be decoded based on more or even all PDUs. Therefore, the network device may acquire the first information based on a type of the decoder.

For another example, the network device may transmit, to the first entity, a request message used for requesting the first information, and the network device may receive, in response to the request message, the first information transmitted by the first entity.

For another example, in a case that the first information may be changed based on a capability of an application server or a processing status, the network device may periodically acquire the first information.

It should be noted that, that the receive end acquires the first information from the first entity described above may be understood as that the receive end directly acquires the first information from the first entity, or may be understood as that the receive end acquires the first information from another entity (for example, a second entity) via the first entity, or the second entity first transmits the first information to the first entity, and then the first entity transmits the first information to the receive end. In some implementations, the second entity may include one or more of an application layer of the terminal device, an entity of the terminal device, an application server, an AF, a decoder, an encoder, or a core network entity. Accordingly, the second entity may include an SMF or a UPF.

For example, when the first entity is an access network device or a UPF, and the second entity is an SMF, the SMF may acquire the first information based on a type or a capability of the decoder, and transmit the first information to the access network device or the UPF.

For another example, when the first entity is an SMF, and the second entity is an application server, the application server may transmit the first information to the SMF, and the SMF transmits the first information to the network device.

For another example, when the first entity is an application layer of the terminal device, the application layer of the terminal device may transmit the first information to the network device.

As described above, the receive end may alternatively be a terminal device. When the receive end is a terminal device, the terminal device may also acquire the first information in a requesting manner. For example, the terminal device may transmit, to a network device, a request message used for requesting the first information. Accordingly, in response to the request message, the network device acquires the first information from the first entity, and transmits the first information to the terminal device.

Content of the first information and transmission manners of the first information are described above. The first operation performed by the receive end based on the first information is described below.

In some implementations, the performing a first operation includes one or more of the following operations: determining a type of part of or all of PDUs in the first PDU; determining a processing order of part of or all of PDUs in the first PDU; determining a priority or a priority level of part of or all of PDUs in the first PDU; determining independent decoding information of part of or all of PDUs in the first PDU; determining a dependency relationship of part of or all of PDUs in the first PDU in a coding and/or decoding process; whether to discard part of or all of PDUs in the first PDU; whether to transmit discard indication of discarding part of or all of PDUs in the first PDU; whether to feed back a transmission status of part of or all of PDUs in the first PDU; whether to transmit feedback information of successfully receiving part of or all of PDUs in the first PDU; determining whether part of or all of PDUs in the first PDU are transmitted successfully; whether to instruct to retransmit or transmit part of or all of PDUs in the first PDU; whether to perform integrated packet handling on part of or all of PDUs in the first PDU; whether to generate a first data packet, where the first data packet includes part of or all of PDUs in the first PDU; whether to deliver a second data packet to a higher layer, where the second data packet includes part of or all of PDUs in the first PDU; whether to cache a data packet including part of or all of PDUs in the first PDU; whether to cache part of or all of PDUs in the first PDU; whether to perform re-ordering on part of or all of PDUs in the first PDU; whether to deliver part of or all of PDUs in the first PDU to a higher layer in a first order; or whether to deliver part of or all of PDUs in the first PDU to a lower layer in a second order.

The following uses an example in which the first operation includes any one of the foregoing operations. It should be noted that the first operation may include the foregoing plurality of operations. For example, when discarding part of or all of PDUs in the first PDU, the receive end may transmit discard indication of discarding part of or all of PDUs in the first PDU. For brevity, examples are not listed below one by one.

In Case 1, the performing a first operation includes determining a type of part of or all of PDUs in the first PDU, where a type of a PDU may indicate, for example, whether data carried in the PDU is an I frame, a P frame, or the like described above. Certainly, the type of a PDU may alternatively indicate a priority of the PDU, a dependency degree of the PDU, or the like. This is not limited in embodiments of this application.

In Case 2, the performing a first operation includes determining a processing order of part of or all of PDUs in the first PDU. The processing order may be determined based on priorities of part of or all of PDUs in the first PDU. A PDU having a higher priority may be prioritized for processing, anda PDU having a lower priority may be processed after the PDU having a higher priority is processed.

In Case 3, the performing a first operation includes determining a priority or a priority level of part of or all of PDUs in the first PDU. Alternatively, the receive end may determine, based on the first information, a priority or a priority level of part of or all of PDUs in the first PDU.

In Case 4, the performing a first operation includes determining independent decoding information of part of or all of PDUs in the first PDU. The independent decoding information may indicate whether a corresponding PDU may be independently decoded. In some implementations, each PDU in the first PDU may correspond to a piece of dedicated independent decoding information. In some other implementations, a plurality of PDUs in the first PDU may share one piece of independent decoding information. This is not limited in embodiments of this application.

In Case 5, the performing a first operation includes determining a dependency relationship of part of or all of PDUs in the first PDU in a coding and/or decoding process. In other words, the receive end may determine which PDUs in the first PDU have a dependency relationship, thereby performing joint decoding subsequently on PDUs having a dependency relationship.

In Case 6, if the performing a first operation includes whether to discard part of or all of PDUs in the first PDU, before performing the first operation, the receive end may first determine whether to discard part of or all of PDUs in the first PDU, and then discard part of or all of PDUs in the first PDU after determining to discard the PDUs. Otherwise, the receive end may not discard part of or all of PDUs in the first PDU. Certainly, the receive end may alternatively directly discard part of or all of PDUs in the first PDU based on the first information, or the receive end may not directly discard part of or all of PDUs in the first PDU based on the first information.

As described above, the first PDU may include part of or all of PDUs in a PDU set. When the first PDU includes all PDUs in the PDU set, discarding all PDUs in the first PDU described above may be understood as discarding all PDUs in the PDU set.

The first operation may be understood as being performed by the receive end, or may be understood as being performed by a protocol layer of the receive end. The protocol layer may be, for example, a PDCP layer, an SDAP layer, an RLC layer, or a MAC layer. For ease of understanding, the following uses a PDCP layer as an example to describe the first operation. In addition, the following describes two scenarios in which the receive end may recover the first PDU based on part of PDUs and the receive end may need to recover the first PDU based on all PDUs, with examples provided for each scenario.

In Scenario 1, the receive end may need to recover the first PDU based on all PDUs.

For example, the first PDU includes a PDU 1. When a PDCP layer of the receive end determines that the PDU 1 is lost, the PDCP layer of the receive end may delete another PDU in the first PDU. In a possible implementation, the PDCP layer of the receive end may indicate a corresponding RLC entity, and delete the another PDU in the first PDU or a lower-layer SDU corresponding to the another PDU. Generally, the PDCP layer of the receive end may determine, based on feedback from a lower protocol layer, that the PDU 1 is lost, or the PDCP layer of the receive end may determine, based on timeout of a timer, that the PDU 1 is lost.

For another example, the first PDU includes a PDU 1. When the PDCP layer of the receive end determines that a transmission delay of the PDU 1 is greater than or equal to a PDB of the first PDU, the PDCP layer of the receive end may delete the another PDU in the first PDU.

For another example, PDUs in the first PDU are transmitted by using a plurality of RLC layers, and when a PDU transmitted by using one RLC layer in the plurality of RLC layers is lost, the PDCP layer of the receive end may discard another PDU, transmitted by using another RLC layer, in the first PDU.

It should be noted that the another PDU described above may be understood as another PDU, different from the PDU 1, in the first PDU. For example, the another PDU may be a data packet (for example, a PDCP PDU) received by the receive end. For example, the another PDU may alternatively be a PDU that is not delivered to a higher layer. In addition, the PDU 1 may represent one PDU or a plurality of PDUs.

In Scenario 2, the receive end may recover the first PDU based on part of PDUs, where the part of PDUs may be, for example, PDUs of a first PDU quantity.

For example, when the PDCP layer of the receive end determines that PDUs of the first PDU quantity in the first PDU are transmitted successfully, the PDCP layer of the receive end may delete the another PDU in the first PDU. Generally, the PDCP layer of the receive end may determine, based on feedback from a lower protocol layer, that PDUs of the first PDU quantity are transmitted successfully, or the PDCP layer of the receive end may determine, based on timeout of a timer, that the PDUs of the first PDU quantity are lost.

For another example, when the PDCP layer of the receive end determines that a quantity of PDUs transmitted successfully in the first PDU does not reach the first PDU quantity, the PDCP layer of the receive end may delete the PDUs transmitted successfully in the first PDU. Generally, the PDCP layer of the receive end may determine, based on feedback from a lower protocol layer, that the another PDU in the first PDU is lost, or the PDCP layer of the receive end may determine, based on timeout of a timer, that the another PDU in the first PDU is lost.

For another example, when the PDCP layer of the receive end determines that a transmission delay of PDUs of the first PDU quantity in the first PDU is greater than or equal to a PDB of the first PDU, the PDCP layer of the receive end may delete the another PDU in the first PDU.

It should be noted that the another PDU may be a data packet (for example, a PDCP PDU) received by the receive end, or may be a PDU that is not delivered to a higher layer.

As described above, if the PDCP layer of the receive end needs to delete the another PDU, the PDCP layer of the receive end needs to identify a PDU that needs to be deleted. In some implementations, the PDCP layer of the receive end may identify, based on information such as packet header information, a higher layer user plane indication, or a higher layer control plane indication, a PDU to be deleted. This is not limited in embodiments of this application.

In some implementations, assuming that the first PDU includes a plurality of PDU sets, the PDCP layer of the receive end may perform re-ordering) on PDU sets in the plurality of PDU sets. Certainly, the PDCP layer of the receive end may alternatively stop the foregoing reordering timer.

In some implementations, assuming that the first PDU includes a plurality of PDU sets, the PDCP layer of the receive end may perform re-ordering on PDUs in one PDU set. Certainly, the PDCP layer of the receive end may alternatively stop the foregoing reordering timer.

In some implementations, assuming that the first PDU includes a plurality of PDU sets, and after a PDU set 1 to which the PDU 1 belongs is discarded, the PDCP layer of the receive end may perform re-ordering on remaining PDU sets in the plurality of PDU sets. Certainly, the PDCP layer of the receive end may alternatively stop the foregoing reordering timer.

In the foregoing cases, the first information may be determined based on one or more of following information: a network load status, QoS information of the first PDU group, QoS information of the first PDU, or QoS information of a PDU set. For example, the first information may indicate, based on the foregoing information, a PDU and/or PDU set to be discarded. For another example, the first information may indicate, based on the foregoing information, a type of a PDU set to be discarded. For another example, the first information may indicate, based on the foregoing information, a type of a PDU to be discarded in the first PDU group. Accordingly, the receive end may perform discarding based on the first information.

For example, a base station may transmit the first information to the terminal device, and accordingly, the terminal device discards a PDU to be discarded.

For another example, a core network may transmit the first information to a base station, and accordingly, the base station discards a PDU to be discarded.

For another example, a core network may transmit the first information to a base station, and then the base station transmits the first information or related information of the first information to the terminal device. Accordingly, the terminal device discards a PDU to be discarded.

For another example, a core network may transmit the first information, such as NAS signalling, to the terminal device, and accordingly, the terminal device discards a PDU to be discarded.

In Case 7, if the performing a first operation includes whether to transmit discard indication of discarding part of or all of PDUs in the first PDU, before performing the first operation, the receive end may perform one or more of following operations: determining whether to transmit the discard indication, transmitting the discard indication by the receive end, or not transmitting the discard indication by the receive end.

The first operation may be understood as being performed by the receive end, or may be understood as being performed by a protocol layer of the receive end. The protocol layer may be, for example, a PDCP layer, an SDAP layer, an RLC layer, or a MAC layer.

In some scenarios, the first PDU includes all PDUs in the first PDU group and the first PDU group includes one PDU set. In this case, if the discard indication instructs to delete all PDUs in the first PDU, it may be understood that the receive end transmits discard indication of deleting the PDU set. For example, the PDCP layer (as an instance of a first protocol layer) of the receive end instructs a lower protocol layer (also referred to as a “second protocol layer”) to delete the PDU set, where the first protocol layer is a layer higher than the second protocol layer.

For ease of understanding, the following uses a PDCP layer as an example to describe the first operation. In addition, the following describes two scenarios in which the receive end may recover the first PDU based on part of PDUs and the receive end may need to recover the first PDU based on all PDUs, with examples provided for each scenario.

In Scenario 1, the receive end may need to recover the first PDU based on all PDUs.

For example, the first PDU includes a PDU 2. Accordingly, when the PDCP layer determines that the PDU 2 is lost, the PDCP layer of the receive end may transmit discard indication to a lower protocol layer, to instruct the lower protocol layer to delete an another PDU in the first PDU. Generally, the PDCP layer of the receive end may determine, based on feedback from a lower protocol layer, that the PDU 2 is lost, or the PDCP layer of the receive end may determine, based on timeout of a timer, that the PDU 2 is lost.

For another example, the first PDU includes a PDU 2. When the PDCP layer of the receive end determines that a transmission delay of the PDU 2 is greater than or equal to a PDB of the first PDU, the PDCP layer of the receive end may transmit discard indication to a lower protocol layer, to instruct the lower protocol layer to delete an another PDU in the first PDU.

For another example, PDUs in the first PDU are transmitted by using a plurality of RLC layers, and when a PDU transmitted by using one RLC layer in the plurality of RLC layers is lost, the PDCP layer of the receive end may transmit discard indication to the another RLC layer, to instruct the another RLC layer to discard the another PDU in the first PDU.

The another PDU described above may be understood as another PDU, different from the PDU 2, in the first PDU. For example, the another PDU may be a data packet (for example, a PDCP PDU) received by the receive end. For example, the another PDU may alternatively be a PDU that is not delivered to a higher layer. In addition, the PDU 2 may represent one PDU or a plurality of PDUs.

In Scenario 2, the receive end may recover the first PDU based on part of PDUs, where the part of PDUs may be, for example, PDUs of a first PDU quantity.

For example, when the PDCP layer of the receive end determines that PDUs of the first PDU quantity are transmitted successfully, the PDCP layer of the receive end may transmit discard indication to a lower protocol layer, to instruct the lower protocol layer to delete an another PDU in the first PDU. Generally, the PDCP layer of the receive end may determine, based on feedback from a lower protocol layer, that PDUs of the first PDU quantity are transmitted successfully, or the PDCP layer of the receive end may determine, based on timeout of a timer, that the PDUs of the first PDU quantity are transmitted successfully.

For example, when the PDCP layer of the receive end determines that a quantity of PDUs transmitted successfully in the first PDU does not reach the first PDU quantity, the PDCP layer of the receive end may transmit discard indication to a lower protocol layer, to instruct the lower protocol layer to delete an another PDU in the first PDU. Generally, the PDCP layer of the receive end may determine, based on feedback from a lower protocol layer, that a quantity of PDUs transmitted successfully does not reach the first PDU quantity, or the PDCP layer of the receive end may determine, based on timeout of a timer, that a quantity of PDUs transmitted successfully does not reach the first PDU quantity.

For another example, when the PDCP layer of the receive end determines that a transmission delay of PDUs transmitted successfully in the first PDU is greater than or equal to a PDB of the first PDU, and a quantity of the PDUs transmitted successfully does not reach the first PDU quantity, the PDCP layer of the receive end may transmit discard indication to a lower protocol layer, to instruct the lower protocol layer to delete an another PDU in the first PDU.

It should be noted that the foregoing lower protocol layer may be, for example, an RLC layer. Accordingly, the RLC layer may perform at least one of following actions: deleting the another PDU, clearing cache corresponding to the another PDU, or stopping a re-assembly timer corresponding to the another PDU.

It may be understood that the another PDU described above are a data packet (for example, a PDCP PDU) received by the receive end. Alternatively, it may be understood that the another PDU may be a PDU that is not delivered to a higher layer.

As described above, if the PDCP layer of the receive end needs to instruct a lower protocol layer to delete the another PDU, the PDCP layer of the receive end needs to identify PDUs that need to be deleted. In some implementations, the PDCP layer of the receive end may identify, based on information such as packet header information, a higher layer user plane indication, or a higher layer control plane indication, a PDU to be deleted. This is not limited in embodiments of this application.

In some implementations, assuming that the first PDU includes a plurality of PDU sets, the PDCP layer of the receive end may perform re-ordering on PDU sets in the plurality of PDU sets. Certainly, the PDCP layer of the receive end may alternatively stop the foregoing reordering timer.

In some implementations, assuming that the first PDU includes a plurality of PDU sets, the PDCP layer of the receive end may perform re-ordering on PDUs in one PDU set. Certainly, the PDCP layer of the receive end may alternatively stop the foregoing reordering timer.

In some implementations, assuming that the first PDU includes a plurality of PDU sets, and after a PDU set to which the PDU 2 belongs is discarded, the PDCP layer of the receive end may perform re-ordering on remaining PDU sets in the plurality of PDU sets. Certainly, the PDCP layer of the receive end may alternatively stop the foregoing re-assembly timer.

In Case 8, if the performing a first operation includes whether to feed back a transmission status of part of or all of PDUs in the first PDU, the receive end may determine whether to feed back the transmission status of part of or all of PDUs in the first PDU, or the receive end may feed back the transmission status of part of or all of PDUs in the first PDU, or the receive end may do not feed back the transmission status of part of or all of PDUs in the first PDU.

In some implementations, the transmission status may be carried in feedback information, and the feedback information may include at least one of the following: a sequence number SN, an identity, or an ACK/NACK. In some other implementations, the feedback information may include at least one of following: an SN of the first PDU with a transmission error in the first PDU, an identify of the first PDU with a transmission error in the first PDU, or an ACK/NACK.

The SN may be an SN of the first PDU, or may be an SN of at least one PDU in the first PDU, or may be an SN of a PDU set. It should be noted that there may be one or more corresponding SNs.

The identify may be an identify of the first PDU, or may be an identify of at least one PDU in the first PDU, or may be an identify of a PDU set. It should be noted that there may be one or more corresponding identities.

In Case 9, if the performing a first operation described above includes whether to transmit feedback information of successfully receiving part of or all of PDUs in the first PDU, the transmit end may perform the first operation based on the feedback information. The feedback information may be from the receive end. Accordingly, the receive end may perform at least one of following operations: determining whether to transmit the feedback information, transmitting the feedback information, or not transmitting the feedback information.

Accordingly, when the receive end receives the foregoing feedback information, the receive end may determine, based on the feedback information, whether to continue to transmit or retransmit the first PDU. In some scenarios, if feedback information corresponding to the first PDU indicates that the PDU fails to be transmitted, the transmit end may retransmit (or transmit) the first PDU. Certainly, the transmit end may alternatively not retransmit (or transmit) the first PDU. In some other scenarios, if feedback information corresponding to the first PDU indicates that the PDU is transmitted successfully, the transmit end may not retransmit (or transmit) the first PDU.

In some implementations, the feedback information may be a NACK or an ACK. When the feedback information is a NACK, it may be used to indicate that a corresponding PDU fails to be transmitted, or may be used to indicate that a corresponding PDU is lost, or may be used to indicate that a transmission delay of a corresponding PDU is greater than or equal to a PDB corresponding to a PDU set to which the PDU belongs.

The first operation may be understood as being performed by the receive end, or may be understood as being performed by a protocol layer of the receive end. The protocol layer may be, for example, a PDCP layer, an SDAP layer, an RLC layer, or a MAC layer. For ease of understanding, the following uses a PDCP layer as an example to describe the first operation. In addition, the following describes two scenarios in which the receive end may recover the first PDU based on part of PDUs and the receive end may need to recover the first PDU based on all PDUs, with examples provided for each scenario.

In Scenario 1, the receive end may need to recover the first PDU based on all PDUs.

For example, the first PDU includes a PDU 3, and whether transmission of the PDU 3 is successful does not affect decoding of the first PDU. Accordingly, when the PDCP layer determines that the PDU 3 is lost, the PDCP layer of the receive end may set feedback information corresponding to the first PDU as an ACK, and transmit the feedback information to the transmit end. Generally, the PDCP layer of the receive end may determine, based on feedback from a lower protocol layer, that the PDU 3 is lost, or the PDCP layer of the receive end may determine, based on timeout of a timer, that the PDU 3 is lost. Accordingly, after receiving the feedback information, the transmit end may no longer transmit the PDU 3.

For another example, the first PDU includes a PDU 3, and whether transmission of the PDU 3 is successful does not affect decoding of the first PDU. When the PDCP layer of the receive end determines that a transmission delay of the PDU 3 is greater than or equal to a PDB of the first PDU, the PDCP layer of the receive end may set feedback information corresponding to the first PDU as an ACK, and transmit the feedback information to the transmit end. Accordingly, after receiving the feedback information, the transmit end may no longer transmit the PDU 3.

For another example, the first PDU includes a PDU 3, and whether transmission of the PDU 3 is successful affects decoding of the first PDU. Accordingly, when the PDCP layer determines that the PDU 3 is lost, the PDCP layer of the receive end may set feedback information corresponding to the first PDU as a NACK, to indicate that the first PDU is not received successfully, and transmit the feedback information to the transmit end. Generally, the PDCP layer of the receive end may determine, based on feedback from a lower protocol layer, that the PDU 3 is lost, or the PDCP layer of the receive end may determine, based on timeout of a timer, that the PDU 3 is lost. Accordingly, after receiving the feedback information, the transmit end needs to retransmit the PDU 3.

For another example, the first PDU includes a PDU 3, and whether transmission of the PDU 3 is successful affects decoding of the first PDU. When the PDCP layer of the receive end determines that a transmission delay of the PDU 3 is greater than or equal to a PDB of the first PDU, the PDCP layer of the receive end may set feedback information corresponding to the first PDU as a NACK. Accordingly, after receiving the feedback information, the transmit end needs to retransmit the PDU 3.

In Scenario 2, the receive end may recover the first PDU based on part of PDUs, where the part of PDUs may be, for example, PDUs of a first PDU quantity.

For example, after PDUs of the first PDU quantity in the first PDU are successfully transmitted to the receive end, the PDCP layer of the receive end may set feedback information corresponding to the first PDU as an ACK, and transmit the feedback information to the transmit end. Generally, the PDCP layer of the receive end may determine, based on feedback from a lower protocol layer, that PDUs of the first PDU quantity are transmitted successfully, or the PDCP layer of the receive end may determine, based on whether a timer expires, that the PDUs of the first PDU quantity are transmitted successfully. Accordingly, after receiving the feedback information, the transmit end may no longer transmit the first PDU.

For another example, if a quantity of PDUs transmitted successfully in the first PDU is less than the first PDU quantity, the PDCP layer of the receive end may set feedback information corresponding to the first PDU as an ACK, and transmit the feedback information to the transmit end. Generally, the PDCP layer of the receive end may determine, based on feedback from a lower protocol layer, a quantity of PDUs transmitted successfully, or the PDCP layer of the receive end may determine, based on whether a timer expires, a quantity of PDUs transmitted successfully in the first PDU. Accordingly, after receiving the feedback information, the transmit end may no longer transmit the first PDU.

For another example, if a quantity of PDUs transmitted successfully in the first PDU is less than the first PDU quantity, the PDCP layer of the receive end may set feedback information corresponding to the first PDU as a NACK, and transmit the feedback information to the transmit end. Generally, the PDCP layer of the receive end may determine, based on feedback from a lower protocol layer, a quantity of PDUs transmitted successfully, or the PDCP layer of the receive end may determine, based on whether a timer expires, a quantity of PDUs transmitted successfully in the first PDU. Accordingly, after receiving the feedback information, the transmit end needs to retransmit the first PDU.

For another example, a quantity of PDUs transmitted successfully in the first PDU is less than the first PDU quantity, and a transmission delay of the PDUs transmitted successfully is less than a PDB of the first PDU. In this case, the PDCP layer of the receive end may set feedback information corresponding to the first PDU as a NACK, to indicate that the first PDU is not successfully received, and transmit the feedback information to the transmit end. Accordingly, after receiving the feedback information, the transmit end needs to retransmit the first PDU.

It should be noted that the feedback information corresponding to the first PDU may be understood as feedback information corresponding to an SN or an identify corresponding to the first PDU, or feedback information corresponding to a plurality of SNs or identities corresponding to the first PDU. Alternatively, the feedback information corresponding to the first PDU may be feedback for the first PDU, or may be feedback for at least one PDU in the first PDU, or may be feedback for a PDU set.

In some implementations, the feedback information may include at least one of following: a sequence number SN, an identity, or an ACK/NACK. In some other implementations, the feedback information may include at least one of following: an SN corresponding to the first PDU with a transmission error, a quantity of consecutive transmission errors, an identity corresponding to a PDU with a transmission error, or an ACK/NACK.

The SN may be an SN of the first PDU, or may be an SN of at least one PDU in the first PDU, or may be an SN of a PDU set. It should be noted that there may be one or more corresponding SNs.

The identify may be an identify of the first PDU, or may be an identify of at least one PDU in the first PDU, or may be an identify of a PDU set. It should be noted that there may be one or more corresponding identities.

In addition, if the PDCP layer of the receive end needs to feed back feedback information for a PDU, the PDCP layer of the receive end needs to identify the PDU for which feedback is required. In some implementations, the PDCP layer of the receive end may identify, based on information such as packet header information, higher layer user plane indication, or higher layer control plane indication, the PDU for which feedback is required. This is not limited in embodiments of this application.

In Case 10, if the performing a first operation described above includes determining whether part of or all of PDUs in the first PDU are transmitted successfully, the receive end may determine, based on the first information, whether part of or all of PDUs in the first PDU are transmitted successfully. In some implementations, the receive end may determine, based on the first information, a PDU included in the first PDU, and determine whether the PDU included in the first PDU is received successfully.

In Case 11, if the performing a first operation described above includes whether to instruct to retransmit or transmit part of or all of PDUs in the first PDU, the receive end may determine, based on the first information, whether to instruct to retransmit or transmit part of or all of PDUs in the first PDU, and when it is determined to perform instruction, instruct the transmit end to retransmit or transmit part of or all of PDUs in the first PDU. Otherwise, the receive end does not instruct the transmit end to retransmit or transmit part of or all of PDUs in the first PDU. Certainly, the receive end may alternatively directly instruct to retransmit or transmit part of or all of PDUs in the first PDU based on the first information, or the receive end may not directly instruct to retransmit or transmit part of or all of PDUs in the first PDU based on the first information.

In some implementations, the receive end may instruct, by using the feedback information described above, whether to retransmit or transmit part of or all of PDUs in the first PDU. Certainly, the receive end may alternatively instruct, by using dedicated indication information, whether to retransmit or transmit part of or all of PDUs in the first PDU.

In addition, an indication manner of the receive end is similar to the manner in which the receive end transmits the feedback information in Case 9 above. Accordingly, a manner in which the transmit end determines, based on the indication of the receive end, whether to retransmit (or transmit) part of or all of PDUs in the first PDU is also similar. For brevity, details are not described below again.

In Case 12, if the performing a first operation described above includes whether to perform integrated packet handling on part of or all of PDUs in the first PDU, the receive end may determine, based on the first information, whether to perform integrated packet handling on part of or all of PDUs in the first PDU, and when it is determined to perform integrated packet handling, perform integrated packet handling on part of or all of PDUs in the first PDU. Otherwise, the receive end does not perform integrated packet handling on part of or all of PDUs in the first PDU. Certainly, the receive end may alternatively directly perform integrated packet handling on part of or all of PDUs in the first PDU based on the first information, or the receive end may not directly perform integrated packet handling on part of or all of PDUs in the first PDU based on the first information.

In some implementations, after performing integrated packet handling on part of or all of PDUs in the first PDU, the receive end may generate a new PDU. The new PDU may be a PDU that is to be delivered to a higher protocol layer. The new PDU may be, for example, a PDCP PDU, an SDAP PDU, an RLC PDU, or a MAC PDU.

In some other implementations, the receive end may perform reordering processing on part of or all of PDUs in the first PDU. Certainly, the receive end may alternatively not perform reordering processing. In this case, the receive end may stop a reordering timer.

The first operation may be understood as being performed by the receive end, or may be understood as being performed by a protocol layer of the receive end. The protocol layer may be, for example, a PDCP layer, an SDAP layer, an RLC layer, or a MAC layer. For ease of understanding, the following uses a PDCP layer as an example to describe the first operation. In addition, the following describes two scenarios in which the receive end may recover the first PDU based on part of PDUs and the receive end may need to recover the first PDU based on all PDUs, with examples provided for each scenario.

In Scenario 1, the PDCP layer of the receive end may recover the first PDU based on part of PDUs. For example, part of PDUs may be, for example, PDUs of the first PDU quantity.

For example, the PDCP layer of the receive end determines that PDUs of the first PDU quantity are transmitted successfully, and the PDCP layer of the receive end may perform integrated packet handling on part of PDUs in the first PDU, and deliver the PDUs obtained after the integrated packet handling to a higher layer.

In Scenario 2, the PDCP layer of the receive end may recover the first PDU based on all of PDUs.

For example, the PDCP layer of the receive end determines that all PDUs in the first PDU are transmitted successfully, and the PDCP layer of the receive end may perform integrated packet handling on all of PDUs in the first PDU, and deliver the PDUs obtained after the integrated packet handling to a higher layer.

In Case 13, if the performing a first operation described above includes whether to generate a first data packet, the first data packet includes part of or all of PDUs in the first PDU, the receive end may determine, based on the first information, whether to generate a first data packet, and after determining to generate a first data packet, generate a first data packet. Otherwise, the receive end may not generate a first data packet. Certainly, the receive end may alternatively directly generate a first data packet based on the first information, or the receive end may not directly generate a first data packet based on the first information.

In some implementations, after performing integrated packet handling on part of or all of PDUs in the first PDU, the receive end may generate a first data packet. The first data packet may be a data packet that is to be delivered to a higher protocol layer.

In some other implementations, the receive end may perform reordering processing on part of or all of PDUs in the first PDU in a process of generating a first data packet. Certainly, the receive end may alternatively not perform reordering processing. In this case, the receive end may stop a reordering timer.

The first operation may be understood as being performed by the receive end, or may be understood as being performed by a protocol layer of the receive end. The protocol layer may be, for example, a PDCP layer, an SDAP layer, an RLC layer, or a MAC layer.

For ease of understanding, the following uses a PDCP layer as an example to describe the first operation. In addition, the following describes two scenarios in which the receive end may recover the first PDU based on part of PDUs and the receive end may need to recover the first PDU based on all PDUs, with examples provided for each scenario.

In Scenario 1, the PDCP layer of the receive end may recover the first PDU based on part of PDUs. For example, part of PDUs may be, for example, PDUs of the first PDU quantity.

For example, if the PDCP layer of the receive end determines that PDUs of the first PDU quantity are transmitted successfully, the PDCP layer of the receive end may perform integrated packet handling on part of PDUs in the first PDU, and deliver a first data packet obtained after the integrated packet handling to a higher layer.

In Scenario 2, the PDCP layer of the receive end may recover the first PDU based on all of PDUs.

For example, if the PDCP layer of the receive end determines that all PDUs in the first PDU are transmitted successfully, the PDCP layer of the receive end may perform integrated packet handling on all of PDUs in the first PDU, and deliver a first data packet obtained after the integrated packet handling to a higher layer.

In Case 14, the performing a first operation described above includes whether to deliver a second data packet to a higher layer (or a higher protocol layer). The second data packet includes part of or all of PDUs in the first PDU. When performing the first operation based on the first information, the receive end may first determine whether to deliver a second data packet, and after determining to deliver a second data packet, generate and deliver a second data packet to the higher layer. Otherwise, the receive end may not generate a second data packet. Certainly, the receive end may alternatively directly deliver a second data packet based on the first information, or the receive end may not directly deliver a second data packet based on the first information.

The first operation may be understood as being performed by the receive end, or may be understood as being performed by a protocol layer of the receive end. The protocol layer may be, for example, a PDCP layer, an SDAP layer, an RLC layer, or a MAC layer. In other words, after a protocol layer (also referred to as a “third protocol layer”) of the receive end generates a second data packet, the third protocol layer may transmit the second data packet to a fourth protocol layer of the receive end. The fourth protocol layer is a layer higher than the third protocol layer.

It should be noted that a manner in which the receive end generates a second data packet is the same as the foregoing manner of generating a first data packet. Reference may be made to related description in Case 13 above. For brevity, details are not described herein again.

In Case 15, if the performing a first operation described above includes whether to cache a data packet including part of or all of PDUs in the first PDU, the receive end may first determine, based on the first information, whether to cache the data packet, and when it is determined to cache the data packet, cache the data packet. Otherwise, the receive end may not cache the data packet. Certainly, the receive end may alternatively directly cache the data packet based on the first information, or the receive end may not directly cache the data packet based on the first information.

In some implementations, the receive end may perform reordering processing on PDUs in the data packet in a process of caching the data packet. Certainly, the receive end may alternatively not perform reordering processing. In this case, the receive end may stop a reordering timer.

The first operation may be understood as being performed by the receive end, or may be understood as being performed by a protocol layer of the receive end. The protocol layer may be, for example, a PDCP layer, an SDAP layer, an RLC layer, or a MAC layer. In addition, the following describes two scenarios in which the receive end may recover the first PDU based on part of PDUs and the receive end may need to recover the first PDU based on all PDUs, with examples provided for each scenario.

In Scenario 1, the PDCP layer of the receive end may recover the first PDU based on part of PDUs. For example, part of PDUs may be, for example, PDUs of the first PDU quantity.

For example, when the first information indicates the first PDU quantity, and the PDCP layer of the receive end determines that PDUs of the first PDU quantity are transmitted successfully, the PDCP layer of the receive end may determine, based on the first information, to cache a data packet including part of PDUs in the first PDU.

For another example, when the first information indicates the first PDU quantity, and the PDCP layer of the receive end determines that a quantity of PDUs transmitted successfully is less than the first PDU quantity, the PDCP layer of the receive end may determine, based on the first information, not to cache a data packet including part of PDUs in the first PDU.

In Scenario 2, the PDCP layer of the receive end may recover the first PDU based on all of PDUs.

For example, when the first information indicates that integrated packet handling is to be performed on all of PDUs in the first PDU, and the PDCP layer of the receive end determines that all of PDUs in the first PDU are transmitted successfully, the PDCP layer of the receive end may determine, based on the first information, to cache a data packet including all of PDUs in the first PDU.

For another example, when the first information indicates that integrated packet handling is to be performed on all of PDUs in the first PDU, and the PDCP layer of the receive end determines that part of PDUs in the first PDU fail to be transmitted, the PDCP layer of the receive end may determine, based on the first information, not to cache a data packet including all of PDUs in the first PDU.

In Case 16, if the performing a first operation described above includes whether to cache part of or all of PDUs (hereinafter referred to as a “PDU”) in the first PDU, the receive end may first determine, based on the first information, whether to cache the PDU, and when it is determined to cache the PDU, cache the PDU. Otherwise, the receive end may not cache the PDU. Certainly, the receive end may alternatively directly cache the PDU based on the first information, or the receive end may not directly cache the PDU based on the first information.

In some implementations, the receive end may perform reordering processing on the PDU in a process of caching the PDU. Certainly, the receive end may alternatively not perform reordering processing. In this case, the receive end may stop a reordering timer.

The first operation may be understood as being performed by the receive end, or may be understood as being performed by a protocol layer of the receive end. The protocol layer may be, for example, a PDCP layer, an SDAP layer, an RLC layer, or a MAC layer. In addition, the following describes two scenarios in which the receive end may recover the first PDU based on part of PDUs and the receive end may need to recover the first PDU based on all PDUs, with examples provided for each scenario.

In Scenario 1, the PDCP layer of the receive end may recover the first PDU based on part of PDUs. For example, part of PDUs may be, for example, PDUs of the first PDU quantity.

For example, when the first information indicates the first PDU quantity, and the PDCP layer of the receive end determines that PDUs of the first PDU quantity are transmitted successfully, the PDCP layer of the receive end may determine, based on the first information, to cache the PDUs of the first PDU quantity.

For another example, when the first information indicates the first PDU quantity, and the PDCP layer of the receive end determines that a quantity of PDUs transmitted successfully is less than the first PDU quantity, the PDCP layer of the receive end may determine, based on the first information, not to cache the PDUs that are transmitted successfully.

In Scenario 2, the PDCP layer of the receive end may recover the first PDU based on all of PDUs.

For example, when the first information indicates that integrated packet handling is to be performed on all of PDUs in the first PDU, and the PDCP layer of the receive end determines that all of PDUs in the first PDU are transmitted successfully, the PDCP layer of the receive end may determine, based on the first information, to cache all of PDUs in the first PDU.

For another example, when the first information indicates that integrated packet handling is to be performed on all of PDUs in the first PDU, and the PDCP layer of the receive end determines that part of PDUs in the first PDU fail to be transmitted, the PDCP layer of the receive end may determine, based on the first information, not to cache PDUs that are transmitted successfully.

In Case 17, if the performing a first operation described above includes whether to perform re-ordering on part of or all of PDUs in the first PDU, the receive end may first determine, based on the first information, whether to perform reordering processing on part of or all of PDUs in the first PDU, and when it is determined to perform reordering processing, perform re-ordering on part of or all of PDUs in the first PDU. Otherwise, the receive end may not perform re-ordering on part of or all of PDUs in the first PDU. Certainly, the receive end may alternatively directly perform re-ordering on part of or all of PDUs in the first PDU based on the first information, or the receive end may not directly perform re-ordering on part of or all of PDUs in the first PDU based on the first information.

The first operation may be understood as being performed by the receive end, or may be understood as being performed by a protocol layer of the receive end. The protocol layer may be, for example, a PDCP layer, an SDAP layer, an RLC layer, or a MAC layer.

In some implementations, if the receive end determines not to perform reordering, a reordering timer may be stopped.

In Case 18, if the performing a first operation described above includes whether to deliver part of or all of PDUs in the first PDU to a higher layer (a higher protocol layer of the receive end) in a first order, the receive end may first determine, based on the first information, whether to deliver part of or all of PDUs in the first PDU to the higher layer in the first order, and when it is determined to perform delivery, deliver part of or all of PDUs in the first PDU to the higher layer in the first order. Otherwise, the receive end may not deliver part of or all of PDUs in the first PDU to the higher layer. Certainly, the receive end may alternatively directly deliver part of or all of PDUs in the first PDU to the higher layer in the first order based on the first information, or the receive end may not directly deliver part of or all of PDUs in the first PDU to the higher layer in the first order based on the first information.

In some implementations, the first order may be an order obtained after the receive end reorders the PDUs in the first PDU. Certainly, the first order may alternatively be an order in which the receive end receives the PDUs in the first PDU.

In some other implementations, the first operation may be understood as being performed by the receive end, or may be understood as being performed by a protocol layer of the receive end. The protocol layer may be, for example, a PDCP layer, an SDAP layer, an RLC layer, or a MAC layer.

In Case 19, if the performing a first operation described above includes whether to deliver part of or all of PDUs in the first PDU to a higher layer (a higher protocol layer of the receive end) in a second order, the receive end may first determine, based on the first information, whether to deliver part of or all of PDUs in the first PDU to the higher layer in the second order, and when it is determined to deliver part of or all of PDUs in the first PDU to the higher layer in the second order, deliver part of or all of PDUs in the first PDU to the higher layer in the second order. Otherwise, the receive end may not deliver part of or all of PDUs in the first PDU to the higher layer. Certainly, the receive end may alternatively directly deliver part of or all of PDUs in the first PDU to the higher layer in the second order based on the first information, or the receive end may not directly deliver part of or all of PDUs in the first PDU to the higher layer in the second order based on the first information.

The second order may be determined based on a priority order of part of or all of PDUs in the first PDU. For example, the second order may be an order in which priorities corresponding to part of or all of PDUs in the first PDU are in descending order. For another example, the second order may be an order in which priorities corresponding to part of or all of PDUs in the first PDU are in ascending order. The second order may be determined based on sequence numbers of part of or all of PDUs in the first PDU. For example, the second order may be an order in which sequence numbers corresponding to part of or all of PDUs in the first PDU are in descending order. For another example, the second order may be an order in which sequence numbers corresponding to part of or all of PDUs in the first PDU are in ascending order.

In Case 20, if the performing a first operation described above includes determining, based on a transmission status of the first PDU, whether to discard another PDU, before performing the first operation, the receive end may first determine whether to discard the another PDU, and after it is determined to discard the another PDU, discard the another PDU. Otherwise, the receive end may not discard the another PDU. Certainly, the receive end may alternatively directly discard the another PDU based on the first information, or the receive end may not directly discard the another PDU based on the first information.

As described above, the another PDU may be understood as another PDU, different from the first PDU, in the first PDU group.

The first operation may be understood as being performed by the receive end, or may be understood as being performed by a protocol layer of the receive end. The protocol layer may be, for example, a PDCP layer, an SDAP layer, an RLC layer, or a MAC layer.

In some implementations, the receive end may determine, based on the first information and whether the first PDU is transmitted successfully, whether to discard the another PDU. For example, when the first PDU fails to be transmitted, the receive end may discard the another PDU based on the first information. For another example, when the first PDU is transmitted successfully, the receive end may continue to transmit the another PDU (or not to discard the another PDU) based on the first information.

In Case 21, if the performing a first operation described above includes performing low-priority processing on part of or all of PDUs in the first PDU, before performing the first operation, the receive end may first determine whether to perform low-priority processing on part of or all of PDUs in the first PDU, and when it is determined to perform low-priority processing, process part of or all of PDUs in the first PDU. Otherwise, the receive end may not perform low-priority processing on part of or all of PDUs in the first PDU. Certainly, the receive end may alternatively directly perform low-priority processing on part of or all of PDUs in the first PDU based on the first information, or the receive end may not directly perform low-priority processing on part of or all of PDUs in the first PDU based on the first information.

As described above, the first PDU may include part of or all of PDUs in a PDU set. When the first PDU includes all PDUs in the PDU set, performing the foregoing low-priority processing on all PDUs in the first PDU may be understood as performing low-priority processing on all PDUs in the PDU set.

It should be noted that the low-priority processing may include: when a PDU that requires low-priority processing conflicts with another PDU, skipping transmitting the PDU that requires low-priority processing. Certainly, a PDU that requires low-priority processing may alternatively be transmitted, which is not limited in embodiments of this application.

In the foregoing cases, the first information may be determined based on one or more of following information: a network load status, QoS information of the first PDU group, QoS information of the first PDU, or QoS information of a PDU set. For example, the first information may indicate, based on the foregoing information, a PDU and/or PDU set to be discarded. For another example, the first information may indicate, based on the foregoing information, a type of a PDU set to be discarded. For another example, the first information may indicate, based on the foregoing information, a type of a PDU to be discarded in the first PDU group. Accordingly, the receive end may perform, based on the first information, low-priority processing on a PDU indicated by the first information, or the receive end may perform, based on the first information, low-priority processing on another PDU different from the PDU indicated by the first information. This is not limited in embodiments of this application.

For example, a base station may transmit the first information to the terminal device, and accordingly, the terminal device performs low-priority processing based on the first information.

For another example, a core network may transmit the first information to a base station, and accordingly, the base station performs low-priority processing based on the first information.

For another example, a core network may transmit the first information to a base station, and then the base station transmits the first information or related information of the first information to the terminal device. Accordingly, the terminal device performs low-priority processing based on the first information or the related information of the first information.

For another example, a core network may transmit the first information, such as NAS signalling, to the terminal device, and accordingly, the terminal device performs low-priority processing based on the first information.

The first operation for PDUs in the first PDU is described above with reference to Case 1 to Case 21. As described above, if the first PDU includes all PDUs in the first PDU group, the first operation may be understood as a first operation for all of or each of PDUs in the first PDU group. If the first PDU includes only part of PDUs in the first PDU group, the first operation for another PDU in the first PDU group (that is, another PDU, different from the first PDU, in the first PDU group) may further include one or more of following operations: if the another PDU is not transmitted successfully, whether to discard part of or all of PDUs in the first PDU; if the another PDU is not transmitted successfully, whether to transmit discard indication for instructing to discard part of or all of PDUs in the first PDU; if the another PDU is transmitted successfully, whether to instruct to retransmit or retransmit part of or all of PDUs in the first PDU; whether to discard the another PDU; whether to transmit discard indication of discarding the another PDU; or whether to instruct to retransmit or transmit the another PDU.

It should be noted that the first operation for the another PDU is similar to the first operation described above with reference to Case 1 to Case 18, provided that the “first PDU” in the foregoing cases is replaced with “another PDU”. For brevity, details are not described herein again.

In addition, the another PDU may be a PDU that is not transmitted in the first PDU group, or the another PDU may be a PDU that is not packeted in the first PDU group, or the another PDU may be a PDU that is not transmitted successfully in the first PDU group, or the another PDU may be a PDU that is not delivered to a higher layer in the first PDU group, or the another PDU may be a PDU, in the first PDU group, for which no successful acknowledgement is received, or the another PDU may be a PDU, in the first PDU group, for which a NACK is received, which is not limited in embodiments of this application.

As described above, PDUs included in the first PDU may belong to a PDU set, or may belong to a plurality of PDU sets. The first operation described above with reference to Case 1 to Case 21 may be applicable to the foregoing two scenarios. However, in some cases, when PDUs included in the first PDU belong to a plurality of PDU sets, the first operation may further include an operation for a PDU set. For example, the first PDU belongs to a first PDU set, and part of or all of PDUs, different from the first PDU, in the first PDU group belong to at least one second PDU set. For another example, part of PDUs in the first PDU belong to a first PDU set, and another part of PDUs in the first PDU belong to another PDU set different from the first PDU set. The first operation includes one or more of following operations: identifying at least one second PDU set; identifying a first PDU set; determining whether to discard at least one second PDU set; determining whether to transmit discard indication of discarding at least one second PDU set; if at least one second PDU set is a PDU set that is not transmitted, determining whether to transmit indication information indicating whether the at least one second PDU set is transmitted; determining whether a first PDU set is transmitted successfully; determining whether to transmit feedback information, where the feedback information is used to indicate whether the first PDU is transmitted successfully; if the target PDU set is a first PDU set, determining whether to instruct to retransmit or transmit the target PDU set; determining whether to perform integrated packet handling on a first PDU set and at least one second PDU set; determining whether to perform differentiated packet handling on a first PDU set and at least one second PDU set; determining whether to generate a third data packet, where the third data packet includes a first PDU set; determining whether to generate a fourth data packet, where the fourth data packet includes a first PDU set and at least one second PDU set; determining whether to cache one or more of a first PDU set, at least one second PDU set, a third data packet, or a fourth data packet; determining whether to perform reordering on one or more of a first PDU set, at least one second PDU set, or a third data packet; or determining whether to deliver a third data packet or a fourth data packet to a higher layer of the receive end.

It should be noted that the first operation for the PDU set is similar to the first operation described above with reference to the various cases. For brevity, details are not described below again.

As described above, the receive end may be a network device. Therefore, the first operation further includes one or more of following operations: configuring a resource for transmitting the first PDU, configuring a resource for transmitting the first PDU group; configuring a resource for transmitting each of PDUs or part of PDUs in the first PDU; configuring an RRC parameter of the first PDU; configuring an RRC parameter of each of PDUs or part of PDUs in the first PDU; or configuring an RRC parameter of the first PDU group.

In some implementations, first activation indication information may be used to activate the receive end to perform the first operation for the first PDU or the first PDU group. In other words, the method further includes: receiving, by the receive end, the first activation indication information, where the first activation indication information is used to instruct to activate the first operation to be performed on the first PDU.

It should be noted that the first activation indication information may be transmitted by the transmit end, or may be transmitted by a core network element, which is not limited in embodiments of this application.

A wireless communication method performed by the transmit end according to another embodiment of this application is described below with reference to Embodiment 2. It should be noted that in Embodiment 2, meanings of the first PDU and the first information are the same as those described in Embodiment 1. For brevity, details are not described below again.

### Embodiment 2

FIG. 5 is a schematic flowchart of a wireless communication method according to another embodiment of this application. The method shown in FIG. 5 includes step S510. In step S510, a transmit end performs a second operation for a first PDU.

The second operation is determined based on first information. In some implementations, the second operation may be directly determined based on the first information, that is, the transmit end performs the second operation for the first PDU based on the first information. In some other implementations, the second operation may be indirectly determined based on the first information. For example, the second operation may be performed based on feedback information transmitted by a receive end, but feedback information transmitted by the receive end may be determined based on the first information.

In some implementations, the feedback information is used to indicate whether the first PDU is successfully received, or the feedback information is used to indicate whether the first PDU needs to be retransmitted or transmitted. In some other implementations, the feedback information may carry an SN or a PDU set identity of the first PDU to indicate a PDU corresponding to the feedback information.

In this embodiment of this application, the transmit end performs an operation (also referred to as a “second operation”) for the first PDU. In other words, the transmit end uses the first PDU as a whole to perform a corresponding operation, which avoids focusing only on transmission of a single PDU in a conventional transmission manner, thereby improving properness of a transmission manner of the first PDU.

The following describes a manner in which the transmit end acquires the first information. In this embodiment of this application, the first information may be predefined, or the first information may be preconfigured. Certainly, in some scenarios (for example, the transmit end of the first PDU is an encoding end of the first PDU), the transmit end may learn first information. Therefore, the first information may be indicated by the transmit end. In some other scenarios, the first information is instructed to the transmit end. For example, the transmit end of the first PDU is not an encoding end of the first PDU, and then the first information may be instructed to the transmit end by the encoding end (also referred to as a “second entity”) of the first PDU.

If the first information is indicated by the transmit end, the method further includes: transmitting, by the transmit end, the first information to a first entity, where when the transmit end is a terminal device, the first entity includes one or more of a network device, an application layer of the terminal device, an entity of the terminal device, an application server, an application function AF, a decoder, an encoder, a core network entity, a session management function SMF, or a user plane function UPF; or when the transmit end is a network device, the first entity includes one or more of a terminal device, an application server, an AF, a decoder, an encoder, a core network entity, an SMF, or a UPF.

If the first information is indicated for the transmit end, the method further includes: receiving, by the transmit end, the first information transmitted by the second entity, where when the transmit end is a terminal device, the second entity includes one or more of a network device, an application layer of the terminal device, an entity of the terminal device, an application server, an application function AF, a decoder, an encoder, a core network entity, a session management function SMF, or a user plane function UPF; or when the transmit end is a network device, the second entity includes one or more of a terminal device, an application server, an AF, a decoder, an encoder, a core network entity, an SMF, or a UPF.

It should be noted that there are a plurality of manners of triggering the first information in embodiments of this application. For example, the first information may be periodically indicated to the transmit end. For another example, the first information may be aperiodically indicated to the transmit end. For another example, the first information may be triggered by an event. For another example, the first information may alternatively be acquired by using a request. The following uses an example in which the transmit end is a network device to describe a manner in which the transmit end acquires the first information. It should be understood that the following manners are not only applicable to the network device, but also applicable to another device (for example, the terminal device), which is used as the transmit end to acquire the first information.

For example, for a decoder with a relatively strong decoding capability, data in the first PDU group may be decoded based on fewer PDUs. For a decoder with a relatively weak decoding capability, data in the first PDU group may be decoded based on more or even all PDUs. Therefore, the network device may acquire the first information based on a decoding capability of the decoder.

For another example, for a decoder with a relatively strong decoding capability, data in the first PDU group may be decoded based on fewer PDUs. For a decoder with a relatively weak decoding capability, data in the first PDU group may be decoded based on more or even all PDUs. Therefore, the network device may acquire the first information based on a type of the decoder.

For another example, the network device may transmit, to the first entity, a request message used for requesting the first information, and the network device may receive, in response to the request message, the first information transmitted by the first entity.

For another example, in a case that the first information may be changed based on a capability of an application server or a processing status, the network device may periodically acquire the first information.

It should be noted that, that the transmit end acquires the first information from the first entity may be understood as that the transmit end directly acquires the first information from the first entity, or may be understood as that the transmit end acquires the first information from another entity (for example, the second entity) through the first entity, or the second entity first transmits the first information to the first entity, and then the first entity transmits the first information to the transmit end. In some implementations, the second entity may include one or more of an application layer of the terminal device, an entity of the terminal device, an application server, an AF, a decoder, an encoder, or a core network entity. Accordingly, the second entity may include an SMF or a UPF.

For example, when the first entity is an access network device or a UPF, and the second entity is an SMF, the SMF may acquire the first information based on a type or a capability of the decoder, and transmit the first information to the access network device or the UPF.

For another example, when the first entity is an SMF, and the second entity is an application server, the application server may transmit the first information to the SMF, and the SMF transmits the first information to the network device.

For another example, when the first entity is an application layer of the terminal device, the application layer of the terminal device may transmit the first information to the network device.

As described above, the transmit end may alternatively be a terminal device. When the transmit end is a terminal device, the terminal device may alternatively acquire the first information in a requested manner. For example, the terminal device may transmit, to a network device, a request message used for requesting the first information. Accordingly, in response to the request message, the network device acquires the first information from the first entity, and transmits the first information to the terminal device.

Content of the first information and transmission manners of the first information are described above. The second operation performed by the transmit end based on the first information is described below.

In some implementations, the performing a second operation includes one or more of the following operations: determining a type of part of or all of PDUs in the first PDU; determining a processing order of part of or all of PDUs in the first PDU; determining a priority or a priority level of part of or all of PDUs in the first PDU; determining independent decoding information of part of or all of PDUs in the first PDU; determining a dependency relationship of part of or all of PDUs in the first PDU in a coding and/or decoding process; whether to discard part of or all of PDUs in the first PDU; whether to transmit discard indication of discarding part of or all of PDUs in the first PDU; determining whether part of or all of PDUs in the first PDU are transmitted successfully; whether to instruct to retransmit or transmit part of or all of PDUs in the first PDU; whether to cache a data packet including part of or all of PDUs in the first PDU; whether to cache part of or all of PDUs in the first PDU; or whether to route part of or all of PDUs in the first PDU.

The following uses an example in which the second operation includes any one of the foregoing operations. It should be noted that the second operation may include the foregoing plurality of operations. For example, when discarding part of or all of PDUs in the first PDU, the transmit end may transmit discard indication of discarding part of or all of PDUs in the first PDU. For brevity, examples are not listed below one by one.

In Case 1, the performing a second operation includes determining a type of part of or all of PDUs in the first PDU, where a type of a PDU may indicate, for example, whether data carried in the PDU is an I frame, a P frame, or the like described above. Certainly, the type of a PDU may alternatively indicate a priority of the PDU, a dependency degree of the PDU, or the like. This is not limited in embodiments of this application.

In Case 2, the performing a second operation includes determining a processing order of part of or all of PDUs in the first PDU. The processing order may be determined based on priorities of part of or all of PDUs in the first PDU. A PDU having a higher priority may be prioritized for processing, and a PDU having a lower priority may be processed after the PDU having a higher priority is processed.

In Case 3, the performing a second operation includes determining a priority or a priority level of part of or all of PDUs in the first PDU. Alternatively, the transmit end may determine, based on the first information, a priority or a priority level of part of or all of PDUs in the first PDU.

In Case 4, the performing a second operation includes determining independent decoding information of part of or all of PDUs in the first PDU. The independent decoding information may indicate whether a corresponding PDU may be independently decoded. In some implementations, each PDU in the first PDU may correspond to a piece of dedicated independent decoding information. In some other implementations, a plurality of PDUs in the first PDU may share one piece of independent decoding information. This is not limited in embodiments of this application.

In Case 5, the performing a second operation includes determining a dependency relationship of part of or all of PDUs in the first PDU in a coding and/or decoding process. In other words, the transmit end may determine which PDUs in the first PDU have a dependency relationship.

In Case 6, if the performing a second operation includes whether to discard part of or all of PDUs in the first PDU, before performing the second operation, the transmit end may first determine whether to discard part of or all of PDUs in the first PDU, and then discard part of or all of PDUs in the first PDU after determining to discard the PDUs. Otherwise, the transmit end may not discard part of or all of PDUs in the first PDU. Certainly, the receive end may alternatively directly discard part of or all of PDUs in the first PDU based on the first information, or the receive end may not directly discard part of or all of PDUs in the first PDU based on the first information.

As described above, the first PDU may include part of or all of PDUs in a PDU set. When the first PDU includes all PDUs in the PDU set, discarding all PDUs in the first PDU described above may be understood as discarding all PDUs in the PDU set.

The second operation may be understood as being performed by the transmit end, or may be understood as being performed by a protocol layer of the transmit end. The protocol layer may be, for example, a PDCP layer, an SDAP layer, an RLC layer, or a MAC layer. For ease of understanding, the following uses a PDCP layer as an example to describe the second operation. In addition, the following describes two scenarios in which the receive end may recover the first PDU based on part of PDUs and the receive end may need to recover the first PDU based on all PDUs, with examples provided for each scenario.

In Scenario 1, the receive end may need to recover the first PDU based on all PDUs.

For example, the first PDU includes a PDU 1. When a PDCP layer of the transmit end determines that the PDU 1 is lost, the PDCP layer of the transmit end may delete another PDU in the first PDU. In a possible implementation, the PDCP layer of the receive end may indicate a corresponding RLC entity, and delete the another PDU in the first PDU or a lower-layer SDU corresponding to the another PDU. Generally, the PDCP layer of the transmit end may determine, based on feedback from a lower protocol layer, that the PDU 1 is lost, or the PDCP layer of the transmit end may determine, based on feedback from the receive end, that the PDU 1 is lost.

For another example, the first PDU includes a PDU 1. When the PDCP layer of the transmit end determines that a transmission delay of the PDU 1 is greater than or equal to a PDB of the first PDU, the PDCP layer of the transmit end may delete the another PDU in the first PDU.

For another example, PDUs in the first PDU are transmitted by using a plurality of RLC layers, and when a PDU transmitted by using one RLC layer in the plurality of RLC layers is lost, the PDCP layer of the transmit end may discard another PDU, transmitted by using another RLC layer, in the first PDU.

It should be noted that the another PDU described above may be understood as another PDU, different from the PDU 1, in the first PDU. For example, the another PDU may be a PDU that is not transmitted by the transmit end. For example, the another PDU may be a PDU that is not packaged by the transmit end. For example, the another PDU may alternatively be a PDU that is not delivered to a lower protocol layer. In addition, the PDU 1 may represent one PDU or a plurality of PDUs.

In Scenario 2, the receive end may recover the first PDU based on part of PDUs, where the part of PDUs may be, for example, PDUs of a first PDU quantity.

For example, when the PDCP layer of the transmit end determines that PDUs of the first PDU quantity in the first PDU are transmitted successfully, the PDCP layer of the transmit end may delete the another PDU in the first PDU. Generally, the PDCP layer of the transmit end may determine, based on feedback from a lower protocol layer, that PDUs of the first PDU quantity are transmitted successfully, or the PDCP layer of the transmit end may determine, based on feedback from the receive end, that the PDUs of the first PDU quantity are lost.

For another example, when the PDCP layer of the transmit end determines that a quantity of PDUs transmitted successfully in the first PDU does not reach the first PDU quantity, the PDCP layer of the transmit end may delete the PDUs transmitted successfully in the first PDU. Generally, the PDCP layer of the transmit end may determine, based on feedback from a lower protocol layer, that the another PDU in the first PDU is lost, or the PDCP layer of the transmit end may determine, based on feedback from the receive end, that the another PDU in the first PDU is lost

For another example, when the PDCP layer of the transmit end determines that a transmission delay of PDUs of the first PDU quantity in the first PDU is greater than or equal to a PDB of the first PDU, the PDCP layer of the transmit end may delete the another PDU in the first PDU.

It should be noted that another PDU may be a PDU that is not transmitted by the transmit end, or may be a PDU that is not packaged by the transmit end, or may be a PDU that is not delivered to a low protocol layer.

As described above, if the PDCP layer of the transmit end needs to delete the another PDU, the PDCP layer of the transmit end needs to identify a PDU that needs to be deleted. In some implementations, the PDCP layer of the transmit end may identify, based on information such as packet header information, a higher layer user plane indication, or a higher layer control plane indication, a PDU to be deleted. This is not limited in embodiments of this application.

In Case 7, if the performing a second operation includes whether to transmit discard indication of discarding part of or all of PDUs in the first PDU, before performing the second operation, the transmit end may first determine whether to transmit the discard indication, and transmit the discard indication after determining to transmit the discard indication, or the transmit end may not transmit the discard indication. Certainly, the transmit end may directly transmit the discard indication based on the first information, or the transmit end may directly not transmit the discard indication based on the first information.

The second operation may be understood as being performed by the transmit end, or may be understood as being performed by a protocol layer of the transmit end. The protocol layer may be, for example, a PDCP layer, an SDAP layer, an RLC layer, or a MAC layer.

In some scenarios, the first PDU includes all PDUs in the first PDU group and the first PDU group includes one PDU set. In this case, if the discard indication instructs to delete all PDUs in the first PDU, it may be understood that the transmit end transmits discard indication of deleting the PDU set. For example, the PDCP layer (as an instance of a first protocol layer) of the transmit end instructs a higher protocol layer (also referred to as a “second protocol layer”) to delete the PDU set, where the second protocol layer is a layer higher than the first protocol layer.

For ease of understanding, the following uses a PDCP layer as an example to describe the second operation. In addition, the following describes two scenarios in which the receive end may recover the first PDU based on part of PDUs and the receive end may need to recover the first PDU based on all PDUs, with examples provided for each scenario.

In Scenario 1, the receive end may need to recover the first PDU based on all PDUs.

For example, the first PDU includes a PDU 1. Accordingly, when the PDCP layer determines that the PDU 1 is lost, the PDCP layer of the transmit end may transmit discard indication to a higher protocol layer, so as to instruct the higher protocol layer to delete an another PDU in the first PDU. Generally, the PDCP layer of the transmit end may determine, based on feedback from a higher protocol layer, that the PDU 1 is lost, or the PDCP layer of the transmit end may determine, based on feedback from the receive end, that the PDU 1 is lost.

For another example, the first PDU includes a PDU 1. When the PDCP layer of the transmit end determines that a transmission delay of the PDU 1 is greater than or equal to a PDB of the first PDU, the PDCP layer of the transmit end may transmit discard indication to a higher protocol layer, to instruct the higher protocol layer to delete another PDU in the first PDU.

For another example, PDUs in the first PDU are transmitted by using a plurality of RLC layers, and when a PDU transmitted by using one RLC layer in the plurality of RLC layers is lost, the PDCP layer of the transmit end may transmit discard indication to the another RLC layer, to instruct the another RLC layer to discard the another PDU in the first PDU.

The another PDU may be understood as another PDU, different from the PDU 1, in the first PDU. The another PDU may be a PDU that is not transmitted by the transmit end, or may be a PDU that is not packaged by the transmit end, or may be a PDU that is not delivered to a low protocol layer. In addition, the PDU 1 may represent one PDU or a plurality of PDUs.

In Scenario 2, the receive end may recover the first PDU based on part of PDUs, where the part of PDUs may be, for example, PDUs of a first PDU quantity.

For example, when the PDCP layer of the transmit end determines that PDUs of the first PDU quantity are transmitted successfully, the PDCP layer of the transmit end may transmit discard indication to a higher protocol layer, to instruct the higher protocol layer to delete an another PDU in the first PDU. Generally, the PDCP layer of the transmit end may determine, based on feedback from a lower protocol layer, that PDUs of the first PDU quantity are transmitted successfully, or the PDCP layer of the transmit end may determine, based on feedback from the receive end, that the PDUs of the first PDU quantity are transmitted successfully.

For example, when the PDCP layer of the transmit end determines that a quantity of PDUs transmitted successfully in the first PDU does not reach the first PDU quantity, the PDCP layer of the transmit end may transmit discard indication to a higher protocol layer, to instruct a higher protocol layer to delete an another PDU in the first PDU. Generally, the PDCP layer of the transmit end may determine, based on feedback from a lower protocol layer, that a quantity of PDUs transmitted successfully does not reach the first PDU quantity, or the PDCP layer of the transmit end may determine, based on feedback from the receive end, that a quantity of PDUs transmitted successfully does not reach the first PDU quantity.

For another example, when the PDCP layer of the transmit end determines that a transmission delay of PDUs transmitted successfully in the first PDU is greater than or equal to a PDB of the first PDU, and a quantity of the PDUs transmitted successfully does not reach the first PDU quantity, the PDCP layer of the transmit end may transmit discard indication to a higher protocol layer, to instruct the higher protocol layer to delete an another PDU in the first PDU.

The another PDU may be a PDU that is not transmitted by the transmit end, or may be a PDU that is not packaged by the transmit end, or may be a PDU that is not delivered to a low protocol layer.

As described above, if the PDCP layer of the transmit end needs to instruct the higher layer to delete the another PDU, the PDCP layer of the transmit end needs to identify a PDU that needs to be deleted. In some implementations, the PDCP layer of the transmit end may identify, based on information such as packet header information, a higher layer user plane indication, or a higher layer control plane indication, a PDU to be deleted. This is not limited in embodiments of this application.

In Case 8, if the performing a second operation described above includes determining whether part of or all of PDUs in the first PDU are transmitted successfully, the transmit end may determine, based on feedback information transmitted by the receive end, whether part of or all of PDUs in the first PDU are transmitted successfully.

The second operation may be understood as being performed by the transmit end, or may be understood as being performed by a protocol layer of the transmit end. The protocol layer may be, for example, a PDCP layer, an SDAP layer, an RLC layer, or a MAC layer.

In some implementations, the feedback information may include at least one of following: a sequence number SN, an identity, or an ACK/NACK. In some other implementations, the feedback information may include at least one of following: an SN of the first PDU with a transmission error in the first PDU, an identify of the first PDU with a transmission error in the first PDU, or an ACK/NACK.

The SN may be an SN of the first PDU, or may be an SN of at least one PDU in the first PDU, or may be an SN of a PDU set. It should be noted that there may be one or more corresponding SNs.

The identify may be an identify of the first PDU, or may be an identify of at least one PDU in the first PDU, or may be an identify of a PDU set. It should be noted that there may be one or more corresponding identities.

In Case 9, if the performing a second operation includes whether to retransmit or transmit part of or all of PDUs in the first PDU, the transmit end may determine, based on the feedback information, whether to retransmit or transmit part of or all of PDUs in the first PDU, and when it is determined to perform retransmission or transmission, retransmit or transmit part of or all of PDUs in the first PDU to the receive end; otherwise, the transmit end does not retransmit or transmit part of or all of PDUs in the first PDU. Certainly, the transmit end may directly retransmit or transmit part of or all of PDUs in the first PDU, or the transmit end directly rejects to retransmit or transmit part of or all of PDUs in the first PDU.

The second operation may be understood as being performed by the transmit end, or may be understood as being performed by a protocol layer of the transmit end. The protocol layer may be, for example, a PDCP layer, an SDAP layer, an RLC layer, or a MAC layer. For ease of understanding, the following uses a PDCP layer as an example to describe the second operation. In addition, the following describes two scenarios in which the receive end may recover the first PDU based on part of PDUs and the receive end may need to recover the first PDU based on all PDUs, with examples provided for each scenario.

In Scenario 1, the receive end may need to recover the first PDU based on all PDUs.

For example, the PDCP layer of the receive end transmits feedback information to the PDCP layer of the transmit end, and the PDCP layer of the transmit end determines, based on the feedback information, that transmission of PDUs in the first PDU fails. In this case, the PDCP layer of the transmit end needs to retransmit a PDU that is not successfully transmitted in the first PDU. In addition, the PDCP layer of the transmit end further needs to continue to transmit the PDU that is not transmitted in the first PDU.

For another example, the PDCP layer of the transmit end may receive indication information fed back by an RLC layer of the transmit end, and determine that transmission of PDUs in the first PDU fails. In this case, the PDCP layer of the transmit end needs to retransmit a PDU that is not successfully transmitted in the first PDU. In addition, the PDCP layer of the transmit end further needs to continue to transmit the PDU that is not transmitted in the first PDU.

In Scenario 2, the PDCP layer of the receive end may recover the first PDU based on part of PDUs. For example, part of PDUs may be, for example, PDUs of the first PDU quantity.

For example, it is assumed that a quantity of successfully transmitted PDUs in the first PDU is less than the first PDU quantity, the PDCP layer of the receive end transmits feedback information to the PDCP layer of the transmit end, and the PDCP layer of the transmit end determines, based on the feedback information, that transmission of PDUs in the first PDU fails. In this case, the PDCP layer of the transmit end needs to retransmit a PDU that is not successfully transmitted in the first PDU. In addition, the PDCP layer of the transmit end further needs to continue to transmit the PDU that is not transmitted in the first PDU.

For another example, it is assumed that a quantity of successfully transmitted PDUs in the first PDU is less than the first PDU quantity, the PDCP layer of the transmit end may determine, based on indication information fed back by an RLC layer of the transmit end, that transmission of PDUs in the first PDU fails. In this case, the PDCP layer of the transmit end needs to retransmit a PDU that is not successfully transmitted in the first PDU. In addition, the PDCP layer of the transmit end further needs to continue to transmit the PDU that is not transmitted in the first PDU.

As described above, if the PDCP layer of the transmit end needs to retransmit or transmit a PDU, the PDCP layer of the transmit end needs to identify the PDU that needs to be retransmitted or transmitted. In some implementations, the PDCP layer of the transmit end may identify, based on information such as packet header information, a higher layer user plane indication, or a higher layer control plane indication, the PDU to be retransmitted or transmitted. This is not limited in embodiments of this application.

It should be noted that the feedback information corresponding to the first PDU may be understood as feedback information corresponding to an SN or an identify corresponding to the first PDU, or feedback information corresponding to a plurality of SNs or identities corresponding to the first PDU. Alternatively, the feedback information corresponding to the first PDU may be feedback for the first PDU, or may be feedback for at least one PDU in the first PDU, or may be feedback for a PDU set.

In some implementations, the feedback information may include at least one of following: a sequence number SN, an identity, or an ACK/NACK. In some other implementations, the feedback information may include at least one of following: an SN corresponding to the first PDU with a transmission error, a quantity of consecutive transmission errors, an identity corresponding to a PDU with a transmission error, or an ACK/NACK.

The SN may be an SN of the first PDU, or may be an SN of at least one PDU in the first PDU, or may be an SN of a PDU set. It should be noted that there may be one or more corresponding SNs.

The identify may be an identify of the first PDU, or may be an identify of at least one PDU in the first PDU, or may be an identify of a PDU set. It should be noted that there may be one or more corresponding identities.

In Case 10, if the performing a second operation described above includes whether to cache a data packet including part of or all of PDUs in the first PDU, the transmit end may first determine, based on the first information, whether to cache the data packet, and when it is determined to cache the data packet, cache the data packet. Otherwise, the transmit end may not cache the data packet. Certainly, the transmit end may further directly cache a data packet that includes part of or all of PDUs in the first PDU, or the transmit end may directly not cache a data packet that includes part of or all of PDUs in the first PDU.

The second operation may be understood as being performed by the transmit end, or may be understood as being performed by a protocol layer of the transmit end. The protocol layer may be, for example, a PDCP layer, an SDAP layer, an RLC layer, or a MAC layer. In addition, the following describes two scenarios in which the receive end may recover the first PDU based on part of PDUs and the receive end may need to recover the first PDU based on all PDUs, with examples provided for each scenario.

In Scenario 1, the PDCP layer of the receive end may recover the first PDU based on part of PDUs. For example, part of PDUs may be, for example, PDUs of the first PDU quantity.

For example, when the first information indicates the first PDU quantity, and the PDCP layer of the transmit end determines that PDUs of the first PDU quantity are transmitted successfully, the PDCP layer of the transmit end may determine, based on the first information, not to cache a data packet including part of PDUs in the first PDU.

For another example, when the first information indicates the first PDU quantity, and the PDCP layer of the transmit end determines that a quantity of PDUs transmitted successfully is less than the first PDU quantity, the PDCP layer of the transmit end may determine, based on the first information, to cache a data packet that includes part of PDUs in the first PDU.

In Scenario 2, the PDCP layer of the receive end may recover the first PDU based on all of PDUs.

For example, when the first information indicates that integrated packet handling is to be performed on all of PDUs in the first PDU, and the PDCP layer of the transmit end determines that all of PDUs in the first PDU are transmitted successfully, the PDCP layer of the transmit end may determine, based on the first information, not to cache a data packet including all of PDUs in the first PDU.

For another example, when the first information indicates that integrated packet handling is to be performed on all of PDUs in the first PDU, and the PDCP layer of the transmit end determines that part of PDUs in the first PDU fail to be transmitted, the PDCP layer of the transmit end may determine, based on the first information, to cache a data packet including all of PDUs in the first PDU.

In Case 11, if the performing a second operation described above includes whether to cache part of or all of PDUs (hereinafter referred to as a “PDU”) in the first PDU, the transmit end may first determine, based on the first information, whether to cache the PDU, and when it is determined to cache the PDU, cache the PDU. Otherwise, the transmit end may not cache the PDU. Certainly, the transmit end may further directly cache part of or all of PDUs in the first PDU, or the transmit end may directly not cache part of or all of PDUs in the first PDU.

The second operation may be understood as being performed by the transmit end, or may be understood as being performed by a protocol layer of the transmit end. The protocol layer may be, for example, a PDCP layer, an SDAP layer, an RLC layer, or a MAC layer. In addition, the following describes two scenarios in which the receive end may recover the first PDU based on part of PDUs and the receive end may need to recover the first PDU based on all PDUs, with examples provided for each scenario.

In Scenario 1, the PDCP layer of the receive end may recover the first PDU based on part of PDUs. For example, part of PDUs may be, for example, PDUs of the first PDU quantity.

For example, when the first information indicates the first PDU quantity, and the PDCP layer of the transmit end determines that PDUs of the first PDU quantity are transmitted successfully, the PDCP layer of the transmit end may determine, based on the first information, not to cache the PDUs of the first PDU quantity.

For another example, when the first information indicates the first PDU quantity, and the PDCP layer of the transmit end determines that a quantity of PDUs transmitted successfully is less than the first PDU quantity, the PDCP layer of the transmit end may determine, based on the first information, to cache the first PDU.

In Scenario 2, the PDCP layer of the receive end may recover the first PDU based on all of PDUs.

For example, when the PDCP layer of the transmit end determines that all PDUs in the first PDU are successfully transmitted, the PDCP layer of the transmit end may determine, based on the first information, not to cache any PDU in the first PDU.

For another example, when the PDCP layer of the transmit end determines that transmission of part of PDUs in the first PDU fails, the PDCP layer of the transmit end may determine, based on the first information, to cache a PDU that is successfully transmitted.

In Case 12, if the performing a second operation includes whether to route part of or all of PDUs in the first PDU, the transmit end may first determine whether to route part of or all of PDUs in the first PDU, and when it is determined that routing needs to be performed, perform routing on part of or all of PDUs in the first PDU. Otherwise, the transmit end may not route part of or all of PDUs in the first PDU. Certainly, the transmit end may directly route part of or all of PDUs in the first PDU, or the transmit end may directly reject routing part of or all of PDUs in the first PDU.

The routing may include a route to an underlying path, a route to a path with good channel quality, or a route to a path with a high LCH priority. In some implementations, the paths may be any one of a path through an SDAP entity, a DRB, a path through a PDCP entity, a path through an RLC entity, an LCH, a path through a MAC entity, or a carrier.

In Case 13, if the performing a second operation described above includes determining, based on a transmission status of the first PDU, whether to discard another PDU, before performing the first operation, the transmit end may first determine whether to discard the another PDU, and after it is determined to discard the another PDU, discard the another PDU. Otherwise, the receive end may not discard the another PDU. Certainly, the transmit end may alternatively discard the another PDU directly based on the first information, or the transmit end may not directly discard the another PDU based on the first information.

As described above, the another PDU may be understood as another PDU, different from the first PDU, in the first PDU group.

The second operation may be understood as being performed by the transmit end, or may be understood as being performed by a protocol layer of the transmit end. The protocol layer may be, for example, a PDCP layer, an SDAP layer, an RLC layer, or a MAC layer.

In some implementations, the transmit end may determine, based on the first information and whether the first PDU is transmitted successfully, whether to discard the another PDU. For example, when the first PDU fails to be transmitted, the transmit end may discard the another PDU based on the first information. For another example, when the first PDU is transmitted successfully, the transmit end may continue to transmit the another PDU (or not to discard the another PDU) based on the first information.

The second operation for PDUs in the first PDU is described above with reference to Case 1 to Case 13. As described above, if the first PDU includes all PDUs in the first PDU group, the second operation may be understood as a second operation for the PDUs in the first PDU group. If the first PDU includes only part of PDUs in the first PDU group, the second operation for another PDU in the first PDU group (that is, another PDU, different from the first PDU, in the first PDU group) may further include one or more of following operations: if the another PDU is not transmitted successfully, whether to discard part of or all of PDUs in the first PDU; if the another PDU is not transmitted successfully, whether to transmit discard indication for instructing to discard part of or all of PDUs in the first PDU; if the another PDU is transmitted successfully, whether to retransmit or retransmit part of or all of PDUs in the first PDU; whether to discard the another PDU; whether to transmit discard indication of discarding the another PDU; or whether to retransmit or transmit the another PDU.

It should be noted that the second operation for the another PDU is similar to the second operation described above with reference to Case 1 to Case 12, provided that the “first PDU” in the foregoing cases is replaced with “another PDU”. For brevity, details are not described herein again.

In addition, the another PDU may be a PDU that is not transmitted in the first PDU group, or the another PDU may be a PDU that is not packeted in the first PDU group, or the another PDU may be a PDU that is not transmitted successfully in the first PDU group, or the another PDU may be a PDU that is not delivered to a higher layer in the first PDU group, or the another PDU may be a PDU, in the first PDU group, for which no successful acknowledgement is received, or the another PDU may be a PDU, in the first PDU group, for which a NACK is received, which is not limited in embodiments of this application.

As described above, PDUs included in the first PDU may belong to a PDU set, or may belong to a plurality of PDU sets. The second operation described above with reference to Case 1 to Case 13 may be applicable to the foregoing two scenarios. However, in some cases, when PDUs included in the first PDU belong to a plurality of PDU sets, the second operation may further include an operation for a PDU set. That is, the first PDU belongs to a first PDU set, part of or all of PDUs, different from the first PDU, in the first PDU group belong to at least one second PDU set, and the second operation includes one or more of following operations: identifying the at least one second PDU set; identifying the first PDU set; whether to discard the at least one second PDU set; whether to transmit discard indication of discarding the at least one second PDU set; determining whether the first PDU set is transmitted successfully; whether to perform differentiated packet handling on the first PDU set and the at least one second PDU set; whether to generate a third data packet, where the third data packet includes the first PDU set; whether to generate a fourth data packet, where the fourth data packet includes the first PDU set and the at least one second PDU set; or whether to cache one or more of the first PDU set, the at least one second PDU set, the third data packet, or the fourth data packet.

It should be noted that the second operation for the PDU set is similar to the second operation described above with reference to the various cases. For brevity, details are not described below again.

As described above, the transmit end may be a network device. Therefore, the second operation further includes one or more of the following operations: configuring a resource for transmitting the first PDU; configuring a resource for transmitting the first PDU group; configuring an RRC parameter of the first PDU; or configuring an RRC parameter of the first PDU group.

In some implementations, second activation indication information may be used to activate the transmit end to perform the second operation for the first PDU or the first PDU group. In other words, the method further includes: receiving, by the transmit end, the second activation indication information, where the second activation indication information is used to instruct to activate the second operation to be performed on the first PDU.

It should be noted that the second activation indication information may be transmitted by an encoding end, or may be transmitted by a core network element, which is not limited in embodiments of this application.

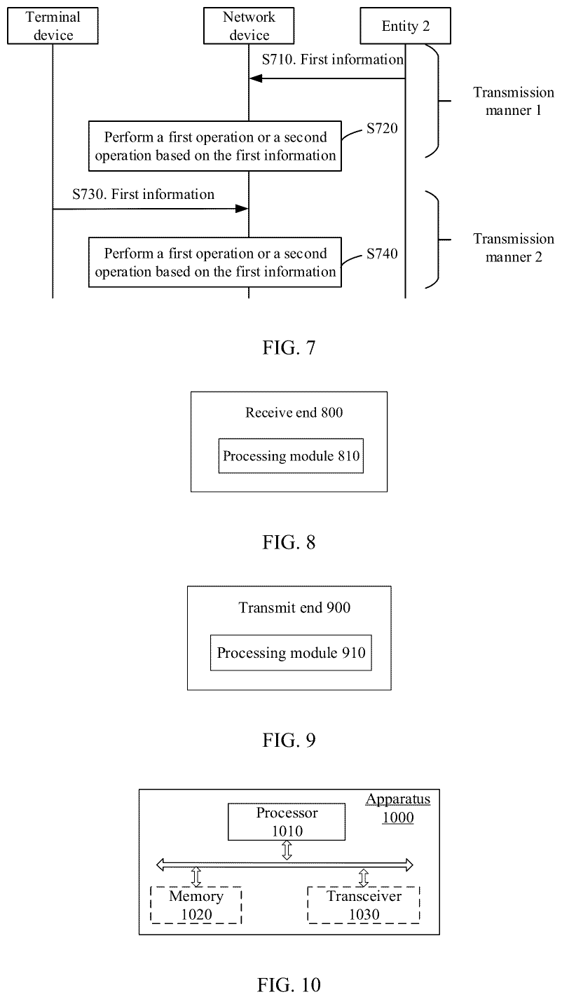

For ease of understanding, with reference to FIG. 6 to FIG. 7, the following uses a network device and a terminal device as examples to describe a transmission method of first information according to an embodiment of this application.

It should be noted that, FIG. 6 illustrates the method in which a terminal device performs a first operation or a second operation according to an embodiment of this application. FIG. 7 illustrates the method in which a network device performs a first operation or a second operation according to an embodiment of this application. In addition, meanings of the first information, the first operation, and the second operation, as well as the first entity and/or the second entity are described above in detail. For brevity, details are not described below.

FIG. 6 is a schematic flowchart of a transmission method of first information according to an embodiment of this application. Referring to FIG. 6, two transmission manners of the first information are described: a transmission manner 1 and a transmission manner 2.

In the transmission manner 1, step S610 to step S630 are included, and the first information may be transmitted by an entity 1 to a terminal device through a network device.

In step S610, the entity 1 transmits the first information to the network device.

In step S620, the network device transmits the first information to the terminal device.

In step S630, the terminal device performs a first operation or a second operation based on the first information.

In the transmission manner 2, step S640 and step S650 are included, and the first information may be directly transmitted by the entity 1 to the terminal device.

In step S640, the entity 1 transmits the first information to the terminal device.

In step S650, the terminal device performs a first operation or a second operation based on the first information.

It should be noted that the entity 1 shown in FIG. 6 may be the first entity described above, or may be the second entity described above. If the entity 1 is the second entity, the second entity may transmit the first information to the network device or the terminal device through the first entity.

FIG. 7 is a schematic flowchart of a transmission method of first information according to another embodiment of this application. Referring to FIG. 7, two transmission manners of the first information are described: a transmission manner 1 and a transmission manner 2.

In the transmission manner 1, step S710 and step S720 are included, and the first information may be transmitted by an entity 2.

In step S710, the entity 2 transmits the first information to the network device.

In step S720, the network device performs a first operation or a second operation based on the first information.

It should be noted that the entity 2 shown in FIG. 7 may be the first entity described above, or may be the second entity described above. If the entity 2 is the second entity, the second entity may transmit the first information to the network device through the first entity.

In the transmission manner 2, step S730 and step S740 are included and the first information may be transmitted by a terminal device.

In step S730, the terminal device transmits the first information to the network device.

In step S740, the network device performs a first operation or a second operation based on the first information.

For ease of understanding, the following describes the wireless communication method in embodiments of this application from another perspective with reference to Embodiment 3 to Embodiment 5. It should be noted that names of terms in Embodiment 3 to Embodiment 5 described below are the same as those in Embodiment 1 and Embodiment 2 described above. For brevity, details are not described below.

### Embodiment 3

In this embodiment of this application, the first PDU may be a PDU set. The first PDU may further include a PDU set that has an association relationship or an integrated packet handling requirement. For example, the first PDU may further include a PDU set that carries an I frame and a PDU set that carries a P frame. Certainly, the first PDU may further include a PDU that has an association relationship or an integrated packet handling requirement. In this embodiment of this application, transmission of the first PDU in a downlink transmission scenario is used as an example for description, where the first PDU is a PDU set. In addition, the method in this embodiment of this application is also applicable to an uplink transmission scenario.

A specific procedure is as follows:

1. A base station acquires first information. The first information is information for the PDU set, or information for integrated packet handling of the PDU set.
(a) The first information may be any one of the following: information about a PDU set for a QoS flow, information about a PDU set for a PDU session, information about a PDU set for an application/AF, information about a PDU set for an IP quintuple, or information about a PDU set for a terminal device.
(b) The first information includes at least one of the following:
   i. an indication for integrated packet handling or consistency handling of the PDU set;
   ii. an object for integrated packet handling or consistency handling of the PDU set, for example, all data packets or PDUs in the PDU set, or at least part of data packets or PDUs in the PDU set;
   iii. a quantity of data packets/PDUs that are tolerated to be lost in the PDU set, or a loss rate of data packets/PDUs that are tolerated to be lost in the PDU set, or a loss proportion of data packets/PDUs that are tolerated to be lost in the PDU set;
   iv. a minimum quantity of to-be-received data packets or PDUs required for the PDU set to be decoded or successfully decoded, or a receive success rate of data packets or PDUs required for the PDU set to be decoded or successfully decoded, or a receive proportion of data packets or PDUs required for the PDU set to be decoded or successfully decoded;
   v. a minimum quantity of to-be-transmitted data packets or PDUs required for the PDU set to be decoded or successfully decoded, or a success rate of data packets or PDUs required for the PDU set to be decoded or successfully decoded, or a success proportion of data packets or PDUs required for the PDU set to be decoded or successfully decoded;
   vi. a transmission success rate (or a proportion or a quantity) of minimum PDUs/data packets that are in the PDU set and that meet a requirement that the PDU set is successfully decoded, or a maximum failure transmission rate (or proportion or quantity) of data packets or PDUs in the PDU set; or
   vii. a threshold of a quantity of data packets required for the PDU set to be decoded or recovered.
c) The acquiring the first information includes at least one of the following:
i. The base station acquires the first information in a manner of a period/event triggering/a base station request/a terminal device request, or the like.
   For example, the base station acquires the first information based on a decoder capability or type.
   For example, the base station requests the first information, and then acquires the first information from a first entity.
   For example, the base station periodically acquires the first information, for example, in a case that the first information is supported to be changed based on a capability or a processing status of an application server.
   For example, the terminal device requests the first information from a base station, and the base station acquires the first information from the first entity, performs processing, or notifies the terminal device of the first information.
   For example, the first entity directly transmits the first information to the base station. The first entity may transmit the first information periodically, or the first entity may transmit the first information aperiodically, which is not limited in embodiments of this application.
ii. The base station acquires the first information from the first entity.
2. In a possible implementation, the first entity acquires the first information from a second entity.
(a) In a possible implementation, the first entity acquires the first information from the second entity before the step 1.
(b) In a possible implementation, the second entity is any one of the following: an application layer of the terminal device, an application server, an AF, a decoder, an encoder, or an SMF.
(c) In a possible implementation, the first entity is a core network entity, such as a UPF and an SMF.
i. For example, the SMF acquires the first information based on the decoder type or capability, and transmits the first information to the base station or the UPF.
ii. For example, the application server notifies the SMF of the first information, and the SMF notifies the base station of the first information.
iii. For example, the application layer of the terminal device notifies the base station of the first information.
3. The terminal device or the base station performs processing (for example, the first operation or the second operation described above) for the PDU set based on the first information.
(a) A first protocol layer of a transmit end or a receive end (for example, the terminal device or the base station) performs processing on the PDU set.
(b) In a possible implementation, the processing for the PDU set includes at least one of the following: scheduling, resource configuration, RRC parameter configuration, packet loss, packet loss indication, feedback, generating one transmission data packet for the PDU set, or generating one transmission data packet for at least part of the PDU set.
i. For example, the packet loss means that a TX or RX PDCP layer discards a message/SDU/PDU associated with the PDU set.
ii. For example, the packet loss indication means that a TX or RX PDCP layer indicates that if a message/SDU/PDU of a PDU set transmitted through one RLC layer is lost, another RLC layer discards a related message/SDU/PDU of the PDU set; or a TX or RX PDCP layer indicates that if the PDCP layer receives, from another RLC layer, indication that a message/SDU/PDU of the PDU set transmitted through the RLC is lost, the another RLC discards a related message/SDU/PDU of the PDU set.
iii. For example, the feedback means that if the receive end receives M PDUs in the PDU set and a quantity of the PDUs is greater than a threshold for the PDU set to be successfully decoded or received, the receive end feeds back an ACK to the transmit end.
(c) If integrated packet handling or consistency handling of the PDU set is performed at the base station, the base station performs integrated packet handling or consistency handling of the PDU set based on the first information. The integrated packet handling or the consistency handling includes: resource scheduling, resource configuration, RRC parameter configuration, packet loss, packet loss indication, feedback (for example, feedback to a peer end), generation of a transmission data packet for the PDU set, generation of a transmission data packet for at least part of the PDU set, and the like.
(d) If integrated packet handling or consistency handling of the PDU set is performed at the terminal device, the base station instructs the first information to the terminal device. The terminal device performs integrated packet handling or consistency handling of the PDU set, including packet loss, packet loss indication, feedback (feedback to a peer end), generation of a transmission data packet for the PDU set, generation of a transmission data packet for at least part of the PDU set, and the like.

It should be noted that the entity that supports integrated packet handling may alternatively be a terminal device. Correspondingly, the terminal device may acquire the first information from the first entity. In this case, the first entity may alternatively be a base station. For a transmission manner of the first information, reference may be made to FIG. 6 and FIG. 7. For brevity, details are not described herein again.

In this embodiment of this application, a procedure of performing integrated packet handling based on the PDU set is specified, so that a network transmission/decoding requirement of integrated packet handling is ensured.

### Embodiment 4

In this embodiment of this application, the first PDU may be a PDU set. The first PDU may further include a PDU set that has an association relationship or an integrated packet handling requirement. For example, the first PDU may further include a PDU set that carries an I frame and a PDU set that carries a P frame. Certainly, the first PDU may further include a PDU that has an association relationship or an integrated packet handling requirement. In this embodiment of this application, transmission of the first PDU in a downlink transmission scenario is used as an example for description, where the first PDU is a PDU set. In addition, the method in this embodiment of this application is also applicable to an uplink transmission scenario.

This embodiment of this application mainly describes a manner of integrated packet handling for all PDUs/data packets in the PDU set, for example, including air interface transmit end handling, air interface receive end handling, and/or the like.

The following mainly describes, with reference to Solution 1 and Solution 2, processing for the PDU set performed by a base station and processing for the PDU set performed by a terminal, respectively.

### Solution 1

1. A base station acquires first information. The first information is information for the PDU set, or information for integrated packet handling of the PDU set. Based on the first information, the PDU set can be recovered for all PDUs/data packets in the PDU set. That is, if there is one PDU/data packet, or a specific PDU/data packet is not successfully received, the PDU set cannot be recovered, or it is considered that transmission of the PDU set fails. In a possible implementation, the first information includes at least one of the following:
(a) the first information is information about a PDU set for a QoS flow, information about a PDU set for a PDU session, information about a PDU set for an application/AF, information about a PDU set for an IP quintuple, or information about a PDU set for a terminal device; or
(b) the first information includes an indication for integrated packet handling or consistency handling of the PDU set, or the first information includes an activation indication for activating integrated packet handling or consistency handling for the PDU set.

2. The base station performs processing for the PDU set based on the first information.
(a) If integrated packet handling or consistency handling of the PDU set is performed at the base station, the base station performs integrated packet handling or consistency handling for the PDU set based on the first information. Integrated packet handling or consistency handling includes resource scheduling, resource configuration, RRC parameter configuration, packet loss, packet loss indication, feedback (feedback to a peer end), generation of a transmission data packet for the PDU set, and the like. The following separately describes an operation (also referred to as a “second operation”) performed by a transmit end and an operation (also referred to as a “first operation”) performed by a receive end.
i. As a transmit end for data transmission (for example, for DL data transmission), at least one of the following operations may be performed.
   An optional operation 1: packet deletion/packet loss. The following uses a PDCP layer as an example for description, but it is not limited to the PDCP layer, or may be one of an SDAP layer, an RLC layer, a MAC layer, or the like.
(a) For example, the PDCP layer determines that a data packet or a specific data packet in the PDU set is lost (for example, based on lower-layer feedback or peer-end feedback), and the PDCP layer deletes another data packet in a corresponding PDU set.

For another example, the PDCP layer determines that a transmission delay (for example, based on lower-layer feedback or peer-end feedback) of a data packet or a specific data packet in the PDU set exceeds a PDB corresponding to the PDU set, the PDCP layer deletes another data packet in a corresponding PDU set.

The another data packet may be another data packet that is not transmitted, a data packet that is not packaged as a PDCP PDU, or a PDCP PDU that is not delivered to a lower layer and that is of the another data packet.
(b) Correspondingly, when the PDCP layer needs to identify which PDUs/data packets belong to one PDU set, the PDCP layer may perform identification based on information such as packet header information, a higher-layer user plane indication, and a higher-layer control plane indication.
   An optional operation 2: packet deletion/packet loss indication. The following uses a PDCP layer as an example for description, but it is not limited to the PDCP layer, or may be one of an SDAP layer, an RLC layer, a MAC layer, or the like.
(a) For example, when the PDCP layer determines that a data packet or a specific data packet in the PDU set is lost (for example, which may be learned based on lower-layer feedback or peer-end feedback), the PDCP layer may instruct a lower layer to delete another data packet in a corresponding PDU set.

For another example, when the PDCP layer determines that a transmission delay of a data packet or a specific data packet in the PDU set is greater than or equal to a PDB (for example, which may be learned based on lower-layer feedback or peer-end feedback) corresponding to the PDU set, the PDCP layer may instruct a lower layer to delete another data packet in a corresponding PDU set.

The another data packet may be another data packet that is not transmitted, a data packet that does not form a lower-layer PDU, an RLC SDU/PDU that is not delivered to a peer end and that is of the another data packet, an RLC SDU/PDU that corresponds to the another data packet and that is not delivered to a lower layer, a lower-layer SDU/PDU corresponding to the PDU set, or a lower-layer SDU/PDU corresponding to another data packet in the PDU set.
(b) Correspondingly, the lower layer may be, for example, an RLC layer, and an SDU/PDU corresponding to the indication needs to be deleted.
(c) Accordingly, the PDCP layer needs to identify which PDUs/data packets belong to one PDU set. In some implementations, the PDCP layer may perform identification based on information such as packet header information, a higher-layer user plane indication, and a higher-layer control plane indication.
   An optional operation 3: Based on peer-end feedback, it is considered that a PDU set or a PDU/data packet in a corresponding PDU set is successfully transmitted, or a corresponding data packet is deleted. The following uses a PDCP layer as an example for description, but it is not limited to the PDCP layer, or may be one of an SDAP layer, an RLC layer, a MAC layer, or the like.
(a) For example, the PDCP layer receives feedback information from a PDCP layer of a peer end, and determines, based on an SN indicated by the feedback information or an identifier (such as an SN or a plurality of SNs) of the PDU set, that a corresponding PDU set is successfully transmitted, or that a PDU/data packet in a corresponding PDU set is successfully transmitted.
(b) For another example, the PDCP layer receives indication information from a lower layer (for example, an RLC layer), and determines that a corresponding PDU set or a PDU/data packet in a corresponding PDU set is successfully transmitted. The RLC layer determines indication information to the PDCP layer based on feedback information about an RLC layer at the peer end. For example, it is determined, based on an SN indicated by feedback information or an identifier (such as an SN or a plurality of SNs) of the PDU set, that a corresponding PDU set or a PDU/data packet in a corresponding PDU set is successfully transmitted.
(c) For another example, the PDCP layer determines, based on peer-end feedback, that the PDU set or a PDU/data packet in a corresponding PDU set does not need to be transmitted or retransmitted, or considers that the PDU set or a PDU/data packet in a corresponding PDU set may be deleted. Further, the PDCP layer deletes the PDU set or a PDU/data packet in the corresponding PDU set, or instructs an RLC layer to delete the PDU set or a PDU/data packet in the corresponding PDU set.
(d) In a possible implementation, the PDCP layer needs to identify which PDUs/data packets belong to one PDU set. In some implementations, the PDCP layer may perform identification based on information such as packet header information, a higher-layer user plane indication, and a higher-layer control plane indication.
   An optional operation 4: Based on peer-end feedback, transmission or retransmission of the PDU set or a PDU/data packet in a corresponding PDU set is performed.
(a) For example, the PDCP layer receives feedback information from a PDCP layer of a peer end, and determines, based on an SN indicated by the feedback information or an identifier (such as an SN or a plurality of SNs) of the PDU set, that the corresponding PDU set or a PDU/data packet in the corresponding PDU set is not successfully transmitted, and needs to be retransmitted.

Alternatively, the PDCP layer receives feedback information from a PDCP layer of a peer end, and determines, based on an SN indicated by the feedback information or an identifier (such as an SN or a plurality of SNs) of the PDU set, that PDUs/data packets that are not transmitted and that are in a corresponding PDU set need to be transmitted.
(b) For another example, the PDCP layer receives indication information from a lower layer (for example, an RLC layer), and determines that a corresponding PDU set or a PDU/data packet in a corresponding PDU set is not successfully transmitted, and needs to be retransmitted. Alternatively, the PDCP layer receives indication information about a lower layer (such as an RLC layer), and determines that PDUs/data packets that are not transmitted and that are in a corresponding PDU set need to be transmitted.

The RLC layer determines indication information to the PDCP layer based on feedback information about an RLC layer at the peer end. For example, related information and how to instruct to the PDCP layer are determined based on an SN indicated by feedback information or an identifier (such as an SN or a plurality of SNs) of the PDU set.
(c) In a possible implementation, the PDCP layer needs to identify which PDUs/data packets belong to one PDU set. In some implementations, the PDCP layer may perform identification based on information such as packet header information, a higher-layer user plane indication, and a higher-layer control plane indication.
ii. As a receive end for data transmission (for example, for UL data transmission), one or more of the following optional operations may be performed.
   An optional operation 1: packet deletion/packet loss. The following uses a PDCP layer as an example for description, but it is not limited to the PDCP layer, or may be one of an SDAP layer, an RLC layer, a MAC layer, or the like.
(a) For example, when the PDCP layer determines that a data packet or a specific data packet in the PDU set is lost (for example, based on lower-layer feedback or a fact that a timer expires), or exceeds a PDB, the PDCP layer deletes another data packet in a corresponding PDU set.

For another example, when the PDCP layer determines that a transmission delay of a data packet or a specific data packet in the PDU set is greater than or equal to a PDB corresponding to the PDU set, the PDCP layer deletes another data packet in a corresponding PDU set.

The another data packet may be another data packet that is received, a PDCP PDU that is not delivered to a higher layer and that is of the another data packet, a corresponding PDU set that is deleted, or all data packets that are deleted and that is in a corresponding PDU set.
(b) Accordingly, the PDCP layer needs to identify which PDUs/data packets belong to one PDU set. In some implementations, the PDCP layer may perform identification based on information such as packet header information, a higher-layer user plane indication, and a higher-layer control plane indication.
(c) In a possible implementation, the PDCP layer needs to perform re-ordering on data packets in one PDU set.
(d) In a possible implementation, the PDCP layer stops a reordering timer in this case.
   An optional operation 2: packet deletion/packet loss indication. The following uses a PDCP layer as an example for description, but it is not limited to the PDCP layer, or may be one of an SDAP layer, an RLC layer, a MAC layer, or the like.
(a) For example, when the PDCP layer determines that a data packet or a specific data packet in the PDU set is lost (for example, based on lower-layer feedback or a fact that a timer expires), the PDCP layer deletes another data packet in a corresponding PDU set.

When the PDCP layer determines that a transmission delay of a data packet or a specific data packet in the PDU set is greater than or equal to a PDB corresponding to the PDU set, the PDCP layer deletes another data packet in a corresponding PDU set.

The another data packet may include another data packet that is received, a PDCP PDU that is not delivered to a higher layer and that is of the another data packet, a corresponding PDU set that is deleted, or all data packets that are deleted and that is in a corresponding PDU set.
(b) For example, when the PDCP layer determines that a data packet or a specific data packet in the PDU set is lost (for example, based on lower-layer feedback or a fact that a timer expires), the PDCP layer instructs a lower layer to delete a corresponding data packet. For example, the RLC layer is instructed to delete another data packet in a corresponding PDU set, delete another data packet that is not delivered to the PDCP layer, delete a corresponding data packet in a corresponding PDU set, or clear a buffer corresponding to the PDU set, or stop a corresponding re-assembly timer.

For another example, when the PDCP layer determines that a transmission delay of a data packet or a specific data packet in the PDU set is greater than or equal to a PDB corresponding to the PDU set, the PDCP layer instructs a lower layer to delete a corresponding data packet. For example, the RLC layer is instructed to delete another data packet in a corresponding PDU set, delete another data packet that is not delivered to the PDCP layer, delete a corresponding data packet in a corresponding PDU set, or clear a buffer corresponding to the PDU set, or stop a corresponding re-assembly timer.
(c) Correspondingly, the lower layer (for example, an RLC layer) needs to perform at least one of the following operations: deleting an SDU/PDU corresponding to the indication, clearing the corresponding buffer, and stopping the corresponding re-assembly timer.
(d) Correspondingly, the PDCP layer needs to identify which PDUs/data packets belong to one PDU set, for example, perform identification based on information such as packet header information, a higher-layer user plane indication, and a higher-layer control plane indication.
(e) In a possible implementation, the PDCP layer needs to perform re-ordering on data packets in one PDU set.
(f) In a possible implementation, the PDCP layer stops a reordering timer in this case.
   An optional operation 3: Feedback (feedback to a peer end) is performed for indicating that a PDU/data packet in a corresponding PDU set or a PDU set does not need to be retransmitted. The following uses a PDCP layer as an example for description, but it is not limited to the PDCP layer, or may be one of an SDAP layer, an RLC layer, a MAC layer, or the like.
(a) For the PDU set, if the PDCP layer determines that a data packet or a specific data packet in the PDU set is lost (for example, based on lower-layer feedback or a fact that a timer expires), the PDCP layer sets feedback information about a corresponding PDU set or data packets corresponding to the PDU set to an ACK (for example, a corresponding SN or a plurality of SNs are set to an ACK), and instructs the feedback information to a peer end. For example, when one data packet or a specific data packet fails to be transmitted, or one data packet or a specific data packet is transmitted or the PDU set exceeds a PDB, or one data packet, a specific data packet, or the PDU set is lost, feedback is performed.

For another example, for the PDU set, if the PDCP layer determines that a transmission delay of a data packet or a specific data packet in the PDU set is greater than or equal to a PDB of the PDU set, the PDCP layer sets feedback information about a corresponding PDU set or data packets corresponding to the PDU set to an ACK (for example, a corresponding SN or a plurality of SNs are set to an ACK), and instructs the feedback information to a peer end. For example, when one data packet or a specific data packet fails to be transmitted, or one data packet or a specific data packet is transmitted or the PDU set exceeds a PDB, or one data packet, a specific data packet, or the PDU set is lost, feedback is performed.
(b) In a possible implementation, the PDCP layer needs to identify which PDUs/data packets belong to one PDU set, for example, perform identification based on information such as packet header information, a higher-layer user plane indication, and a higher-layer control plane indication.
   An optional operation 4: Feedback (feedback to a peer end) is performed to indicate that a PDU/data packet in a corresponding PDU set or a PDU set needs to be retransmitted.
(a) For the PDU set, if the PDCP layer determines that a data packet or a specific data packet in the PDU set is lost (for example, based on lower-layer feedback or a fact that a timer expires) and delay thereof does not exceed a PDB, or that some data packets in the PDU set are received but a data packet or a specific data packet in the PDU set is not received yet, the PDCP layer sets feedback information about a corresponding PDU set or data packets corresponding to the PDU set to a NACK (for example, a corresponding SN or an SN that is not received is set to a NACK), and instructs the feedback information to a peer end. For example, when one data packet or a specific data packet fails to be transmitted, or one data packet or a specific data packet is transmitted or the PDU set exceeds a PDB, or one data packet, a specific data packet, or the PDU set is lost, feedback is performed.
(b) In a possible implementation, the PDCP layer needs to identify which PDUs/data packets belong to one PDU set, for example, perform identification based on information such as packet header information, a higher-layer user plane indication, and a higher-layer control plane indication.
iii. The base station identifies PDUs or data packets in the PDU set (that is, identifies which PDUs or data packets belong to one PDU set), and the base station performs scheduling or resource allocation for the PDU set. For example, the base station schedules a DG to transmit all data packets of the PDU set. For another example, if the base station acquires a data volume of the PDU set from, for example, a terminal device, and schedules a DG based on the data volume, all data of packets the PDU set is transmitted.
iv. The base station identifies PDUs or data packets in the PDU set (that is, identifies which PDUs or data packets belong to one PDU set), and transmits a PDU at an AS generated from PDUs or data packets corresponding to one PDU set to a lower layer. For example, the PDUs or data packets corresponding to one PDU set are included in one PDCP PDU, or SDAP PDU, or MAC PDU.
(b) If integrated packet handling or consistency handling of the PDU set is performed at a terminal device, the base station instructs the first information to the terminal device. The terminal device performs integrated packet handling or consistency handling for the PDU set, including packet loss, packet loss indication, feedback (feedback to a peer end), generation of a transmission data packet for the PDU set, and the like.
i. A specific manner is similar to that of the operations of the base station in i to iv above (a difference is that an execution body is changed from the base station to the terminal device, and a transmission direction is changed from UL to DL, or vice versa, from DL to UL). For brevity, details are not described below.

### Solution 2

1. The terminal device acquires first information. The first information is information for the PDU set, or information for integrated packet handling of the PDU set.
(a) The first information may be information about a PDU set for a QoS flow, information about a PDU set for a PDU session, information about a PDU set for an AF, information about a PDU set for an IP quintuple, or information about a PDU set for a terminal device.
(b) The first information may include an indication for integrated packet handling or consistency handling of the PDU set, or an activation indication for activating integrated packet handling or consistency handling of the PDU set.

2. In a possible implementation, the terminal device notifies a base station of the first information.

3. The terminal device or the base station performs processing for the PDU set based on the first information.
(a) For the terminal device, a manner in which processing is performed for the PDU set based on the first information is similar to the processing manner of (b) in 2 in Solution 1.
(b) For the base station, a manner in which processing is performed for the PDU set based on the first information is similar to the processing manner of (a) in 2 in Solution 1, except that the base station acquires the first information from the terminal device.

In this embodiment of this application, a specific manner of integrated packet handling for the PDU set through an air interface is provided, where handling includes transmit end handling, receive end handling, and/or the like. In addition, in this embodiment of this application, a manner of integrated packet handling on all PDUs/data packets in the PDU set is applicable to a case that the PDU set can be recovered only by using all the PDUs/data packets in the PDU set. Alternatively, it may be understood that the PDU set can be recovered only after all PDUs/data packets in the PDU set are received or successfully transmitted or successfully received or decoded. With reference to Embodiment 5, the following describes a first operation and/or a second operation performed in a case that the PDU set may be recovered by using part of PDUs/data packets in the PDU set.

### Embodiment 5

In this embodiment of this application, the first PDU may be a PDU set. The first PDU may further include a PDU set that has an association relationship or an integrated packet handling requirement. For example, the first PDU may further include a PDU set that carries an I frame and a PDU set that carries a P frame. Certainly, the first PDU may further include a PDU that has an association relationship or an integrated packet handling requirement. In this embodiment of this application, transmission of the first PDU in a downlink transmission scenario is used as an example for description, where the first PDU is a PDU set. In addition, the method in this embodiment of this application is also applicable to an uplink transmission scenario.

This embodiment of this application mainly describes a manner of integrated packet handling for all PDUs/data packets in the PDU set, for example, including air interface transmit end handling, air interface receive end handling, and/or the like.

The following mainly describes, with reference to Solution 1 and Solution 2, processing for the PDU set performed by a base station and processing for the PDU set performed by a terminal, respectively.

### Solution 1

1. The base station acquires first information. The first information is information for the PDU set, or information for integrated packet handling of the PDU set. Based on the first information, the PDU set may be recovered by using part of PDUs/data packets in the PDU set. For example, if there is a PDU/data packet that is greater than a threshold, or a specific quantity of specific PDUs/data packets that are received successfully (for example, a specific PDU whose received quantity is greater than a threshold), the PDU set may be recovered, or it is considered that the PDU set may be decoded, or the PDU set is transmitted or decoded successfully.
(a) The first information may be information about a PDU set for a QoS flow, information about a PDU set for a PDU session, information about a PDU set for an application/AF, information about a PDU set for an IP quintuple, or information about a PDU set for a terminal device.
(b) The first information includes an indication for integrated packet handling or consistency handling of the PDU set.
(c) The first information includes an object for integrated packet handling or consistency handling of the PDU set, for example, at least part of data packets/PDUs in the PDU set are objects.
(d) The first information includes a quantity of data packets/PDUs that are tolerated to be lost in the PDU set, or a loss rate of data packets/PDUs that are tolerated to be lost in the PDU set, or a loss proportion of data packets/PDUs that are tolerated to be lost in the PDU set.
(e) The first information includes a minimum quantity of to-be-received PDUs/data packets required for the PDU set to be decoded or successfully decoded, a receive success rate of minimum PDUs/data packets required for the PDU set to be decoded or successfully decoded, a receive proportion of minimum PDUs/data packets required for the PDU set to be decoded or successfully decoded, a minimum quantity of to-be-transmitted PDUs/data packets required for the PDU set to be decoded or successfully decoded, a success rate of minimum PDUs/data packets required for the PDU set to be decoded or successfully decoded, or a proportion of minimum PDUs/data packets required for the PDU set to be decoded or successfully decoded.
(f) The first information includes a transmission success rate (or a proportion or a quantity) of minimum PDUs/data packets that are in the PDU set and that meet a requirement that the PDU set is successfully decoded, or a maximum transmission failure rate (or a proportion or a quantity) of PDUs/data packets that are in the PDU set and that meet a requirement that the PDU set is successfully decoded.
(g) The first information includes a threshold of a quantity of data packets required for the PDU set to be decoded successfully or recovered.

2. The base station performs processing for the PDU set based on the first information.
(a) If integrated packet handling or consistency handling of the PDU set is performed at the base station, the base station performs integrated packet handling or consistency handling for the PDU set based on the first information, including scheduling, resource configuration, RRC parameter configuration, packet loss, packet loss indication, feedback (feedback to a peer end), generation of a transmission data packet for a required quantity of data packets in the PDU set (the required quantity of data packets is a data packet and/or a quantity of data packets determined based on a quantity, a proportion, or a threshold corresponding to (d) to (g) in 1), and the like.
i. As a transmit end for data transmission (for example, for DL data transmission), one or more of the following operations may be performed.
   An optional operation 1: packet deletion/packet loss. The following uses a PDCP layer as an example for description, but it is not limited to the PDCP layer, or may be one of an SDAP layer, an RLC layer, a MAC layer, or the like.
(a) For example, when the PDCP layer determines that a required quantity of data packets in the PDU set are successfully transmitted (for example, based on lower-layer feedback or peer-end feedback), or data packets failing to meet a required quantity are successfully transmitted and delay thereof exceed a PDB, the PDCP layer deletes another data packet in a corresponding PDU set, or another data packet that is not transmitted, or a data packet not packaged as a PDCP PDU, or a PDCP PDU that is not delivered to a lower layer and that is of the another data packet. The required quantity of data packets is a data packet and/or a quantity of data packets determined based on a quantity, a proportion, or a threshold corresponding to (d) to (g) in 1.
(b) Correspondingly, the PDCP layer needs to identify which PDUs/data packets belong to one PDU set, for example, may perform identification based on information such as packet header information, a higher-layer user plane indication, and a higher-layer control plane indication.
   An optional operation 2: packet deletion/packet loss indication. The following uses a PDCP layer as an example for description, but it is not limited to the PDCP layer, or may be one of an SDAP layer, an RLC layer, a MAC layer, or the like.
(a) For example, when the PDCP layer determines that a required quantity of data packets in the PDU set are successfully transmitted (for example, based on lower-layer feedback or peer-end feedback), or data packets failing to meet a required quantity are successfully transmitted and delay thereof exceed a PDB, the PDCP layer instructs a lower layer to delete another data packet in a corresponding PDU set, or another data packet that is not transmitted, or a data packet not packaged as a lower-layer PDU, an RLC SDU/PDU that is not delivered to a peer end and that is of the another data packet, or an RLC SDU/PDU that corresponds to the another data packet and that is not delivered to the lower layer, or a lower-layer SDU/PDU corresponding to the PDU set, or a lower-layer SDU/PDU corresponding to the another data packet in the PDU set. The required quantity of data packets is a data packet and/or a quantity of data packets determined based on a quantity, a proportion, or a threshold corresponding to (d) to (g) in 1.
(b) Correspondingly, the lower layer (for example, an RLC layer) needs to delete an SDU/PDU corresponding to the indication.
(c) Correspondingly, the PDCP layer needs to identify which PDUs/data packets belong to one PDU set, for example, may perform identification based on information such as packet header information, a higher-layer user plane indication, and a higher-layer control plane indication.
   An optional operation 3: Based on peer-end feedback, it is considered that the PDU set or a PDU/data packet in a corresponding PDU set is successfully transmitted, or it is considered that a remaining data packet or a data packet that is not transmitted or a data packet that is not successfully transmitted does not need to be transmitted, or needs to be stopped from being transmitted, or needs to be deleted. The following uses a PDCP layer as an example for description, but it is not limited to the PDCP layer, or may be one of an SDAP layer, an RLC layer, a MAC layer, or the like.
(a) For example, the PDCP layer receives feedback information from a PDCP layer of a peer end, and determines, based on an SN indicated by the feedback information or an identifier (for example, an SN of the PDU set or a plurality of SNs allocated to packets corresponding to the PDU set) of the PDU set, that a corresponding PDU set or a PDU/data packet in a corresponding PDU set is successfully transmitted, or considers that a remaining data packet or a data packet that is not transmitted or a data packet that is not successfully transmitted does not need to be transmitted, or needs to be stopped from being transmitted, or needs to be deleted.
(b) Alternatively, for example, the PDCP layer receives indication information from a lower layer such as an RLC layer, and determines that a corresponding PDU set or a PDU/data packet in a corresponding PDU set is successfully transmitted, or considers that a remaining data packet or a data packet that is not transmitted or a data packet that is not successfully transmitted does not need to be transmitted, or needs to be stopped from being transmitted, or needs to be deleted. The RLC layer determines indication information to the PDCP layer based on feedback information about an RLC layer at the peer end. For example, related information is determined based on an SN indicated by the feedback information or an identifier (such as an SN or a plurality of SNs) of the PDU set.
(c) For example, the PDCP layer determines, based on peer-end feedback, that the PDU set or a PDU/data packet in a corresponding PDU set do not need to be transmitted or retransmitted, or considers that the PDU set or a PDU/data packet in a corresponding PDU set may be deleted. Further, the PDCP layer deletes the PDU set or all or some of the PDUs/data packets in the corresponding PDU set, or instructs an RLC layer to delete the PDU set or the PDUs/data packets in the corresponding PDU set.
(d) In a possible implementation, the PDCP layer needs to identify which PDUs/data packets belong to one PDU set, for example, may perform identification based on information such as packet header information, a higher-layer user plane indication, and a higher-layer control plane indication.
   An optional operation 4: Based on peer-end feedback, transmission or retransmission of the PDU set or a PDU/data packet in a corresponding PDU set is performed.
(a) For example, the PDCP layer receives feedback information from a PDCP layer at a peer end, and determines, based on an SN indicated by the feedback information or an identifier (such as an SN or a plurality of SNs) of the PDU set, that a corresponding PDU set or a PDU/data packet in a corresponding PDU set is not successfully transmitted, or that a quantity of successfully transmitted data packets does not meet a required quantity, or that a data packet in the PDU set needs to be retransmitted; or determines that a PDU/data packet that is not transmitted in a corresponding PDU set needs to be transmitted. The required quantity of data packets is a data packet and/or a quantity of data packets determined based on a quantity, a proportion, or a threshold corresponding to (d) to (g) in 1.
(b) Alternatively, for example, the PDCP layer receives indication information from a lower layer such as an RLC layer, and determines that a corresponding PDU set or a PDU/data packet in a corresponding PDU set is not successfully transmitted, or that data packets successfully transmitted do not meet a required quantity, or that a data packet in the PDU set needs to be retransmitted; or determines that a PDU/data packet that is not transmitted in a corresponding PDU set needs to be transmitted. The RLC layer determines indication information to the PDCP layer based on feedback information about an RLC layer at the peer end. For example, related information and how to instruct to the PDCP layer are determined based on an SN indicated by feedback information or an identifier (such as an SN or a plurality of SNs) of the PDU set.
(c) In a possible implementation, the PDCP layer needs to identify which PDUs/data packets belong to one PDU set, for example, perform identification based on information such as packet header information, a higher-layer user plane indication, and a higher-layer control plane indication.
ii. As a receive end for data transmission (for example, for UL data transmission), any one of the following operations may be performed.
   An optional operation 1: delivering to a higher layer. The following uses a PDCPlayer as an example for description, but it is not limited to the PDCP layer, or may be one of an SDAP layer, an RLC layer, a MAC layer, or the like.
(a) If the PDCP layer determines that a required quantity of data packets are successfully transmitted or a specific required quantity of data packets are successfully transmitted, the PDCP layer delivers, to the higher layer, a data packet corresponding to the PDU set.
(b) In a possible implementation, the PDCP layer needs to perform reordering on data packets in one PDU set.
c) In a possible implementation, the PDCP layer stops a re-ordering timer in this case.
   An optional operation 2: packet deletion/packet loss. The following uses a PDCP layer as an example for description, but it is not limited to the PDCP layer, or may be one of an SDAP layer, an RLC layer, a MAC layer, or the like.
(a) For example, the PDCP layer determines that a required quantity of data packets in the PDU set are successfully transmitted (for example, based on lower-layer feedback or a fact that a timer expires), or that data packets failing to meet a required quantity are successfully transmitted and delay thereof exceed a PDB, and the PDCP layer deletes another data packet in a corresponding PDU set, or another received data packet, or a PDCP PDU that is not delivered to a higher layer and that is of the another data packet, or a corresponding PDU set, or all data packets in a corresponding PDU set.
(b) Correspondingly, the PDCP layer needs to identify which PDUs/data packets belong to one PDU set, for example, may perform identification based on information such as packet header information, a higher-layer user plane indication, and a higher-layer control plane indication.
(c) In a possible implementation, the PDCP layer needs to perform re-ordering on data packets in one PDU set.
(d) In a possible implementation, the PDCP layer stops a reordering timer in this case.
   An optional operation 3: packet deletion/packet loss indication. The following uses a PDCP layer as an example for description, but it is not limited to the PDCP layer, or may be one of an SDAP layer, an RLC layer, a MAC layer, or the like.
(a) For example, when the PDCP layer determines that a required quantity of data packets in the PDU set are successfully transmitted (for example, based on lower-layer feedback or a fact that a timer expires), or that data packets failing to meet a required quantity are successfully transmitted and delay thereof exceed a PDB, the PDCP layer deletes another data packet in a corresponding PDU set, or another received data packet, or a PDCP PDU that is not delivered to a higher layer and that is of the another data packet, or a corresponding PDU set, or all data packets in a corresponding PDU set.
(b) For example, when the PDCP layer determines that a required quantity of data packets in the PDU set are successfully transmitted (for example, based on lower-layer feedback or a fact that a timer expires), or that data packets failing to meet a required quantity are successfully transmitted and exceed the PDB, and the PDCP layer instructs a lower layer to delete a corresponding data packet. For example, the RLC layer is instructed to delete another data packet in a corresponding PDU set, delete another data packet that is not delivered to the PDCP layer, delete a corresponding data packet in a corresponding PDU set, or clear a buffer corresponding to the PDU set, or stop a corresponding re-assembly timer.
(c) Correspondingly, the lower layer such as an RLC layer needs to perform at least one of the following operations: deleting an SDU/PDU corresponding to the indication, clearing the corresponding buffer, and stopping the corresponding reassembly timer.
(d) Correspondingly, the PDCP layer needs to identify which PDUs/data packets belong to one PDU set, for example, may perform identification based on information such as packet header information, a higher-layer user plane indication, and a higher-layer control plane indication.
(e) In a possible implementation, the PDCP layer needs to perform re-ordering on data packets in one PDU set.
(f) In a possible implementation, the PDCP layer stops a reordering timer in this case.
   An optional operation 4: Feedback (to a peer end) is performed to indicate that a PDU/data packet in a corresponding PDU set or the PDU set is transmitted successfully, or that transmission is not performed for data that is not transmitted, or retransmission is not performed. The following uses a PDCP layer as an example for description, but it is not limited to the PDCP layer, or may be one of an SDAP layer, an RLC layer, a MAC layer, or the like.
(a) For the PDU set, if the PDCP layer determines that a required quantity of data packets in the PDU set are successfully transmitted (for example, based on a low-layer feedback or a fact that a timer timeout), or that data packets failing to meet a required quantity are successfully transmitted and delay thereof exceed a PDB, the PDCP layer sets feedback information about a corresponding PDU set or data packets corresponding to the PDU set to an ACK (for example, a corresponding SN or a plurality of SNs are set to an ACK), and transmits the feedback information to a peer end. For example, when a threshold is reached for successful transmission, or a PDB is reached, or packet deletion/packet loss is performed at the receive end, feedback is performed.
(b) In a possible implementation, the PDCP layer needs to identify which PDUs/data packets belong to one PDU set, for example, perform identification based on information such as packet header information, a higher-layer user plane indication, and a higher-layer control plane indication.
   An optional operation 5: Feedback (feedback to a peer end) is performed to indicate that a PDU/data packet in a corresponding PDU set or a PDU set needs to be retransmitted.
(a) For the PDU set, if the PDCP layer determines that data packetsfailing to meet a required quantity in the PDU set are successfully transmitted (for example, based on low-layer feedback or a fact that a timer expires) and delay thereof do not exceed a PDB, the PDCP layer sets feedback information about a corresponding PDU set or data packets corresponding to the PDU set to a NACK (for example, an SN of the corresponding PDU set or a not received SN is set to a NACK), and transmits the feedback information to a peer end. For example, when the timer expires and the required quantity of data packets are not received, feedback is performed.
(b) In a possible implementation, the PDCP layer needs to identify which PDUs/data packets belong to one PDU set (for example, based on packet header information, a higher-layer user plane indication, and a higher-layer control plane indication, and the like).
iii. The base station identifies PDUs or data packets in the PDU set (that is, identifies which PDUs or data packets belong to one PDU set), and the base station performs scheduling or resource allocation for a required quantity of data packets in the PDU set. For example, the base station schedules a DG to transmit all data packets of the PDU set (which is applicable to a DL or UL scenario). For another example, a data volume of the PDU set is acquired from a terminal device, and the base station schedules a DG based on the data volume to transmit all data packets of the PDU set.
iv. The base station identifies PDUs or data packets in the PDU set (that is, identifies which PDUs or data packets belong to one PDU set), and transmits one PDU generated from a required quantity of data packets corresponding to one PDU set to a lower layer. For example, a required quantity of data packets corresponding to one PDU set are included in one PDCP PDU, or SDAP PDU, or MAC PDU.
(b) If integrated packet handling or consistency handling of the PDU set is performed at a terminal device, the base station instructs the first information to the terminal device. The terminal device performs integrated packet handling or consistency handling for the PDU set, including packet loss, packet loss indication, feedback (feedback to a peer end), generation of a transmission data packet for the PDU set, and the like.
i. A specific manner is similar to that of the operations of the base station in i to iv above (a difference is that an execution body is changed from the base station to the terminal device, and a transmission direction is changed from UL to DL, or vice versa, from DL to UL).

### Solution 2

1. The terminal device acquires first information. The first information is information for the PDU set, or information for integrated packet handling of the PDU set. The first information is similar to that described in step 1 in Solution 1 in this embodiment.

2. In a possible implementation, the terminal device notifies a base station of the first information.

3. The terminal device or the base station performs processing for the PDU set based on the first information.
(a) For the terminal device, a manner in which processing is performed for the PDU set based on the first information is similar to the processing manner of (b) in 2 in Solution 1.
(b) For the base station, a manner in which processing is performed for the PDU set based on the first information is similar to the processing manner of (a) in 2 in Solution 1, except that the base station acquires the first information from the terminal device.

In this embodiment of this application, a specific manner of integrated packet handling on the PDU set through an air interface is provided, where processing may include transmit end processing, receive end processing, and/or the like.

### Embodiment 6

In this embodiment of this application, the first PDU may be a PDU set. The first PDU may further include a PDU set that has an association relationship or an integrated packet handling requirement. For example, the first PDU may further include a PDU set that carries an I frame and a PDU set that carries a P frame. Certainly, the first PDU may further include a PDU that has an association relationship or an integrated packet handling requirement. In this embodiment of this application, transmission of the first PDU in a downlink transmission scenario is used as an example for description, and the first PDU includes a plurality of associated PDU sets. In addition, the method in this embodiment of this application is also applicable to an uplink transmission scenario.

### Solution 1

1. A base station acquires first information. The first information is information for an associated PDU set, or information used for integrated packet handling of an associated PDU set. Based on the first information, the associated PDU set may be recovered upon receiving of a specific PDU in the associated PDU set. In a possible implementation, the first information includes at least one of the following:
(a) information about a PDU set for a QoS flow, information about a PDU set for a PDU session, information about a PDU set for an application/AF, information about a PDU set for an IP quintuple, or information about a PDU set for a terminal device;
(b) an indication for integrated packet handling or consistency handling of the PDU set;
(c) an object for integrated packet handling or consistency handling of the PDU set, for example, which associated PDU sets, for example, an I frame and a P frame that are associated, and a current P frame and a subsequent P frame; or
(d) an identification class or an important PDU set in the associated PDU set.

2. The base station performs processing for the PDU set based on the first information.
(a) If integrated packet handling or consistency handling of the associated PDU set is performed at the base station, the base station performs, based on the first information, integrated packet handling or consistency handling for the associated PDU set. Integrated packet handling or consistency handling includes resource scheduling, resource configuration, RRC parameter configuration, packet loss, packet loss indication, feedback (feedback to a peer end), generation of a transmission data packet for the associated PDU set, and the like.
i. As a transmit end for data transmission (for example, for DL data transmission), one or more of the following optional operations may be performed.
   An optional operation 1: If an important PDU set in the associated PDU set is lost, a corresponding associated PDU set is deleted.
   An optional operation 2: If an important PDU set in the associated PDU set is lost, a lower layer is instructed to delete a remaining PDU set in the associated PDU set.
   An optional operation 3: Based on peer-end feedback, if an important PDU set in the associated PDU set is lost, the associated PDU set is deleted.
   An optional operation 4: Based on peer-end feedback, if an important PDU set in the associated PDU set is lost, the important PDU set is transmitted or retransmitted.
ii. As a receive end for data transmission (for example, for UL data transmission), one or more of the following optional operations may be performed.
   An option operation 1: If an important PDU set in the associated PDU set is successfully received (and a quantity of PDU sets satisfying a quantity requirement for decoding are received), the important PDU set is delivered to a higher layer.
   An optional operation 2: If an important PDU set in the associated PDU set is lost, a corresponding associated PDU set is deleted.
   An optional operation 3: If an important PDU set in the associated PDU set is lost, a lower layer is instructed to delete a remaining PDU set in the associated PDU set.
   An optional operation 4: Feedback (feedback to a peer end) is performed to indicate that an important PDU set in the associated PDU set is lost, and for instructing the peer end to delete another PDU set in the associated PDU set, or not to transmit another PDU set.
   An optional operation 5: Feedback (feedback to a peer end) is performed to indicate that an important PDU set in the associated PDU set is lost, and for instructing the peer end to retransmit the important PDU set in the associated PDU set.
iii. The base station identifies the associated PDU set and performs scheduling or resource allocation as a whole based on the associated PDU set. For example, the base station schedules a DG to transmit all data packets of the PDU set (this operation is applicable to a DL or UL scenario). For another example, if the base station acquires a data volume of the PDU set from a terminal device, and schedules a DG based on the data volume to transmit all data packets of the PDU set.
iv. The base station identifies the associated PDU set and transmits the associated PDU set in a low-layer packet.
(b) If integrated packet handling or consistency handling of the PDU set is performed at a terminal device, the base station instructs the first information to the terminal device. The terminal device performs integrated packet handling or consistency handling for the PDU set, including packet loss, packet loss indication, feedback (feedback to a peer end), generation of a transmission data packet for the PDU set, and the like.
i. A specific manner is similar to that of the operations of the base station in i to iv above (a difference is that an execution body is changed from the base station to the terminal device, and a transmission direction is changed from UL to DL, or vice versa, from DL to UL)

### Solution 2

1. A terminal device acquires first information. The first information is information for the PDU set, or information for integrated packet handling of an associated PDU set. Based on the first information, the associated PDU set may be recovered upon receiving of a specific PDU in the associated PDU set. Details are similar to those described in step 1 in Solution 1 in this embodiment.

2. In a possible implementation, the terminal device notifies a base station of the first information.

3. The terminal device or the base station performs processing on the associated PDU set based on the first information.
(a) For the terminal device, a manner in which processing is performed on the associated PDU set based on the first information is similar to the processing manner of (b) in 2 in Solution 1.
(b) For the base station, a manner in which processing is performed on the associated PDU set based on the first information is similar to the processing manner of (a) in 2 in Solution 1, except that the base station acquires the first information from the terminal device.

In this embodiment of this application, an integrated packet handling manner between associated PDU sets is provided.

The method embodiments of this application are described in detail above with reference to FIG. 1 to FIG. 7. Apparatus embodiments of this application are described below in detail with reference to FIG. 8 to FIG. 10. It should be understood that the description of the method embodiments corresponds to the description of the apparatus embodiments, and therefore, for parts that are not described in detail, reference may be made to foregoing method embodiments.

FIG. 8 is a schematic diagram of a receive end according to an embodiment of this application. The receive end 800 shown in FIG. 8 includes a processing unit 810.

The processing unit 810 is configured to perform a first operation for a first PDU based on first information.

The first PDU includes part of or all of PDUs in a first PDU group, and PDUs in the first PDU group belong to one or more PDU sets.

In a possible implementation, a PDU in the first PDU belongs to a first QoS flow; or a PDU in the first PDU belongs to a first service flow; or a PDU in the first PDU belongs to a first PDU session; or a PDU in the first PDU is associated with a first application; or a PDU in the first PDU is associated with a first AF; or a PDU in the first PDU is associated with a first user; or a PDU in the first PDU is associated with a first network device; or an IP quintuple of a PDU in the first PDU is a first IP quintuple, or PDUs in the first PDU belong to different QoS flows; or PDUs in the first PDU belong to different service flows.

In a possible implementation, the first information is used to indicate a first relationship, and the first relationship includes at least one of the following: an association relationship between PDUs in the first PDU; a priority relationship between PDUs in the first PDU; or a dependency relationship of a PDU in the first PDU in a coding and/or decoding process.

In a possible implementation, the first information includes information about performing integrated packet handling on the first PDU, or the first information includes information about performing differentiated packet handling on the first PDU.

In a possible implementation, the differentiated packet handling information includes at least one of the following: information indicating a processing order of a PDU in the first PDU; information indicating independent decoding of a PDU in the first PDU; or information indicating a dependency relationship of a PDU in the first PDU in a coding and/or decoding process.

In a possible implementation, the first information includes one or more of the following information: information for indicating that integrated packet handling is to be performed on the first PDU; information for indicating that differentiated packet handling is to be performed on the first PDU; information for indicating a PDU, on which integrated packet handling needs to be performed, in the first PDU group; information for indicating a quantity of PDUs tolerated to be lost in the first PDU group; information for indicating a quantity of PDUs required for successfully decoding the first PDU group; information for indicating a quantity of PDUs required for successfully recovering the first PDU group; or information for indicating a quantity of PDUs transmitted successfully in the first PDU group when a condition of successfully decoding the first PDU group is met.

In a possible implementation, the first information is associated with the first PDU group, or the first information is associated with the first PDU.

In a possible implementation, the first information is predefined or preconfigured, or the first information is indicated to the receive end.

In a possible implementation, if the first information is indicated to the receive end, the receive end further includes a first receiving unit, configured to receive the first information transmitted by a first entity. When the receive end is a terminal device, the first entity includes one or more of a network device, an application layer of the terminal device, an entity of the terminal device, an application server, an application function AF, a decoder, an encoder, a core network entity, a session management function SMF, or a user plane function UPF; or when the receive end is a network device, the first entity includes one or more of a terminal device, an application server, an AF, a decoder, an encoder, a core network entity, an SMF, or a UPF.

In a possible implementation, performing the first operation includes one or more of the following operations: determining a type of part of or all of PDUs in the first PDU; determining a processing order of part of or all of PDUs in the first PDU; determining a priority or a priority level of part of or all of PDUs in the first PDU; determining independent decoding information of part of or all of PDUs in the first PDU; determining a dependency relationship of part of or all of PDUs in the first PDU in a coding and/or decoding process; whether to discard part of or all of PDUs in the first PDU; whether to transmit discard indication of discarding part of or all of PDUs in the first PDU; whether to feed back a transmission status of part of or all of PDUs in the first PDU; whether to transmit feedback information of successfully receiving part of or all of PDUs in the first PDU; determining whether part of or all of PDUs in the first PDU are transmitted successfully; whether to instruct to retransmit or transmit part of or all of PDUs in the first PDU; whether to perform integrated packet handling on part of or all of PDUs in the first PDU; whether to generate a first data packet, where the first data packet includes part of or all of PDUs in the first PDU; whether to deliver a second data packet to a higher layer, where the second data packet includes part of or all of PDUs in the first PDU; whether to cache a data packet including part of or all of PDUs in the first PDU; whether to cache part of or all of PDUs in the first PDU; whether to perform re-ordering on part of or all of PDUs in the first PDU; or whether to deliver part of or all of PDUs in the first PDU to a higher layer in a first order.

In a possible implementation, a first protocol layer of the receive end transmits the discard indication to a second protocol layer of the receive end.

In a possible implementation, the first data packet is generated by a third protocol layer of the receive end, and is transmitted to a fourth protocol layer of the receive end.

In a possible implementation, in a case that the first information includes a first PDU quantity, the first PDU quantity is used to indicate a quantity of PDUs required for successfully decoding the first PDU group. The processing unit is further configured to perform the first operation for the first PDU based on the first PDU quantity.

In a possible implementation, the processing unit is further configured to perform the first operation for the first PDU based on the first PDU quantity and a quantity of PDUs transmitted successfully in the first PDU; or the receive end performs the first operation for the first PDU based on the first PDU quantity and a quantity of PDUs that are not transmitted successfully in the first PDU.

In a possible implementation, the first PDU includes part of PDUs in the first PDU group, and the first PDU group further includes another PDU different from the first PDU. The first operation includes one or more of the following operations: in a case that the another PDU is not transmitted successfully, whether to discard part of or all of PDUs in the first PDU; in a case that the another PDU is not transmitted successfully, whether to transmit discard indication for instructing to discard part of or all of PDUs in the first PDU; in a case that the another PDU is transmitted successfully, whether to instruct to retransmit or transmit part of or all of PDUs in the first PDU; whether to discard the another PDU; whether to transmit discard indication of discarding the another PDU; or whether to instruct to retransmit or transmit the another PDU.

In a possible implementation, the another PDU includes a PDU that is not transmitted in the first PDU group; or the another PDU includes a PDU that is not packeted in the first PDU group; or the another PDU includes a PDU that is not transmitted successfully in the first PDU group; or the another PDU includes a PDU that is not delivered to a higher layer in the first PDU group; or the another PDU includes a PDU, in the first PDU group, for which no successful acknowledgement is received; or the another PDU includes a PDU, in the first PDU group, for which a NACK is received.

In a possible implementation, the receive end is the network device, and the first operation includes one or more of the following operations: configuring a resource for transmitting the first PDU; configuring a resource for transmitting the first PDU group; configuring an RRC parameter of the first PDU; or configuring an RRC parameter of the first PDU group.

In a possible implementation, the receive end further includes a second receiving unit, configured to receive first activation indication information, where the first activation indication information is used to instruct to activate performing of the first operation on the first PDU.

In a possible implementation, a PDU in the first PDU group belongs to a first QoS flow; or a PDU in the first PDU group belongs to a first service flow; or a PDU in the first PDU group belongs to a first PDU session; or a PDU in the first PDU group is associated with a first application; or a PDU in the first PDU group is associated with a first AF; or a PDU in the first PDU group is associated with a first user; or a PDU in the first PDU group is associated with a first network device; or an IP quintuple of a PDU in the first PDU group is a first IP quintuple; or PDUs in the first PDU group belong to different QoS flows; or PDUs in the first PDU group belong to different service flows.

In a possible implementation, in a case that PDUs in the first PDU group belong to a plurality of PDU sets, the first information includes one or more of following information: information for indicating a PDU set, on which integrated packet handling needs to be performed, in the first PDU group; information for indicating a target PDU set in the first PDU group; or information for indicating a PDU set, on which differentiated packet handling needs to be performed, in the first PDU group.

In a possible implementation, the target PDU set is a PDU set of an identification class, or the target PDU set is a PDU set having the highest priority in PDU sets included in the first PDU group.

In a possible implementation, the first PDU belongs to a first PDU set, part of or all of PDUs, different from the first PDU, in the first PDU group belong to at least one second PDU set, and the first operation includes one or more of following operations: identifying the at least one second PDU set; identifying the first PDU set; determining whether to discard the at least one second PDU set; determining whether to transmit discard indication of discarding the at least one second PDU set; in a case that the at least one second PDU set is a PDU set that is not transmitted, determining whether to transmit indication information indicating whether the at least one second PDU set is transmitted; determining whether the first PDU set is transmitted successfully; determining whether to transmit feedback information, where the feedback information is used to indicate whether the first PDU is transmitted successfully; in a case that the target PDU set is the first PDU set, determining whether to instruct to retransmit or transmit the target PDU set; determining whether to perform integrated packet handling on the first PDU set and the at least one second PDU set; determining whether to perform differentiated packet handling on the first PDU set and the at least one second PDU set; determining whether to generate a third data packet, where the third data packet includes the first PDU set; determining whether to generate a fourth data packet, where the fourth data packet includes the first PDU set and the at least one second PDU set; determining whether to cache one or more of the first PDU set, the at least one second PDU set, the third data packet, or the fourth data packet; determining whether to perform re-ordering on one or more of the first PDU set, the at least one second PDU set, or the third data packet; or determining whether to deliver the third data packet or the fourth data packet to a higher layer of the receive end.

In a possible implementation, the receive end is a terminal device or a network device.

FIG. 9 is a schematic diagram of a transmit end according to an embodiment of this application. The transmit end 900 shown in FIG. 9 includes a processing unit 910.

The processing unit 910 is configured to perform a second operation for a first PDU, where the first PDU includes part of or all of PDUs in a first PDU group, PDUs in the first PDU group belong to one or more PDU sets, and the second operation is determined based on first information.

In a possible implementation, a PDU in the first PDU belongs to a first QoS flow; or a PDU in the first PDU belongs to a first service flow; or a PDU in the first PDU belongs to a first PDU session; or a PDU in the first PDU is associated with a first application; or a PDU in the first PDU is associated with a first AF; or a PDU in the first PDU is associated with a first user; or a PDU in the first PDU is associated with a first network device; or an IP quintuple of a PDU in the first PDU is a first IP quintuple, or PDUs in the first PDU belong to different QoS flows; or PDUs in the first PDU belong to different service flows.

In a possible implementation, the first information is used to indicate a first relationship, and the first relationship includes at least one of the following: an association relationship between PDUs in the first PDU; a priority relationship between PDUs in the first PDU; or a dependency relationship of a PDU in the first PDU in a coding and/or decoding process.

In a possible implementation, the first information includes information about performing integrated packet handling on the first PDU, or the first information includes information about performing differentiated packet handling on the first PDU.

In a possible implementation, the differentiated packet handling information includes at least one of the following: information indicating a processing order of a PDU in the first PDU; information indicating independent decoding of a PDU in the first PDU; or information indicating a dependency relationship of a PDU in the first PDU in a coding and/or decoding process.

In a possible implementation, the first information includes one or more of the following information: information for indicating that integrated packet handling is to be performed on the first PDU; information for indicating that differentiated packet handling is to be performed on the first PDU; information for indicating a PDU, on which integrated packet handling needs to be performed, in the first PDU group; information for indicating a quantity of PDUs tolerated to be lost in the first PDU group; information for indicating a quantity of PDUs required for successfully decoding the first PDU group; information for indicating a quantity of PDUs required for successfully recovering the first PDU group; or information for indicating a quantity of PDUs transmitted successfully in the first PDU group when a condition of successfully decoding the first PDU group is met.

In a possible implementation, the first information is associated with the first PDU group, or the first information is associated with the first PDU.

In a possible implementation, the first information is predefined or the first information is preconfigured, or the first information is indicated by the transmit end, or the first indication information is indicated to the transmit end.

In a possible implementation, in a case that the first information is indicated by the transmit end, the transmit end further includes: a transmitting unit, configured to transmit the first information to a first entity. When the transmit end is a terminal device, the first entity includes one or more of a network device, an application layer of the terminal device, an entity of the terminal device, an application server, an application function AF, a decoder, an encoder, a core network entity, a session management function SMF, or a user plane function UPF; or when the transmit end is a network device, the first entity includes one or more of a terminal device, an application server, an AF, a decoder, an encoder, a core network entity, an SMF, or a UPF.

In a possible implementation, the first indication information is indicated to the transmit end, and the transmit end further includes: a first receiving unit, configured to receive the first information transmitted by a second entity. When the transmit end is a terminal device, the second entity includes one or more of a network device, an application layer of the terminal device, an entity of the terminal device, an application server, an application function AF, a decoder, an encoder, a core network entity, a session management function SMF, or a user plane function UPF; or when the transmit end is a network device, the second entity includes one or more of a terminal device, an application server, an AF, a decoder, an encoder, a core network entity, an SMF, or a UPF.

In a possible implementation, performing the second operation includes one or more of the following operations: determining a type of part of or all of PDUs in the first PDU; determining a processing order of part of or all of PDUs in the first PDU; determining a priority or a priority level of part of or all of PDUs in the first PDU; determining independent decoding information of part of or all of PDUs in the first PDU; determining a dependency relationship of part of or all of PDUs in the first PDU in a coding and/or decoding process; whether to discard part of or all of PDUs in the first PDU; whether to transmit discard indication of discarding part of or all of PDUs in the first PDU; determining whether part of or all of PDUs in the first PDU are transmitted successfully; whether to retransmit or transmit part of or all of PDUs in the first PDU; whether to cache a data packet including part of or all of PDUs in the first PDU; whether to cache part of or all of PDUs in the first PDU; or whether to route part of or all of PDUs in the first PDU.

In a possible implementation, a first protocol layer of the transmit end transmits the discard indication to a second protocol layer of the transmit end.

In a possible implementation, the first data packet is generated by a third protocol layer of the transmit end, and is transmitted to a fourth protocol layer of the transmit end.

In a possible implementation, the processing unit is further configured to perform the second operation for the first PDU based on a feedback message, where the feedback message is determined based on the first information, and the feedback information is used to indicate whether the first PDU is successfully received; or the feedback information is used to indicate whether the first PDU needs to be retransmitted or transmitted.

In a possible implementation, the processing unit is further configured to perform the second operation for the first PDU based on the first information.

In a possible implementation, in a case that the first information includes a first PDU quantity, the first PDU quantity is used to indicate a quantity of PDUs required for successfully decoding the first PDU group. The processing unit is further configured to perform the second operation for the first PDU based on the first PDU quantity.

In a possible implementation, the processing unit is further configured to: perform the second operation based on the first PDU quantity and the quantity of PDUs included in the first PDU; or perform the second operation based on the first PDU quantity and a quantity of PDUs that are not transmitted successfully in the first PDU.

In a possible implementation, the first PDU includes part of PDUs in the first PDU group, and the first PDU group further includes another PDU different from the first PDU. The second operation includes one or more of the following operations: in a case that the another PDU is not transmitted successfully, whether to discard part of or all of PDUs in the first PDU; in a case that the another PDU is not transmitted successfully, whether to transmit discard indication for instructing to discard part of or all of PDUs in the first PDU; in a case that the another PDU is transmitted successfully, whether to retransmit or transmit part of or all of PDUs in the first PDU; whether to discard the another PDU; whether to transmit discard indication of discarding the another PDU; or whether to retransmit or transmit the another PDU.

In a possible implementation, the another PDU includes a PDU that is not transmitted in the first PDU group; or the another PDU includes a PDU that is not packeted in the first PDU group; the another PDU includes a PDU that is not delivered to a lower layer in the first PDU group; or the another PDU includes a PDU that is not transmitted successfully in the first PDU group; or the another PDU includes a PDU, in the first PDU group, for which no successful acknowledgement is received; or the another PDU includes a PDU, in the first PDU group, for which a NACK is received.

In a possible implementation, the transmit end is the network device, and the second operation includes one or more of the following operations: configuring a resource for transmitting the first PDU; configuring a resource for transmitting the first PDU group; configuring an RRC parameter of the first PDU; or configuring an RRC parameter of the first PDU group.

In a possible implementation, the transmit end further includes a second receiving unit, configured to receive second activation indication information, where the second activation indication information is used to instruct to perform the second operation on the first PDU.

In a possible implementation, a PDU in the first PDU group belongs to a first QoS flow; or a PDU in the first PDU group belongs to a first service flow; or a PDU in the first PDU group belongs to a first PDU session; or a PDU in the first PDU group is associated with a first application; or a PDU in the first PDU group is associated with a first AF; or a PDU in the first PDU group is associated with a first user; or a PDU in the first PDU group is associated with a first network device; or an IP quintuple of a PDU in the first PDU group is a first IP quintuple; or PDUs in the first PDU group belong to different QoS flows; or PDUs in the first PDU group belong to different service flows.

In a possible implementation, in a case that PDUs in the first PDU group belong to a plurality of PDU sets, the first information includes one or more of following information: information for indicating a PDU set, on which integrated packet handling needs to be performed, in the first PDU group; information for indicating a target PDU set in the first PDU group; or information for indicating a PDU set, on which differentiated packet handling needs to be performed, in the first PDU group.

In a possible implementation, the target PDU set is a PDU set of an identification class, or the target PDU set is a PDU set having the highest priority in PDU sets included in the first PDU group.

In a possible implementation, the first PDU belongs to a first PDU set, part of or all of PDUs, different from the first PDU, in the first PDU group belong to a second PDU set, and performing the second operation includes one or more of following operations: identifying the at least one second PDU set; identifying the first PDU set; whether to discard the at least one second PDU set; whether to transmit discard indication of discarding the at least one second PDU set; determining whether the first PDU set is transmitted successfully; whether to perform differentiated packet handling on the first PDU set and the at least one second PDU set; whether to generate a third data packet, where the third data packet includes the first PDU set; whether to generate a fourth data packet, where the fourth data packet includes the first PDU set and the at least one second PDU set; or whether to cache one or more of the first PDU set, the at least one second PDU set, the third data packet, or the fourth data packet.

In a possible implementation, the receive end is a terminal device or a network device.

FIG. 10 is a schematic structural diagram of a receive end according to an embodiment of this application. Dashed lines in FIG. 10 indicate that a unit or module is optional. The apparatus 1000 may be configured to implement methods described in the method embodiments. The apparatus 1000 may be a chip, a terminal device, or a network device.

The apparatus 1000 may include one or more processors 1010. The processor 1010 may allow the apparatus 1000 to implement the methods described in the foregoing method embodiments. The processor 1010 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field-programmable gate array (FPGA) or another programmable logic device, a discrete gate or transistor logic device, a discrete hardware component, or the like. The general-purpose processor may be a microprocessor, or the processor may be any conventional processor or the like.

The apparatus 1000 may further include one or more memories 1020. The memory 1020 stores a program that may be executed by the processor 1010 to cause the processor 1010 to perform the methods described in the foregoing method embodiments. The memory 1020 may be independent of the processor 1010 or may be integrated into the processor 1010.

The apparatus 1000 may further include a transceiver 1030. The processor 1010 may communicate with another device or chip through the transceiver 1030. For example, the processor 1010 may perform data transceiver with another device or chip by using the transceiver 1030.

An embodiment of this application further provides a computer-readable storage medium for storing a program. The computer-readable storage medium may be applied to a terminal or a network device provided in embodiments of this application, and the program causes a computer to execute the methods to be executed by the terminal or the network device in various embodiments of this application.

An embodiment of this application further provides a computer program product. The computer program product includes a program. The computer program product may be applied to the terminal or the network device provided in embodiments of this application, and the program causes a computer to execute the method to be executed by the terminal or the network device in embodiments of this application.

An embodiment of this application further provides a computer program. The computer program may be applied to the terminal or the network device provided in embodiments of this application, and the computer program causes the computer to execute the methods to be executed by the terminal or the network device in embodiments of this application.

It should be understood that the terms “system” and “network” in this application may be used interchangeably. In addition, the terms used in this application are only used to illustrate specific embodiments of this application, but are not intended to limit this application. The terms “first”, “second”, “third”, “fourth”, and the like in the specification, claims, and drawings of this application are used for distinguishing different objects from each other, rather than defining a specific order. In addition, the terms “include” and “have” and any variations thereof are intended to cover a non-exclusive inclusion.

In embodiments of this application, “indicate” mentioned herein may refer to a direct indication, or may refer to an indirect indication, or may mean that there is an association relationship. For example, A indicates B, which may mean that A directly indicates B, for example, B may be obtained by means of A; or may mean that A indirectly indicates B, for example, A indicates C, and B may be obtained by means of C; or may mean that there is an association relationship between A and B.

In embodiments of this application, “B that is corresponding to A” means that B is associated with A, and B may be determined based on A. However, it should also be understood that, determining B based on A does not mean determining B based only on A, but instead B may be determined based on A and/or other information.

In embodiments of this application, the term “corresponding” may mean that there is a direct or indirect correspondence between two elements, or that there is an association between two elements, or that there is a relationship of “indicating” and “being indicated”, “configuring” and “being configured”, or the like.

In embodiments of this application, the “predefining” and “pre-configuration” may be implemented by pre-storing a corresponding code or table in a device (for example, including the terminal device and the access network device) or in other manners that may be used for indicating related information, and a specific implementation thereof is not limited in this application. For example, pre-defining may refer to being defined in a protocol.

In embodiments of this application, the “protocol” may indicate a standard protocol in the communication field, which may include, for example, an LTE protocol, an NR protocol, and a related protocol applied to a future communications system. This is not limited in this application.

In embodiments of this application, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

In embodiments of this application, sequence numbers of the foregoing processes do not mean execution sequences. The execution sequences of the processes should be determined according to functions and internal logic of the processes, and should not be construed as any limitation on the implementation processes of embodiments of this application.

In the several embodiments provided in this application, it should be understood that the disclosed system, apparatus, and method may be implemented in another manner. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatus or units may be implemented in electronic, mechanical, or other forms.

The units described as separate parts may or may not be physically separate, and parts displayed as units may or may not be physical units, and may be located in one position, or may be distributed on a plurality of network units. Some or all of the units may be selected according to actual needs to achieve the objective of the solutions of embodiments.

In addition, function units in embodiments of this application may be integrated into one processing unit, or each of the units may exist alone physically, or two or more units may be integrated into one unit.

All or some of the foregoing embodiments may be implemented by using software, hardware, firmware, or any combination thereof. When the software is used to implement embodiments, all or some of embodiments may be implemented in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (such as a coaxial cable, an optical fiber, and a digital subscriber line (DSL)) manner or a wireless (such as infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid state drive (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A receive end, comprising a memory and a processor, wherein the memory is configured to store a program, and the processor is configured to invoke the program in the memory to execute the method comprising:
performing, a first operation for a first PDU based on first information,
wherein the first PDU comprises part of or all of PDUs in a first PDU group, and PDUs in the first PDU group belong to one or more PDU sets.

2. The receive end according to claim 1, wherein
a PDU in the first PDU belongs to a first QoS flow; or
a PDU in the first PDU belongs to a first service flow; or
a PDU in the first PDU belongs to a first PDU session; or
a PDU in the first PDU is associated with a first application; or
a PDU in the first PDU is associated with a first AF; or
a PDU in the first PDU is associated with a first user; or
a PDU in the first PDU is associated with a first network device; or
an IP quintuple of a PDU in the first PDU is a first IP quintuple; or
PDUs in the first PDU belong to different QoS flows; or
PDUs in the first PDU belong to different service flows.

3. The receive end according to claim 1, wherein the first information is used to indicate a first relationship, and the first relationship comprises at least one of following:
an association relationship between PDUs in the first PDU;
a priority relationship between PDUs in the first PDU; or
a dependency relationship of a PDU in the first PDU in a coding and/or decoding process.

4. The receive end according to claim 1, wherein the first information comprises information about performing integrated packet handling on the first PDU; or
the first information comprises information about performing differentiated packet handling on the first PDU; or
the first information comprises one or more of following information:
information for indicating that integrated packet handling is to be performed on the first PDU;
information for indicating that differentiated packet handling is to be performed on the first PDU;
information for indicating a PDU, on which integrated packet handling needs to be performed, in the first PDU group;
information for indicating a quantity of PDUs tolerated to be lost in the first PDU group;
information for indicating a quantity of PDUs required for successfully decoding the first PDU group;
information for indicating a quantity of PDUs required for successfully recovering the first PDU group; or
information for indicating a quantity of PDUs transmitted successfully in the first PDU group when a condition of successfully decoding the first PDU group is met;
wherein the information about performing differentiated packet handling comprises at least one of following:
information indicating a processing order of a PDU in the first PDU;
information indicating independent decoding of a PDU in the first PDU; or
information indicating a dependency relationship of a PDU in the first PDU in a coding and/or decoding process.

5. The receive end according to claim 1, wherein the first information is associated with the first PDU group, or the first information is associated with the first PDU.

6. The receive end according to claim 1, wherein in a case that the first information is indicated to the receive end, the method further comprises:
receiving the first information transmitted by a first entity, wherein when the receive end is a terminal device, the first entity comprises one or more of a network device, an application layer of the terminal device, an entity of the terminal device, an application server, an application function AF, a decoder, an encoder, a core network entity, a session management function SMF, or a user plane function UPF; or
when the receive end is a network device, the first entity comprises one or more of a terminal device, an application server, an AF, a decoder, an encoder, a core network entity, an SMF, or a UPF.

7. The receive end according to claim 1, wherein performing the first operation comprises one or more of following operations:
determining a type of part of or all of PDUs in the first PDU;
determining a processing order of part of or all of PDUs in the first PDU;
determining a priority or a priority level of part of or all of PDUs in the first PDU;
determining independent decoding information of part of or all of PDUs in the first PDU;
determining a dependency relationship of part of or all of PDUs in the first PDU in a coding and/or decoding process;
whether to discard part of or all of PDUs in the first PDU;
whether to transmit discard indication of discarding part of or all of PDUs in the first PDU;
whether to feed back a transmission status of part of or all of PDUs in the first PDU;
whether to transmit feedback information of successfully receiving part of or all of PDUs in the first PDU;
determining whether part of or all of PDUs in the first PDU are transmitted successfully;
whether to instruct to retransmit or transmit part of or all of PDUs in the first PDU;
whether to perform integrated packet handling on part of or all of PDUs in the first PDU;
whether to generate a first data packet, wherein the first data packet comprises part of or all of PDUs in the first PDU;
whether to deliver a second data packet to a higher layer, wherein the second data packet comprises part of or all of PDUs in the first PDU;
whether to cache a data packet comprising part of or all of PDUs in the first PDU;
whether to cache part of or all of PDUs in the first PDU;
whether to perform re-ordering on part of or all of PDUs in the first PDU; or
whether to deliver part of or all of PDUs in the first PDU to a higher layer in a first order.

8. The receive end according to claim 7, wherein a first protocol layer of the receive end transmits the discard indication to a second protocol layer of the receive end.

9. The receive end according to claim 1, wherein in a case that the first information comprises a first PDU quantity, the first PDU quantity is used to indicate a quantity of PDUs required for successfully decoding the first PDU group; and
the performing a first operation for a first PDU based on first information comprises:
performing the first operation for the first PDU based on the first PDU quantity.

10. The receive end according to claim 9, wherein the performing, by the receive end, the first operation for the first PDU based on the first PDU quantity comprises:
performing the first operation for the first PDU based on the first PDU quantity and a quantity of PDUs transmitted successfully in the first PDU; or
performing the first operation for the first PDU based on the first PDU quantity and a quantity of PDUs that are not transmitted successfully in the first PDU.

11. The receive end according to claim 1, wherein the first PDU comprises part of PDUs in the first PDU group, and the first PDU group further comprises another PDU different from the first PDU; and the first operation comprises one or more of following operations:
in a case that the another PDU is not transmitted successfully, whether to discard part of or all of PDUs in the first PDU; in a case that the another PDU is not transmitted successfully, whether to transmit discard indication for instructing to discard part of or all of PDUs in the first PDU; in a case that the another PDU is transmitted successfully, whether to instruct to retransmit or transmit part of or all of PDUs in the first PDU; whether to discard the another PDU; whether to transmit discard indication of discarding the another PDU; or whether to instruct to retransmit or transmit the another PDU.

12. The receive end according to claim 11, wherein the another PDU comprises a PDU that is not transmitted in the first PDU group; or the another PDU comprises a PDU that is not packeted in the first PDU group; or the another PDU comprises a PDU that is not transmitted successfully in the first PDU group; or the another PDU comprises a PDU that is not delivered to a higher layer in the first PDU group; or the another PDU comprises a PDU, in the first PDU group, for which no successful acknowledgement is received; or the another PDU comprises a PDU, in the first PDU group, for which a NACK is received.

13. The receive end according to claim 1, wherein the receive end is a network device, and the first operation comprises one or more of following operations: configuring a resource for transmitting the first PDU; configuring a resource for transmitting the first PDU group; configuring an RRC parameter of the first PDU; or configuring an RRC parameter of the first PDU group.

14. The receive end according to claim 1, wherein the method further comprises:
receiving first activation indication information, wherein the first activation indication information is used to instruct to activate performing of the first operation on the first PDU.

15. The receive end according to claim 1, wherein in a case that PDUs in the first PDU group belong to a plurality of PDU sets, the first information comprises one or more of following information:
information for indicating a PDU set, on which integrated packet handling needs to be performed, in the first PDU group; information for indicating a target PDU set in the first PDU group; or information for indicating a PDU set, on which differentiated packet handling needs to be performed, in the first PDU group.

16. The receive end according to claim 15, wherein the target PDU set is a PDU set of an identification class, or the target PDU set is a PDU set having the highest priority in PDU sets comprised in the first PDU group.

17. The receive end according to claim 1, wherein the first PDU belongs to a first PDU set, part of or all of PDUs, different from the first PDU, in the first PDU group belong to at least one second PDU set, and the first operation comprises one or more of following operations:
identifying the at least one second PDU set;
identifying the first PDU set;
determining whether to discard the at least one second PDU set;
determining whether to transmit discard indication of discarding the at least one second PDU set;
in a case that the at least one second PDU set is a PDU set that is not transmitted, determining whether to transmit indication information indicating whether the at least one second PDU set is transmitted;
determining whether the first PDU set is transmitted successfully;
determining whether to transmit feedback information, wherein the feedback information is used to indicate whether the first PDU is transmitted successfully;
in a case that a target PDU set is the first PDU set, determining whether to instruct to retransmit or transmit the target PDU set;
determining whether to perform integrated packet handling on the first PDU set and the at least one second PDU set;
determining whether to perform differentiated packet handling on the first PDU set and the at least one second PDU set;
determining whether to generate a third data packet, wherein the third data packet comprises the first PDU set;
determining whether to generate a fourth data packet, wherein the fourth data packet comprises the first PDU set and the at least one second PDU set;
determining whether to cache one or more of the first PDU set, the at least one second PDU set, the third data packet, or the fourth data packet;
determining whether to perform re-ordering on one or more of the first PDU set, the at least one second PDU set, or the third data packet; or
determining whether to deliver the third data packet or the fourth data packet to a higher layer of the receive end.

18. The receive end according to claim 1, wherein the receive end is a terminal device or a network device.

19. A transmit end, comprising a memory and a processor, wherein the memory is configured to store a program, and the processor is configured to invoke the program in the memory to execute the method comprising:
performing, a second operation for the first PDU, wherein the first PDU comprises part of or all of PDUs in a first PDU group, PDUs in the first PDU group belong to one or more PDU sets, and the second operation is determined based on first information.

20. A wireless communication method, comprising:
performing, by a receive end, a first operation for a first PDU based on first information, wherein the first PDU comprises part of or all of PDUs in a first PDU group, and PDUs in the first PDU group belong to one or more PDU sets.
